(19) United States
(12) Patent Application Publication
(10) Pub. No.: US 2026/0296288 A1
(43) Pub. Date: Oct. 1, 2026

(54) ARTICLES WITH RAISED PORTIONS AND RECESSED PORTIONS

(71) Applicant: John Richard Taylor, Irving, TX (US)

(72) Inventor: John Richard Taylor, Irving, TX (US)

(21) Appl. No.: 19/295,399

(22) Filed: Aug. 8, 2025

Related U.S. Application Data
(63) Continuation-in-part of application No. 19/256,815, filed on Jul. 1, 2025.
(63) Continuation-in-part of application No. 30/011,131, filed on Jul. 1, 2025.
(63) Continuation-in-part of application No. PCT/US25/36335, filed on Jul. 2, 2025.
(60) Provisional application No. 63/781,207, filed on Mar. 31, 2025.

(51) Int. Cl. B60N 3/04; A47G 27/02

(52) U.S. Cl. CPC B60N 3/048; A47G 27/02

(57) ABSTRACT

Articles with raised-portions and recessed-portions, like tires, soles-of-footwear, floormats, vehicle-liners, and coasters, have at least some of the raised-portions be a color and have at least some of the recessed-portions be a different color. This coloring difference enhances visibility of the given article. For tires this may be done by fitting a colored tire-band within a groove of a tire; by fitting a colored sleeve over at least a portion of a tire; or by a machine operating upon an initially untreaded tire to form a treaded tire. For soles-of-footwear, floormats, vehicle-liners, and coasters, this may be done by a machine operating upon an initial article without recessed-portions to form those recessed-portions or upon an initial article without raised-portions to form those raised-portions. The machines may be CNC or 3D printing machines. Light-emitting-element(s) may also be added to bottoms of the recessed-portions.

### PRIORITY NOTICE

The present (instant) U.S. nonprovisional patent application, a continuation-in-part (CIP) patent application, claims priority under 35 U.S.C. § 120 to U.S. nonprovisional patent application Ser. No. 19/256,815, filed on Jul. 1, 2025; wherein the disclosure of which is incorporated herein by reference in its entirety (as if fully set forth herein); wherein both of these U.S. nonprovisional patent applications, including the current U.S. nonprovisional patent application, are all from the same inventor (of John Richard Taylor).

The present (instant) U.S. nonprovisional patent application, a continuation-in-part (CIP) patent application, claims priority under 35 U.S.C. § 120 to U.S. nonprovisional patent application Ser. No. 30/011,131, filed on Jul. 1, 2025; wherein the disclosure of which is incorporated herein by reference in its entirety (as if fully set forth herein); wherein both of these U.S. nonprovisional patent applications, including the current U.S. nonprovisional patent application, are all from the same inventor (of John Richard Taylor).

The present (instant) U.S. nonprovisional patent application, a continuation-in-part (CIP) patent application, claims priority under 35 U.S.C. § 120 to PCT international patent application serial number PCT/US25/36335, filed on Jul. 2, 2025; wherein the disclosure of which is incorporated herein by reference in its entirety (as if fully set forth herein); wherein both of these U.S. nonprovisional patent applications, including the current U.S. nonprovisional patent application, are all from the same inventor (of John Richard Taylor).

The present (instant) U.S. nonprovisional patent application claims priority under 35 U.S.C. § 119(e) to co-pending U.S. provisional patent application Ser. No. 63/781,207 filed on Mar. 31, 2025; wherein the disclosure of which is incorporated herein by reference in its entirety (as if fully set forth herein); wherein this co-pending U.S. provisional patent application, as well as the current U.S. nonprovisional patent application, are all from the same inventor (of John Richard Taylor).

### TECHNICAL FIELD OF THE INVENTION

The present invention relates in general to physical (tangible) articles with raised portions (e.g., ridges) and recessed portions (e.g., grooves), such as, but not limited to, tires for motor vehicles and automobiles, bottoms of footwear (e.g., soles of shoes), mats, and floormats (e.g., vehicle floormats), and vehicle liners (e.g., truck bed liners); and more specifically to the raised portions (or portions thereof) being of first particular color(s) and bottoms of the recessed portions (or portions thereof) being of second particular color(s), wherein the first particular color(s) may be different color(s) from the second particular color(s).

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Circa 2024 and historically, (rubber) tires for motor vehicles and automobiles, such as, but not limited to, cars; sedans; coups; vans; minivans; pick-up trucks; sport utility vehicles (SUVs); crossovers; motorcycles; trucks; flatbed trucks; box trucks; container trucks; semi-trucks; delivery trucks; jeeps; busses; trailers; ATVs (all-terrain vehicles); quads; motorhomes; RVs (recreational vehicles); fifth wheels; dune buggies; sand rails; bicycles; tricycles; quadracycles; scooters; wagons; chariots; buggies; wheeled vehicles; partially wheeled vehicles; airplanes, helicopters, and/or flying vehicles' landing wheeled gear; combinations thereof; and/or the like, that drive on and/or roll on roads, streets, highways, interstates, freeways, driveways, loading docks, boat ramps, runways, taxiways, tarmacs, sidewalks, concrete surfaces, asphalt surfaces, gravel surfaces, substantially (mostly) flat surfaces, and/or the like, and whether or not paved or unpaved, have had and have used (rubber) tires where the tread and the groove(s) between tread elements (such as, but not limited to, tread blocks and/or tread ribs) have been of a singular (uniform) color, namely black, and/or without any light emission from light source(s) and/or from glow in the dark source(s).

However, many users, drivers, enthusiasts, hobbyists, and/or owners of such motor vehicles and automobiles often desire and often do after market customizations of the look (and sometimes of the functions) of their motor vehicles and automobiles in various ways. For example, there are custom vehicle wraps (e.g., often of vinyl) to cover over most of a vehicle's exterior body; there are custom paint jobs; there are customizable door handle covers; there are aftermarket wheels; there are aftermarket hub cabs; there are aftermarket brakes (e.g., often of a given bright color [e.g., red, yellow, or green]); there are aftermarket bumpers; there are aftermarket fenders; there are aftermarket grilles; there are aftermarket vehicular lights (e.g., brake lights, headlights, taillights, turn signal lights, reverse lights, and/or running lights); there are aftermarket winches; there is aftermarket window tinting; there are aftermarket tires; there are aftermarket windshield wipers; there are aftermarket trailer hitches; there are aftermarket running boards; there are aftermarket LED light strips (e.g., for under a chassis); combinations thereof; and/or the like.

Historically, at best, one could sometimes get a tire with a sidewall that was white, as in whitewall tires.

But there currently is not a good, affordable, reliable, durable, and/or dependable way to alter and/or change that default black color of the tire's tread and/or grooves into a different color of choice.

For example, tire manufacturers generally develop specific tooling and with specific materials of construction to make thousands upon thousands of a given identical tire model, that are generally all of the exact same (black) color; and it does not make financial sense for those tire manufacturers to do short runs of one tire model in a multitude of different colors.

For example, merely painting some or all of an existing black tire is not a good means for altering the tire's color, because that applied paint simply wears off far too quickly (e.g., from road friction and/or weather).

There is a need in the art for parts, components, systems, portions, regions, and/or methods of changing the color of a tire's tread and/or of a tire's groove to a different (desired) color(s). For example, maintaining a tire with normal (default) black tread elements, but having bottoms of at least some of the tire's recessed-portions being at least one predetermined color, other than black, may result in a tire that much more visible to external observers. Such a higher visibility tire may aid in vehicle safety and/or in parked vehicle location determination. Additionally, being able to color tires may then allow color coding to be applied for vehicle fleet management purposes, wherein particular color coding of the tire of a given vehicle may correspond to various functions and/or purposes. There is a need for being able to color raised-portions (e.g., tread elements) of tires differently from recessed-portions (e.g., grooves, channels, dimples, and/or the like) of tires.

Similarly, there is a need for being able to color raised-portions differently from recessed-portions in other articles, such as, but not limited to, a sole of footwear, a floormat (such as, but not limited to, a vehicle-floormat), a vehicle liner (such as, but not limited to, a pickup truck bed liner), a coaster, and/or the like. Having raised-portions colored differently from recessed-portions, of a given article, may enhance visibility of the given article. Enhanced visibility may aid in enhancing safety, in helping to gauge if the given article may be clean or dirty, and/or the like.

It is to these ends that the present invention has been developed.

### BRIEF SUMMARY OF THE INVENTION

To minimize the limitations in the prior art, and to minimize other limitations that will be apparent upon reading and understanding the present specification, embodiments of the present invention describe a band and/or a sleeve (slick) that is/are configured for use on a tire, e.g., of a wheel, such as, but not limited to, of an automobile, a motor vehicle, and/or at least a partially wheeled vehicle. In some embodiments, the band may be of at least one predetermined color and/or with an ability to light up. In some embodiments, that band may be configured to be attached to (onto and/or over) and/or formed (created) in a groove of a tire (such as, but limited to, a groove that runs between tread elements of the given tire). In some embodiments, the sleeve (slick) may be of at least one predetermined color and/or with an ability to light up. In some embodiments, the sleeve may be configured to be attached over grooves and/or over the tread of a tire, e.g., of a wheel, such as, but not limited to, of an automobile, a motor vehicle, and/or at least a partially wheeled vehicle. In some embodiments, by use of such band(s) and/or sleeve(s), a (vehicle or at least a partially wheeled device) user may impart a desired color and/or lighting effect emanating from at least from the groove(s) and/or of the tread of their (vehicle's) tire(s). In some embodiments, a band in a groove or a sleeve over a tire's tread, may stay in place by one or more of the following: appropriate sizing with respect to the groove or the tire's tread, squeezing (e.g., the band squeezing the groove or the sleeve squeezing the tread), friction, interference fit, adhesive, glue, welding, combinations thereof, or the like.

In some embodiments, the material(s) that form a given band and/or a given sleeve or a different material, may be configured to at least partially fill in and attach within void volume spaces on the bottom of footwear (such as, but not limited to, a bottom sole of a shoe). In some embodiments, such material(s) may be of at least one predetermined color and/or with an ability to light up.

To minimize the limitations in the prior art, and to minimize other limitations that will be apparent upon reading and understanding the present specification, embodiments of the present invention may describe articles with raised-portions and recessed-portions-such as, but not limited to, tires, soles-of-footwear, floormats, vehicle-liners, and/or coasters-may have at least some of the raised-portions be a color and may have at least some of the recessed-portions be a different color. This coloring difference enhances visibility of the given article. Enhanced visibility may provide an enhances safety function (feature) may making that given article more visible as compared to other articles without such different coloring (and/or with out such high contrast coloring). For tires this may be done: (1) by fitting a colored tire-band within a groove of a tire; (2) by fitting a colored sleeve over at least a portion of a tire; and/or (3) by a machine operating upon an initially untreaded tire (e.g., a tire-blank) to form a treaded tire (textured-tire). For soles-of-footwear, floormats, vehicle-liners, and/or coasters, this may be done by a machine operating upon an initial article without recessed-portions to form those recessed-portions or upon an initial article without raised-portions to form those raised-portions. The machines may be CNC or 3D printing machines. CNC machines may remove upper/top layers of material to reveal different colored underlayer(s). 3D printers may add colored layers (e.g., tread) upon other color layers (e.g., a tire's base layer). Light-emitting-element(s) (such as, but not limited to, LEDs) may also be added to bottoms of the recessed-portions.

It is an objective of the present invention to provide a part (a component) (e.g., a band) that may be (removably) attached to a groove of a tire (e.g., over and in the groove) to alter a color of that groove (e.g., by covering up the groove's default color with a different color(s) of the band).

It is another objective of the present invention to provide a part (a component) (e.g., a band) that may be (removably) attached to a groove of a tire (e.g., over and in the groove), wherein that part is configured to emit light.

It is another objective of the present invention to provide a part (a component) (e.g., a sleeve) that may be (removably) attached to a tire to alter a color of the tire's tread and/or groove(s) (e.g., by covering up the tread and/or groove's default color with a different color(s) of the sleeve).

It is another objective of the present invention to provide a part (a component) (e.g., a sleeve) that may be (removably) attached to a tire, wherein that part is configured to emit light.

It is another objective of the present invention to provide a blank-tire, i.e., a tire without any treads (that may then be operated upon to form treads).

It is another objective of the present invention to provide a blank-tire with embedded hidden colored layer(s) and/or element(s).

It is another objective of the present invention to provide a finalized and/or finished textured-tire (treaded-tire) that may be formed from a given blank-tire.

It is another objective of the present invention to provide a finalized and/or finished textured-tire (treaded-tire) that may be formed from a given blank-tire by use of a machine, such as, but not limited to, a CNC machine and/or a 3D printer.

It is another objective of the present invention to provide a finalized and/or finished textured-tire (treaded-tire) that may have at least some of its recessed-portions being a color that may be different from the tread color.

It is another objective of the present invention to provide a finalized and/or finished textured-tire (treaded-tire) with embedded colored wear-gauge that only becomes visible upon sufficient wearing down of the treads.

It is another objective of the present invention to provide material, of at least one predetermined color and/or with an ability to light up, that is configured to at least partially fill in and attach within void volume spaces on the bottom of footwear (such as, but not limited to, a bottom sole of a shoe).

It is another objective of the present invention to provide a sole-of-footwear that may have at least some of its recessed-portions being a color that may be different from its raised-portions.

It is another objective of the present invention to provide tires where the raised tread elements are a color and bottoms of the recessed portions are a different color for a purpose of enhancing visibility of the tire.

It is another objective of the present invention to provide tires where the raised tread elements are a color and bottoms of the recessed portions are a different color for a purpose of providing a visually high contrast tire for enhancing visibility of the tire.

It is another objective of the present invention to provide tires where the raised tread elements are a color and bottoms of the recessed portions are a different color for a purpose of enhancing safety of a vehicle utilizing such a tire.

It is another objective of the present invention to provide tires where the raised tread elements are a color and bottoms of the recessed portions are a different color for a purpose of using color coding for vehicle fleet management of vehicle(s) utilizing such color coded tire(s).

It is another objective of the present invention to provide a custom manufactured tire with a tread pattern and tread depth that may match a tread pattern and a tread depth of a preexisting tire and regardless of that preexisting tire's state of tread wear.

It is another objective of the present invention to provide sole(s)-of-footwear where the raised elements are a color and bottoms of the recessed portions are a different color for a purpose of enhancing visibility of the footwear.

It is another objective of the present invention to provide sole(s)-of-footwear where the raised elements are a color and bottoms of the recessed portions are a different color for a purpose of providing a visually high contrast footwear for enhancing visibility of the footwear.

It is another objective of the present invention to provide sole(s)-of-footwear where the raised elements are a color and bottoms of the recessed portions are a different color for a purpose of enhancing pedestrian safety of a person wearing such footwear.

It is another objective of the present invention to provide sole(s)-of-footwear where the raised elements are a color and bottoms of the recessed portions are a different color for a purpose of using color coding for personnel uniform management of uniform(s) utilizing such color coded footwear.

It is another objective of the present invention to provide a floormat (such as, but not limited to, a vehicle floormat) that may have at least some of its recessed-portions being a color that may be different from its raised-portions.

It is another objective of the present invention to provide a vehicle-liner (such as, but not limited to, a pickup truck liner) that may have at least some of its recessed-portions being a color that may be different from its raised-portions.

It is another objective of the present invention to provide floormats where the raised elements are a color and bottoms of the recessed portions are a different color for a purpose of providing enhancing visibility of the floormat.

It is another objective of the present invention to provide floormats where the raised elements are a color and bottoms of the recessed portions are a different color for a purpose of providing a visually high contrast floormat for enhancing visibility of the floormat.

It is another objective of the present invention to provide floormats where the raised elements are a color and bottoms of the recessed portions are a different color for a purpose of enhancing an ability to determine if the floormat is clean or dirty by making dirt upon the floormat easier to see.

It is another objective of the present invention to provide vehicle-liners where the raised elements are a color and bottoms of the recessed portions are a different color for a purpose of providing enhancing visibility of the vehicle-liner.

It is another objective of the present invention to provide vehicle-liners where the raised elements are a color and bottoms of the recessed portions are a different color for a purpose of providing a visually high contrast vehicle-liner for enhancing visibility of the vehicle-liner.

It is yet another objective of the present invention to provide vehicle-liners where the raised elements are a color and bottoms of the recessed portions are a different color for a purpose of enhancing an ability to determine if the vehicle-liner is clean or dirty by making dirt upon the vehicle-liner easier to see.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1A (prior art) shows a perspective view of a generic tire.

FIG. 1B (prior art) shows a portion of a front (rear, top, and/or bottom) view of a generic tire.

FIG. 1C (prior art) shows a portion of a front (rear, top, and/or bottom) view of a generic tire.

FIG. 1D (prior art) shows a portion of a front (rear, top, and/or bottom) view of a generic tire.

FIG. 1E (prior art) shows a perspective view of a generic tire along with its associated wheel.

FIG. 1F (prior art) shows a front (rear, top, and/or bottom) schematic view of a generic tire.

FIG. 2A shows a front (rear, top, and/or bottom) schematic view of the tire of FIG. 1, wherein at least one of a groove of that tire is at least partially covered over by a band.

FIG. 2B is perspective view of a single band shown by itself (that is configured for use on a groove of a tire).

FIG. 2C shows a perspective view of a tire side-by-side with a band, wherein the band is configured for attachment to a groove of the tire.

FIG. 2D shows a portion of a front (rear, top, and/or bottom) view of a generic tire with at least one band attached to a groove of that tire.

FIG. 2E is a perspective view showing a portion of a modified-tire fitted with at least one tire-band in a groove of that tire.

FIG. 2F is a top view showing a portion of a modified-tire fitted with at least one tire-band in a groove of that tire. (Note, because of the radial symmetry of a tire, this top view could be a bottom view, a front view, or a rear view.)

FIG. 2G shows a portion of a front (rear, top, and/or bottom) view of a generic tire with at least one band application means for attaching and/or forming at least one band attached to a groove of that tire.

FIG. 2H shows caulk applicator (gun) in a form factor of a caulk gun or gun like applicator that uses at least one applicator tip to dispense band-material (in a wet, liquid, slurry, gel, uncured, and/or the like form) to groove(s) of a given tire.

FIG. 2I shows another version and/or embodiment of a given caulk applicator (gun) that is configured for extruding hot, melted, liquid, and/or flowable band-material from its applicator tip to adhere to groove(s) of a given tire.

FIG. 3A shows a perspective view of a tire side-by-side with a sleeve, wherein that sleeve is configured for attachment to that tire (the sleeve in FIG. 3A may be an untextured sleeve in some embodiments).

FIG. 3B shows a perspective view of a tire side-by-side with a textured sleeve, wherein that textured sleeve is shown removed and/or detached from that tire.

FIG. 3C shows a perspective view of a given tire that has been fitted with a given sleeve.

FIG. 3D shows a front (rear, top, and/or bottom) schematic view of the tire of FIG. 1, wherein at least most of the grooves and/or the tread of that tire are covered over by a sleeve.

FIG. 3E in one embodiment shows a removal machine (e.g., a CNC machine) (or the like) operating on a blank-tire (tire-blank) to form a textured-tire from that blank-tire by cutting and/or routing material out of that blank-tire.

FIG. 3F shows a cross-sectional view through an upper portion of a tire and in a process of converting a blank-tire (tire-blank) form factor of the tire into a finalized textured-tire, by using a removal-machine.

FIG. 3G shows a cross-sectional view through an upper portion of a tire and in a process of converting a blank-tire (tire-blank) form factor of the tire into a finalized textured-tire, by using a removal-machine; in FIG. 3G the tire may have embedded band(s) of particular color(s).

FIG. 3H shows a top view of a given blank-tire (tire-blank); and FIG. 3H includes sectional-line 3I-3I. (Note, because of the radial symmetry of a tire, this top view could be a bottom view, a front view, or a rear view.) FIG. 3I is a cross-sectional view of a given blank-tire (tire-blank), from sectional-line 3I-3I shown in FIG. 3H.

FIG. 3J shows a cross-sectional view through an upper portion of a tire and in a process of converting a blank-tire (tire-blank) form factor of the tire into a finalized textured-tire, by using a removal-machine; in FIG. 3J the tire may have embedded sheet(s) of particular color(s).

FIG. 3K shows a top view of a given blank-tire (tire-blank). (Note, because of the radial symmetry of a tire, this top view could be a bottom view, a front view, or a rear view.) FIG. 3L shows a cross-sectional view through an upper portion of a tire and in a process of converting a blank-tire (tire-blank) form factor of the tire into a finalized textured-tire, by using an additive-machine (e.g., a 3D printer).

FIG. 3M shows a cross-sectional view through an upper portion of a tire and in a process of converting a blank-tire (tire-blank) form factor of the tire into a finalized textured-tire, by using a removal-machine; in FIG. 3M a particular colored region may be found on the tire's sidewall.

FIG. 3N shows a cross-sectional view through an upper portion of a tire and in a process of converting a blank-tire (tire-blank) form factor of the tire into a finalized textured-tire, by using a removal-machine; in FIG. 3N a particular colored region may be found on the tire's sidewall.

FIG. 3O is a perspective cross-sectional view through an upper portion of a given blank-tire (tire-blank).

FIG. 3P is a perspective cross-sectional view through an upper portion of a given textured-tire (that may be made from a given blank-tire).

FIG. 3Q is a cross-sectional view through an upper portion of a given blank-tire (tire-blank).

FIG. 3R is a cross-sectional view through an upper portion of a given textured-tire (that may be made from a given blank-tire).

FIG. 4 shows a view of a means for forming a sleeve on a tire by dipping the tire within a bath of fluid.

FIG. 5 shows a perspective view of a tire side-by-side with a sheet, wherein that sheet may form a sleeve once attached to the given tire.

FIG. 6A shows at least one electronic circuit as part of a portion of a band or as part of a portion of a sleeve.

FIG. 6B shows at least one LED light strip as being part of at least one band.

FIG. 6C shows at least one LED light strip as being part of a given sleeve.

FIG. 6D shows partial views of a tire-band in both its unstretched configuration and in its stretched configuration.

FIG. 7A shows a bottom view of a pair of shoes (footwear), such that the bottom of the soles is being shown, wherein the exterior appearance of the sole(s) may be of at least two different colors.

FIG. 7B shows a bottom view of a pair of shoes (footwear), such that the bottom of the soles is being shown, wherein the exterior appearance of the sole(s) may be of at least two different colors.

FIG. 8A shows a perspective view of a subassembly both in an exploded (dissembled or pre-assembled) configuration and in an assembled configuration, wherein this subassembly may be acted upon to yield a tire or footwear sole that shows at least different colors.

FIG. 8B shows an outer view of the subassembly of FIG. 8A being converted into an assembly by use of a removal machine (such as, but not limited to, a CNC machine).

FIG. 9A shows a perspective view of subassembly both in an exploded (dissembled or pre-assembled) configuration and in an assembled configuration, wherein this subassembly may be acted upon to yield a tire or footwear sole that shows at least different colors.

FIG. 9B shows an outer view of the subassembly of FIG. 9A being converted into an assembly by use of an additive machine (such as, but not limited to, a 3D printer).

FIG. 10A shows a cross-sectional view through an upper portion of an article with raised-portions and recessed-portions; in FIG. 10A the article may have embedded band(s) of particular color(s).

FIG. 10B shows a cross-sectional view through an upper portion of an article with raised-portions and recessed-portions; in FIG. 10B the article may have embedded wear-gauge(s) of particular color(s).

FIG. 10C shows a cross-sectional view through an upper portion of an article with raised-portions and recessed-portions; in FIG. 10C the article may have embedded sheet(s) of particular color(s).

FIG. 11 is a top view of a tire with raised-portions (e.g., tread) and recessed-portions, wherein at least some of the bottom of the recessed-portions may be a particular color that may be different from a color of the tread. (Note, because of the radial symmetry of a tire, this top view could be a bottom view, a front view, or a rear view.)

FIG. 12A is perspective view of a tire with raised-portions (e.g., tread) and recessed-portions, wherein at least some of the bottom of the recessed-portions may be a particular color that may be different from a color of the tread.

FIG. 12B is a top view of the tire from FIG. 12A, with raised-portions (e.g., tread) and recessed-portions, wherein at least some of the bottom of the recessed-portions may be a particular color that may be different from a color of the tread. (Note, because of the radial symmetry of a tire, this top view could be a bottom view, a front view, or a rear view.)

FIG. 13 is a top view of a tire with raised-portions (e.g., tread) and recessed-portions, wherein at least some of the bottom of the recessed-portions may be a particular color that may be different from a color of the tread. (Note, because of the radial symmetry of a tire, this top view could be a bottom view, a front view, or a rear view.)

FIG. 14 is a perspective view of a group of vehicle floormats, wherein each such floormat may have raised-portions and recessed-portions, wherein at least some of the bottoms of the recessed-portions may be a particular color that may be different from a color of the raised-portions.

FIG. 15 is a perspective view of a portion of a vehicle-liner (e.g., a pickup truck bed liner), wherein the vehicle-liner may have raised-portions and recessed-portions, wherein at least some of the bottoms of the recessed-portions may be a particular color that may be different from a color of the raised-portions.

FIG. 16 is a perspective view of a machine (such as, but not limited to, a CNC machine or a 3D printer) used to form at least some embodiments of finished articles.

FIG. 17 is a perspective view of a machine (such as, but not limited to, a CNC machine or a 3D printer) used to form at least some embodiments of finished articles.

FIG. 18 shows a formula (equation), variable, and example for calculating centrifugal force of a particular tire spinning.

FIG. 19 shows a table of different calculated (determined) centrifugal forces according to FIG. 18.

FIG. 20 is a color photograph of a tire (modified-tire) fitted with at least one tire-band in a groove of that tire, shown from a perspective view.

FIG. 21 is a color photograph of a tire (modified-tire) fitted with at least one tire-band in a groove of that tire, shown from a top view. (Note, because of the radial symmetry of a tire, this top view could be a bottom view, a front view, or a rear view.)

FIG. 22 is a color photograph of a tire where its raised-portions (e.g., its tread) are colored differently from bottoms of its recessed-portions, shown form a perspective view.

FIG. 23 is a color photograph of a tire where its raised-portions (e.g., its tread) are colored differently from bottoms of its recessed-portions, shown form a perspective view.

FIG. 24 is a color photograph of a tire where its raised-portions (e.g., its tread) are colored differently from bottoms of its recessed-portions, shown form a perspective view.

FIG. 25 is a color photograph of a tire where its raised-portions (e.g., its tread) are colored differently from bottoms of its recessed-portions, shown form a perspective view.

FIG. 26 is a color photograph of a tire where its raised-portions (e.g., its tread) are colored differently from bottoms of its recessed-portions, shown form a perspective view; FIG. 26 also shows that at least some portions of the sidewall may have a particular color.

FIG. 27 is a color photograph of a bottom of a sole-of-footwear, where its raised-portions are colored differently from bottoms of its recessed-portions, shown form a bottom view.

FIG. 28 is a color photograph of a top of a floormat (such as, but not limited to, a vehicle floormat), where its raised-portions are colored differently from bottoms of its recessed-portions, shown form a top view.

### REFERENCE NUMERAL SCHEDULE

100 tire 100
100a modified-tire 100a
101 tread 101
103 groove (tread void groove) 103
105 (outside) diameter of groove 105
107 sidewall 107
109 shoulder 109
111 block (tread block) 111
113 rib 113
115 sipe 115
117 dimple 117
150 wheel 150
190 surface (road surface, ground, or floor) 190
200 band for groove 200
200a uncured or flowable band material 200a
205 stretched diameter of band 205
207 unstretched diameter of band 207
251 caulk applicator (gun) 251
252 applicator tip 252
253 spray applicator 253
255 brush applicator 255
257 tape 257 p1 261 elongate-tool 261
271 material-to-be-melted 271
281 electrical-power-cord 281
283 handle 283
300 sleeve (slick) 300
300a untextured (blank) sleeve (untextured tire) 300a
300b textured sleeve (textured article) (textured tire) 300b
300c blank-tire (tire-blank) 300c
300d textured-tire 300d
301 raised-portion (tread) 301
302 region-of-first-color (region-of-color) 302
303 recessed-portion (e.g., channel and/or groove) 303
304 region-of-second-color (region-of-color) 304
305 wear-depth-gauge (tread-depth-gauge) 305
307 depth-of-groove (recessed-depth) 307
309 depth-of-gauge 309
311 exterior-surface 311
313 interior-surface 313
315 center (axial center) 315
351 removal machine or additive machine 351
352 removal-element (removal-tool or tool-head) 352
353 direction-of-tool-movement 353
354 print-head 354
361 belt 361
363 body ply 363
365 bead 365
367 bead filler 367
369 inner-liner 369
371 sidewall 371
381 tread-precursor-material 381
383 outer exterior surface 383
393 outer exterior surface of formed treads 393
400 dipping bath 400
401 fluid-sleeve-material 401
405 out-of-bath 405
500 sheet (planar) material 500
501 heat source (heat means) 501
503 heat 503
600 circuit 600
601 LED (light emitting diode) light source 601
603 power-source 603
605 controller 605
611 LED light strip 611
613 reflector (reflective material) 613
615 to stretched configuration 615
617 to unstretched configuration 617
650 article 650
701 sole of shoe (sole of footwear or sole-of-footwear) 701
703 raised portion 703
705 recessed region 705
711 fill-material 711
721 added-material 721
800 subassembly 800
801 substrate 801
803 first-layer (inner-layer) 803
805 second-layer (outer-layer) 805
807 outermost-added-layer (e.g., tread or raised-portion) 807
811 assembly 811
813 vacuum chamber 813
815 vacuum pump 815
900 subassembly 900
911 assembly 911
1000 textured article 1000
1001 raised-portion 1001
1002 region-of-first-color (region-of-color) 1002
1003 recessed-portion 1003
1004 region-of-second-color (region-of-color) 1004
1005 wear-depth-gauge 1005
1007 depth-of-groove (depth-of-recess or recessed-depth) 1007
1009 depth-of-gauge 1009
1011 exterior-surface 1011
1013 exterior-environment 1013
1100 tire 1100
1101 raised-portion (tread) 1101
1103 recessed-portion 1103
1200 tire 1200
1201 raised-portion (tread) 1201
1300 tire 1300
1301 raised-portion (tread) 1301
1303 recessed-portion 1303
1400 floormat 1400
1401 raised-portion 1401
1403 recessed-portion 1403
1500 vehicle-liner (bedliner, bed liner, or bed-liner) 1500
1501 raised-portion 1501
1503 recessed-portion 1503
1550 cargo 1550
1701 support-for-article 1701

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

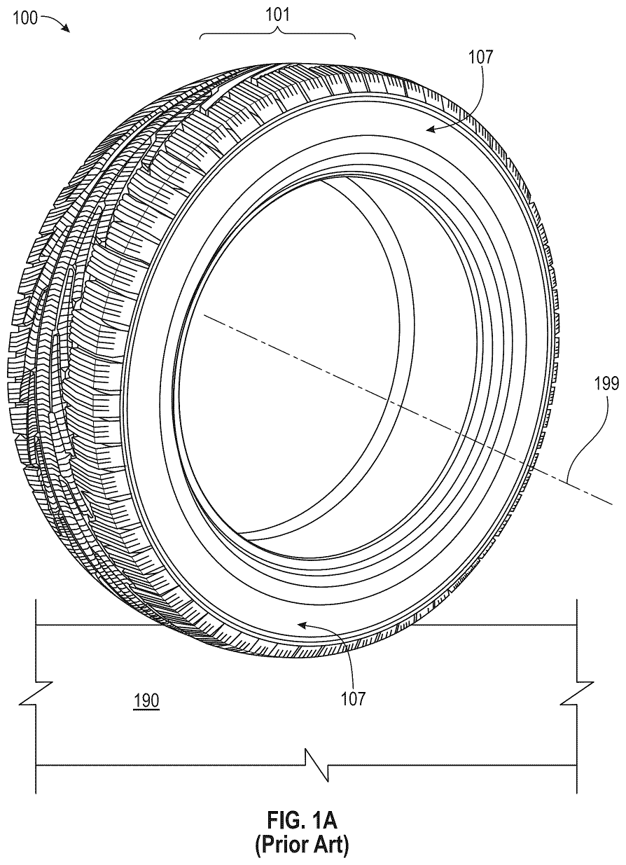

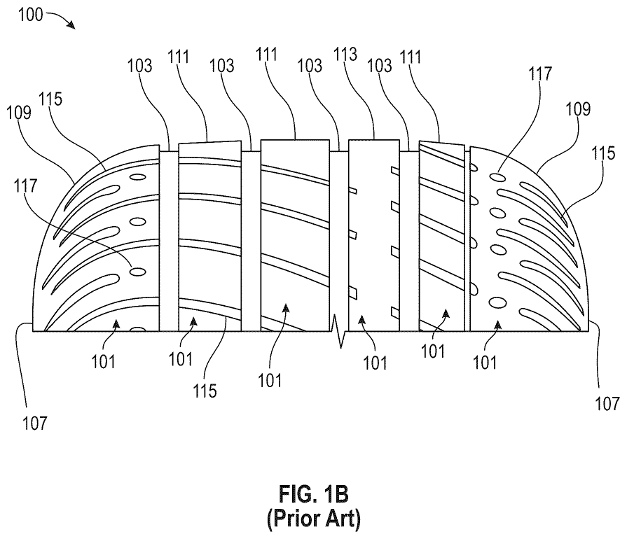

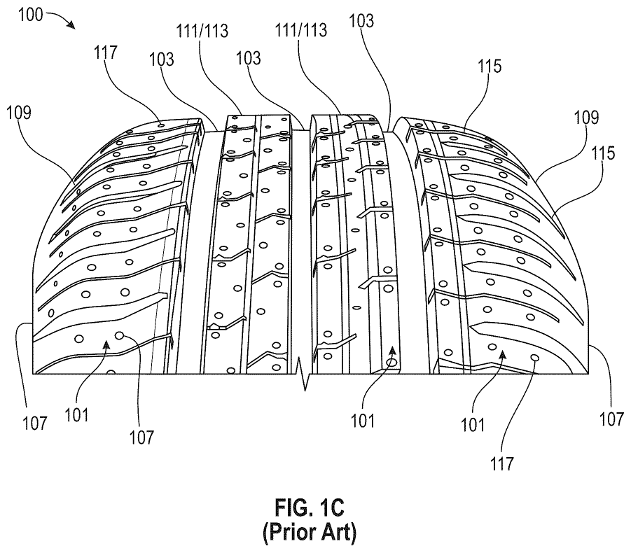

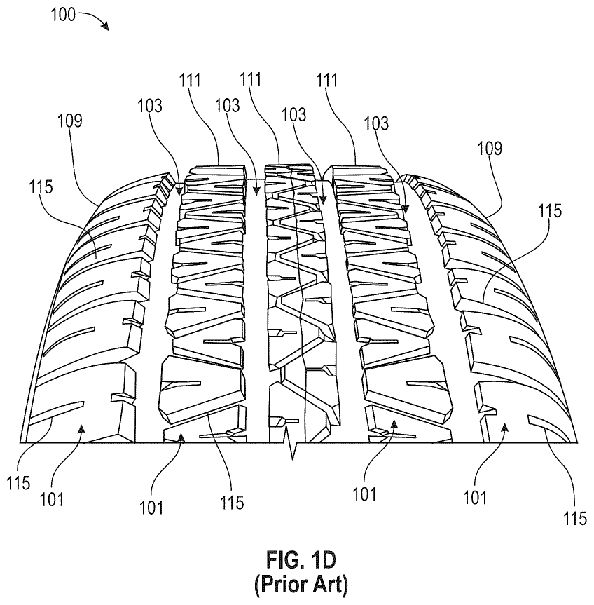

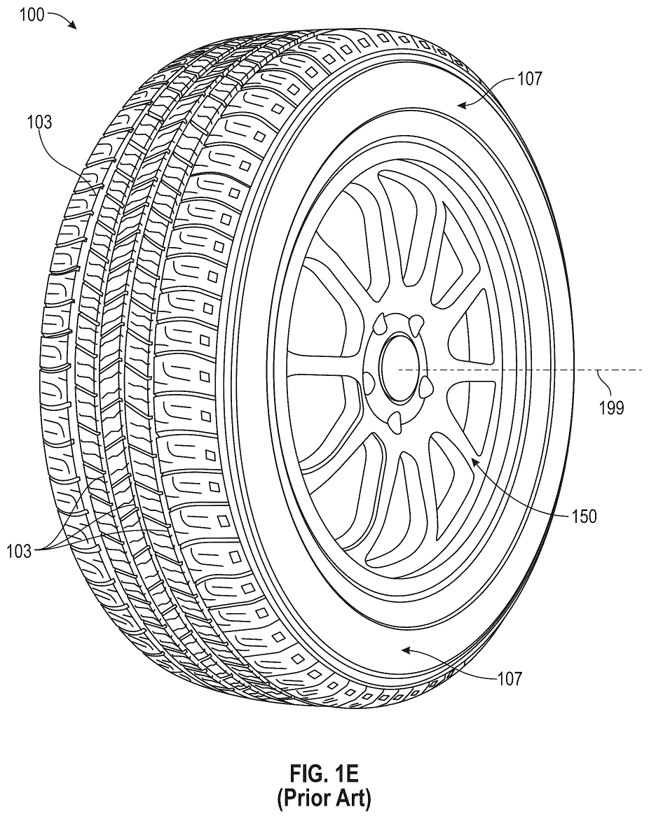

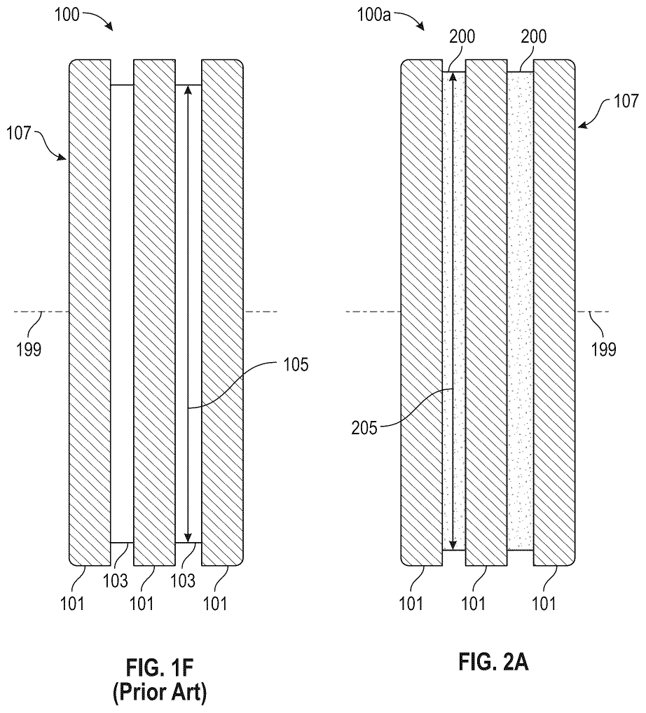

FIG. 1A shows a perspective (isometric) view of a generic tire 100, without its associated wheel 150 (and/or without its associated innertube). Note, see FIG. 1E for wheel 150 (i.e., wheel 150 is not shown in FIG. 1A). Note, tire 100 as shown in FIG. 1A are prior art. FIG. 1A shows that at least most (a majority) of a tread 101 portion (region) of tire 100 being at least mostly perpendicular and/or orthogonal to a sidewall 107 of tire 100. Tread 101 are raised portions of tire 100 that are intended to come into contact with a road's surface during normal intended use as a rotating vehicle tire. FIG. 1A also shows axial centerline 199, which may be an imaginary line that tire 100 rotates about during intended and/or normal use as a rotating vehicle tire. A plane coincident with sidewall 107 (or a portion thereof) may be at least mostly perpendicular and/or orthogonal to axial centerline 199. Tire 100 is configured to be removably mounted to a wheel 150 of a motor vehicle and/or of an automobile, such as, but not limited to, a car; a sedan; a coup; a van; a minivan; a pick-up truck; a sport utility vehicle (SUV); a crossover; a motorcycle; a truck; a flatbed truck; a box truck; a container truck; a semi-truck; a delivery truck; a jeep; a bus; a trailer; an ATV (all-terrain vehicle); a quad; a motorhome; a RV (recreational vehicle); a fifth wheel; a dune buggy; a sand rail; a bicycle; a tricycle; a quadracycle; a scooter; a wagon; a chariot; a buggy; a wheeled vehicle; a partially wheeled vehicle; an airplane, a helicopter, and/or a flying vehicle's landing wheeled gear; combinations thereof; and/or the like, that drive on and/or roll on roads, streets, highways, interstates, freeways, driveways, loading docks, boat ramps, runways, taxiways, tarmacs, sidewalks, concrete surfaces, asphalt surfaces, gravel surfaces, substantially (mostly) flat surfaces, and/or the like, and whether or not paved or unpaved.

FIG. 1B shows a portion of a front (rear, top, and/or bottom) view of tire 100. FIG. 1B is prior art. Tire 100 has tread 101 elements (such as, but not limited to, tread blocks 111 and/or tread rib(s) 113). Tread blocks 111 and/or tread rib(s) 113, if any, are considered as portions and/or regions of the overall tread 101. Tread blocks 111 and/or tread rib(s) 113 are raised portions. Further, a presence of sipes 115 and/or dimples 117, if any, in the tread 101 may also play a role in an effectiveness and/or performance of the overall tread 101 with respect to traction and/or friction to a road surface 190 and/or with respect to shedding (releasing) undesirable road elements (such as, but not limited to, water, liquids, slurries, sand, gravel, and/or the like). Sipes 115 and/or dimples 117 are recessed portions. The tire 100 tread 101 elements may be separated a groove(s) 103 (tread void groove(s) 103). Groove(s) 103 are recessed portions. When the tread 101 of a given tire 100 wears down to a depth of a given groove(s) 103, that tire 100 is what is known as bald. In general, with respect to a given tire 100, an unworn tire 100 will have deeper groove(s) 103 than a worn tire 100. The groove(s) 103 may help shed water, slush, ice, snow, sand, salt, dirt, debris, and/or the like off of and/or away from treads 101; and may thus, help tread 101 maintain friction and/or traction against the given road surface 190. A single groove 103 of a given tire 100, may trace (follow) a circular and/or a circumferential path around a largest outside diameter of tread 101, but recessed from the exterior of tread 101, that forms a volume of void space in tread 101 (or next to [adjacent to] tread 101), wherein that volume of void space for a given groove 103 is at least mostly an annular disc in shape (between two adjacent treads 101 (tread block(s) 111 and/or rib(s) 113)). A single groove 103 of a given tire 100, may trace (follow) a circular and/or a circumferential path around an outside diameter of tire 10, that is recessed from the exterior of tread 101, that forms a volume of void space in tread 101 (or next to [adjacent to] tread 101), wherein that volume of void space for a given groove 103 is at least mostly an annular disc in shape (between two adjacent treads 101 (tread block(s) 111 and/or rib(s) 113)).

Continuing discussing FIG. 1B, an imaginary plane that is coincident with the circular and/or a circumferential path of a given groove 103 of a given tire 100 is typically (often) perpendicular and/or orthogonal to axial centerline 199. Although, in some tire models its groove(s) 103 may not be perfectly perpendicular and/or orthogonal to axial centerline 199. Additionally, some such groove(s) 103 may be continuous and unbroken all the way around the given tire 100 circumference. Whereas, in other tire 100 models, its groove(s) 103 may be interrupted or broken, i.e., not be continuous all the way around the given tire 100 circumference. Further, some groove(s) 103 may follow a strictly non-circular path (such as, but not limited to, a serpentine and/or zig-zag path) around the circumference of the given tire. Some tires 100 may have no groove(s) 103.

Parameters of the tread 101 and/or of the groove(s) 103 may be varied across different tire types (models), but are fixed and non-variable for a particular tire 100 (aside from changing due to temperature changes, centrifugal forces, vehicle loads, braking, and/or wearing down from use). Particular tire types (models) might include: snow tires, all terrain tires, commuter tires, tires of different durability, etc. (Of course, different sized tires 100 are configured for particular vehicle and/or wheel 150 needs.) These tire parameters of the tread 101 and/or of the groove(s) 103 might include: size, dimension, width, depth, shapes, patterns, quantity, presence of such elements, absence of such elements, ratios and/or relationships between such elements, a portion thereof, combinations thereof, and/or the like. Tread 101 and groove(s) 103, of a given tire 100, are integral and of a single article of manufacture. See e.g., FIG. 1A, FIG. 1B, FIG. 1C, FIG. 1D, and/or FIG. 1E for at least some variation in such tire parameters. Tread 101 and groove(s) 103, of a given tire 100, are of the same color, e.g., black.

Continuing discussing FIG. 1B, disposed between sidewall 107 and tread 101 of a given tire 100 is a transitional region, generally referred to as a shoulder 109. That is, the sidewall 107 will transition through shoulder 109 into the main tread 101 elements, although in many tires the shoulder 109 region will have tread elements to it as well (such as, but not limited to, sipe(s) 115 and/or dimple(s) 117). The main (majority) tread 101 elements (e.g., by mass and/or by surface area), are those tread 101 elements that are at least mostly perpendicular and/or orthogonal to sidewall 107 (or to a plane that is coincident with sidewall 107 or a portion of sidewall 107). Tread 101 elements are outer most exterior surfaces of tire 100 that are generally raised up from a bottom of a given groove 103. Tread 101 elements are those that are intended to make regular direct physical contact with a given road surface 190 during normal intended use of tire 100. During intended and/or normal operational use of a given tire 100, its sidewall 107 is intended to not make direct physical contact with the road surface 190 (but occasional physical contact with curbs and the like are intended and engineered for such contact). The sidewall 107 is generally devoice of tread 101 elements. The sidewall 107, or an exterior portion thereof, may be another color from the rest of the tire 100, such as white, as in “whitewall” tires. Also note, U.S. federally required markings (indicia), disclaimers, and/or notices are marked, displayed, and/or found in sidewalls 107 of tires 100; wherein these might include: U.S. Department of Transportation (DOT) identification number; tire ply composition and materials used; maximum load rating; treadwear, traction and temperature grades; maximum permissible inflation pressure; tire type (passenger care tire); nominal width of tire (in millimeters); aspect ratio (radio of height to width); rim diameter code; load index and speed symbol; and/or the like. These marking(s) on the sidewall 107 may be in a color other than black when the sidewall 107 is black; or these marking(s) may be black like the sidewall 107.

Continuing discussing FIG. 1B, the tread 101 may have one or more block 111 (tread block 111) and/or one or more ribs 113. The outer exterior surface of a given block 111 and/or of a given rib 113 is disposed away from a bottom of a given groove 103, which in part gives the given block 111 and/or the given rib 113 its tread functionality. For at least some embodiments of the present invention, distinguishing between a block 111 and a rib 113 may not be relevant. A given block 111 is generally surrounded in its sides (edges) by groove(s) 103 and/or sipe(s) 115; whereas, a rib 113 is generally delineated by two grooves 103 running around the sides of the given rib 113, i.e., a rib 113 is often at least substantially to totally free of sipe(s) 115. A raised disc that is raised above a pair of adjacent grooves 103 of a given tire 100 may be a rib 113 (and/or a tread block 111). Ribs 113 are often devoid of sipes 115, or least devoid of deep sipes 115 (or devoid of sipe(s) 115 that are as deep as in a given tread block 111). A sipe 115 is similar to a groove 103, except that sipes 115 generally have a narrower width and are less deep that a given groove 103. Additionally, sipes 115 generally run in different directions than grooves 103. Sipes 115 often run in directions that are parallel to a direction of axial centerline 199 to running in a direction that is less than ninety (90) degrees from a direction of axial centerline 199. Sipes 115 and grooves 103 rarely run in parallel directions to each other. And dimples 117 are like sipes 115, but shorter. Dimples 117 often resemble hemispherical or half ovoid carve outs in otherwise raised tread 101 material. One or more sipes 115 and/or one or more dimples 117 may be present on tread 101, on a block 111, on a rib 113, on a shoulder 109. Tread block(s) 111 and rib(s) 113 of tread 101 may all be raised portions; whereas, groove(s) 103, sipe(s) 115, and/or dimple(s) 117 are all recessed portions.

FIG. 1C and FIG. 1D are similar to FIG. 1B, in that all are views that show a portion of a front (rear, top, and/or bottom) view of tire 100; and all are prior art. FIG. 1B, FIG. 1C, and FIG. 1D merely differ in their respective tire parameters such as, but not limited to: size, dimension, width, depth, shapes, patterns, quantity, presence of such elements, absence of such elements, ratios and/or relationships between such elements, a portion thereof, combinations thereof, and/or the like; with respect to such elements as: tread 101, grooves 103, blocks 111, ribs 113, sipes 115, and/or dimples 117.

FIG. 1E shows a perspective view of tire 100 along with its associated wheel 150. FIG. 1E is prior art. FIG. 1E is similar to FIG. 1A, but at least a portion of wheel 150 is shown in FIG. 1E. Not shown in FIG. 1E, but disposed between an inside of tire 100 and an outer diameter of wheel 150 may be an innertube (that would typically be inflated to some predetermined minimum [tire] pressure).

Tire 100, tread 101, groove 103, outside diameter 105, sidewall 107, shoulder 109, tread block 111, rib 113, sipe 115, dimple 117, and/or portion(s) of tire 100 are all generally at least mostly (substantially) to entirely of a same and a single color. Tire 100, tread 101, groove 103, outside diameter 105, sidewall 107, shoulder 109, tread block 111, rib 113, sipe 115, dimple 117, and/or portion(s) of tire 100 are all generally at least mostly (substantially) to entirely all black. The only portions of a given prior art tire 100 that are not of the same and single color, might be its sidewall 107 (which is sometimes at least partially white) and/or marking(s) on that sidewall 107, wherein such marking(s) are sometimes not black. The only portions of a given prior art tire 100 that are not black, might be its sidewall 107 and/or marking(s) on that sidewall 107.

FIG. 1F shows a front (rear, top, and/or bottom) schematic view of tire 100. FIG. 1F is prior art. The groove 103 of a given tire 100 has an outside diameter 105. Note, as a tire 100 is used, its tread 101 will wear down (e.g., from repeated frictional abrasion) eventually to the diameter 105, in which case that tire 100 might be deemed bald; and/or may then become a candidate for retreading. Groove 103 follows a circumference of tire 100 around outside diameter 105. Outside diameter 105 is less than the largest outside diameter of tire 100, when tread 101 is at least substantially (mostly) unworn.

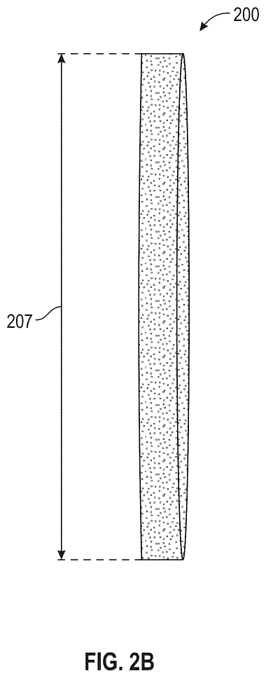

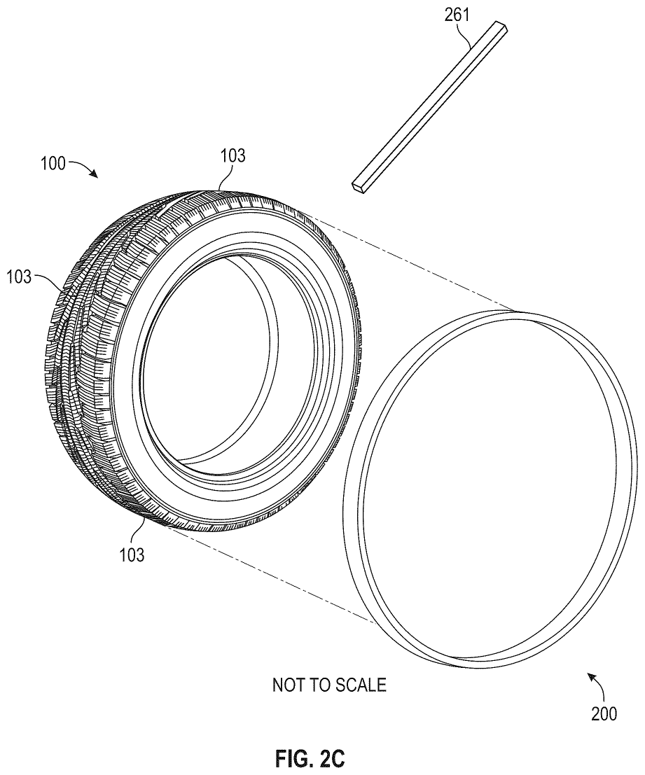

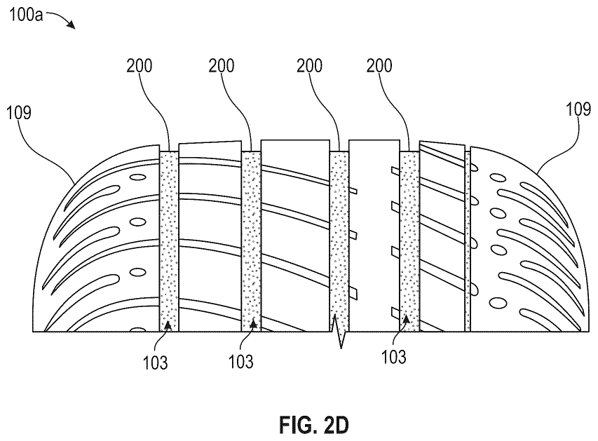

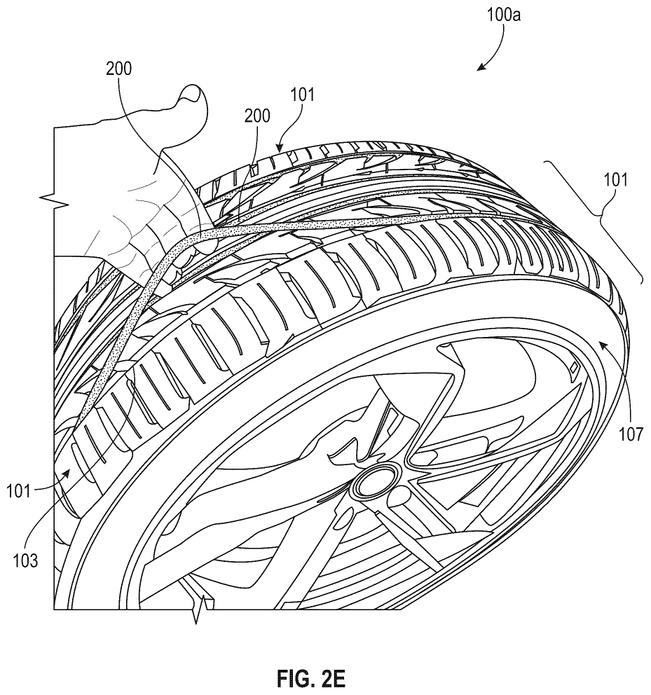

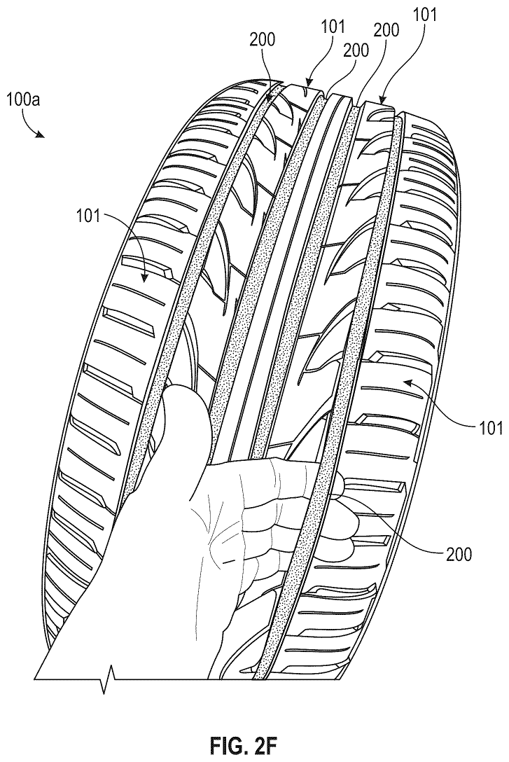

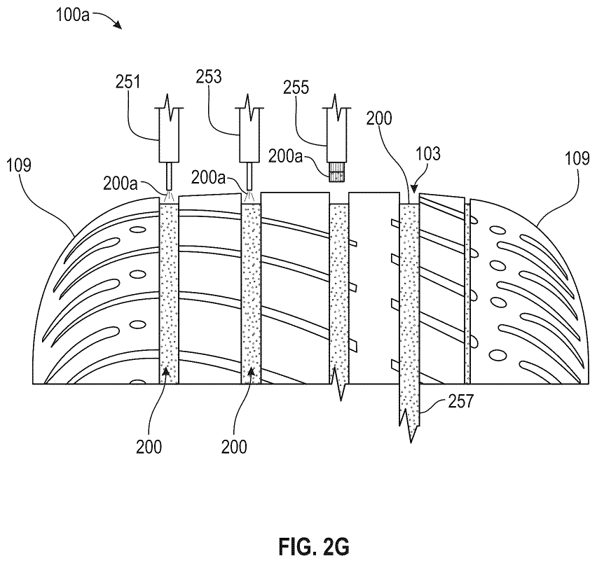

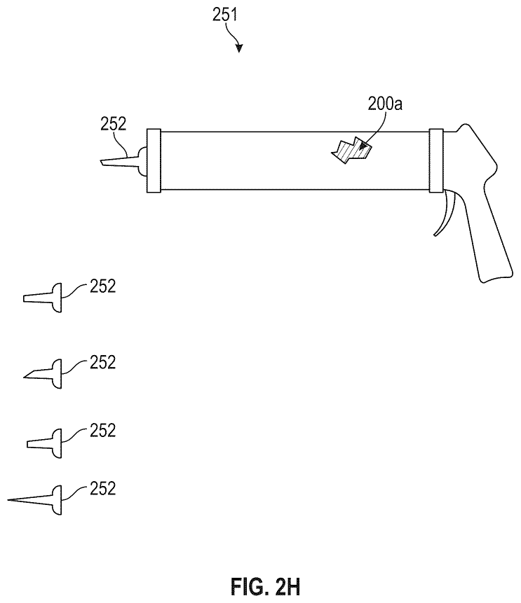

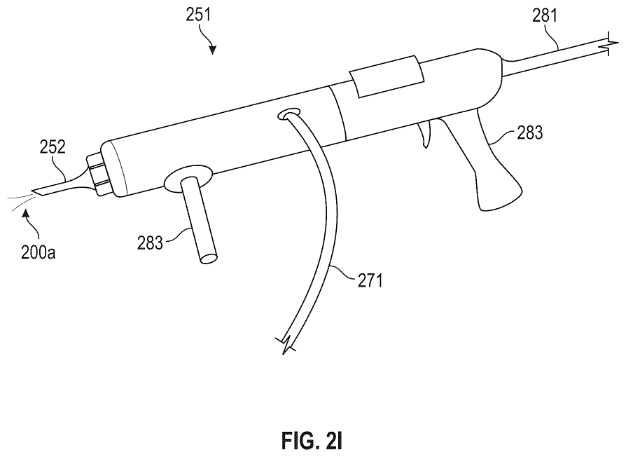

Note, FIG. 1F is intentionally shown side-by-side with FIG. 2A so that the prior art tire 100 (without band(s) 200) may be compared may be compared to a modified-tire 100a with band(s) 200. Tire 100 in FIG. 1F is without bands 200. Whereas, the tire 100a shown in FIG. 2A is with at least one band 200. But otherwise, FIG. 1F and FIG. 2A are of the same view type, i.e., a front (rear, top, and/or bottom) schematic view.

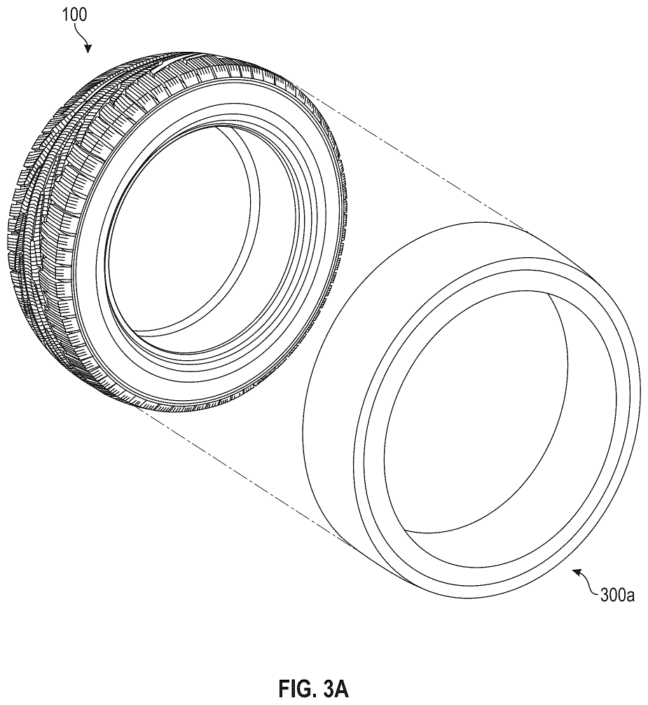

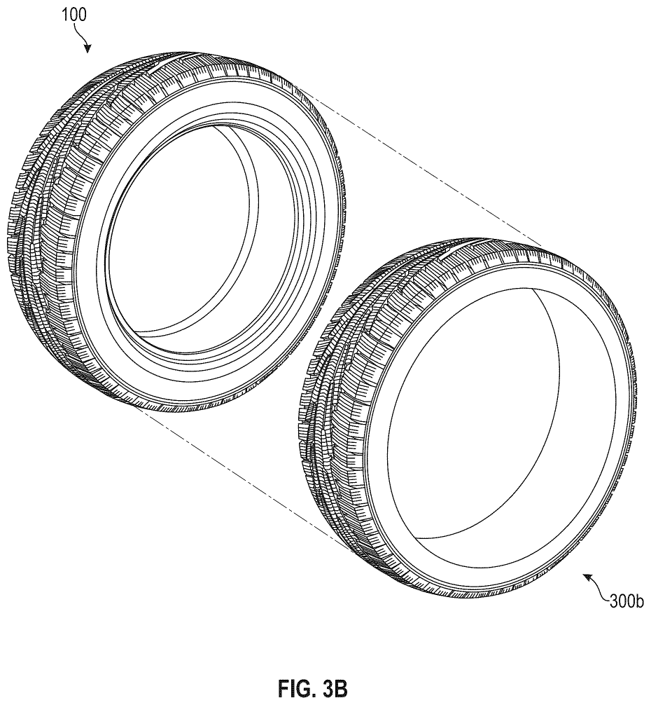

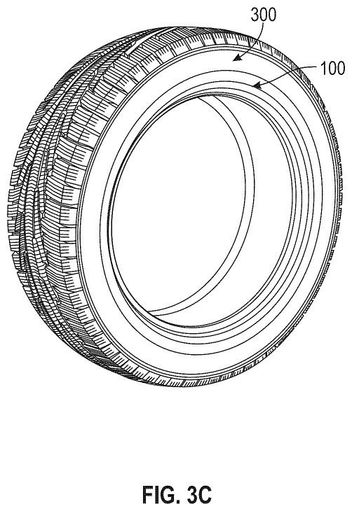

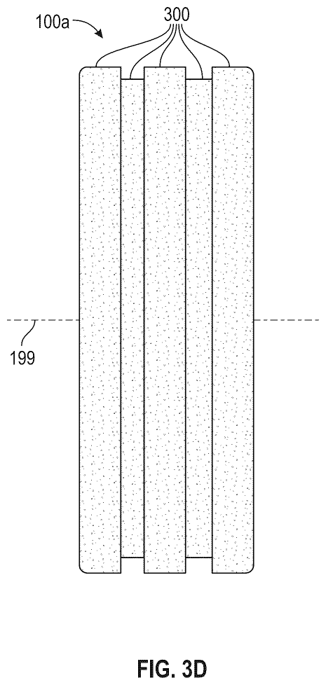

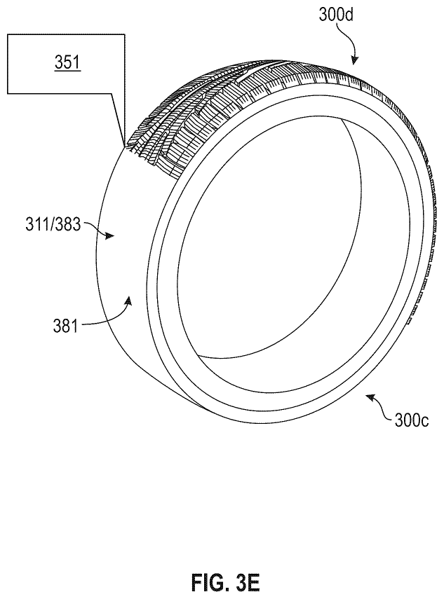

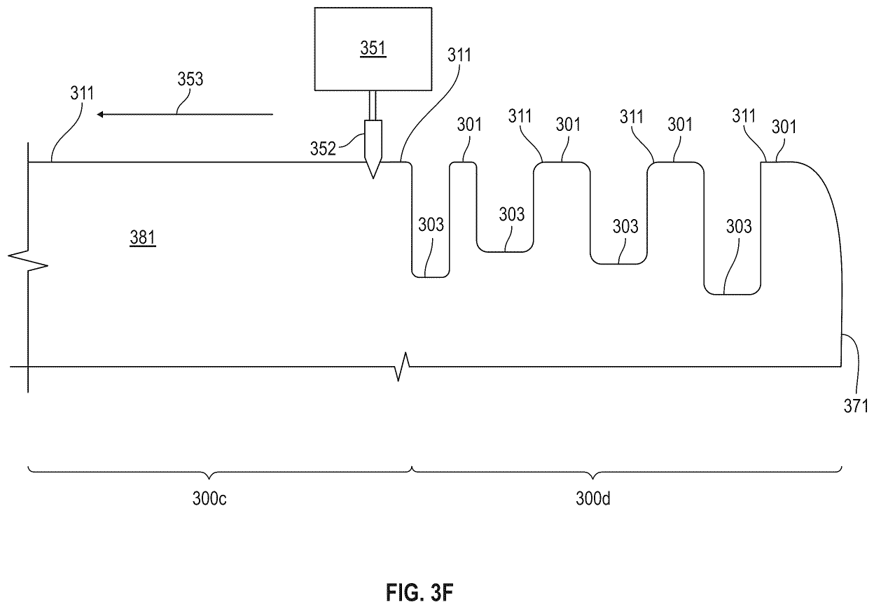

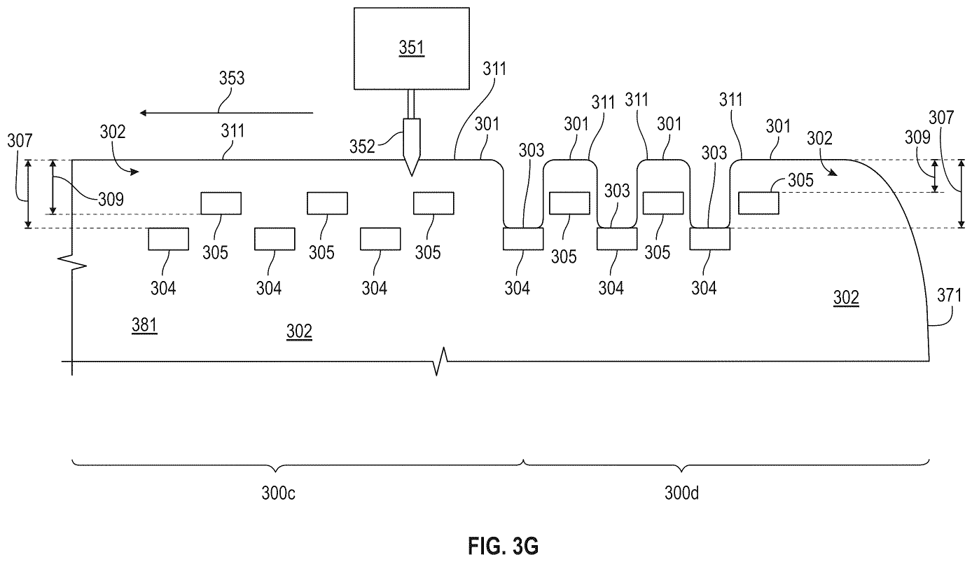

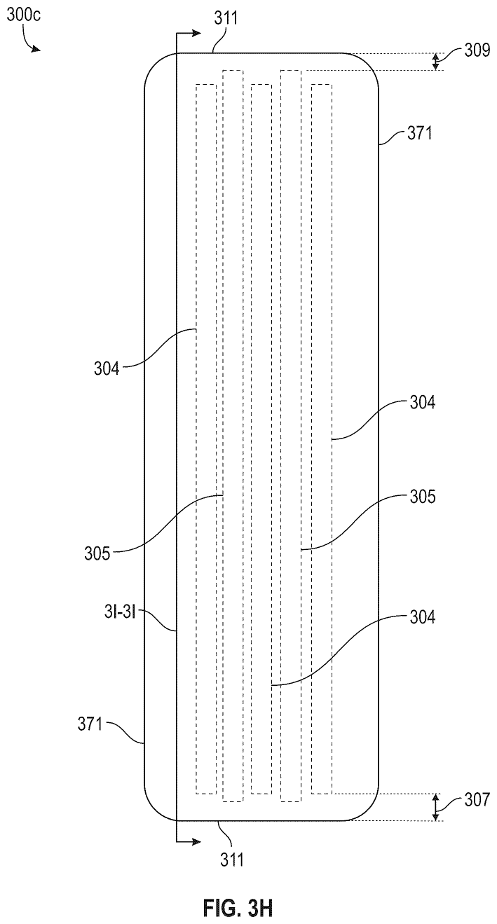

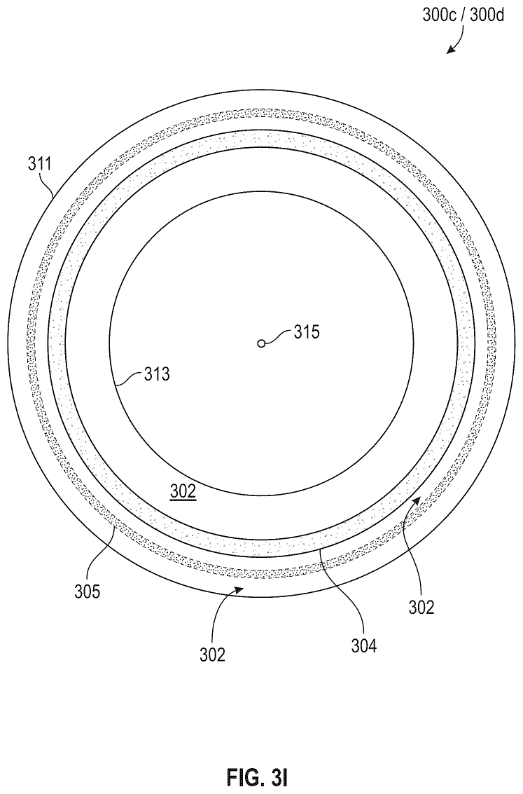

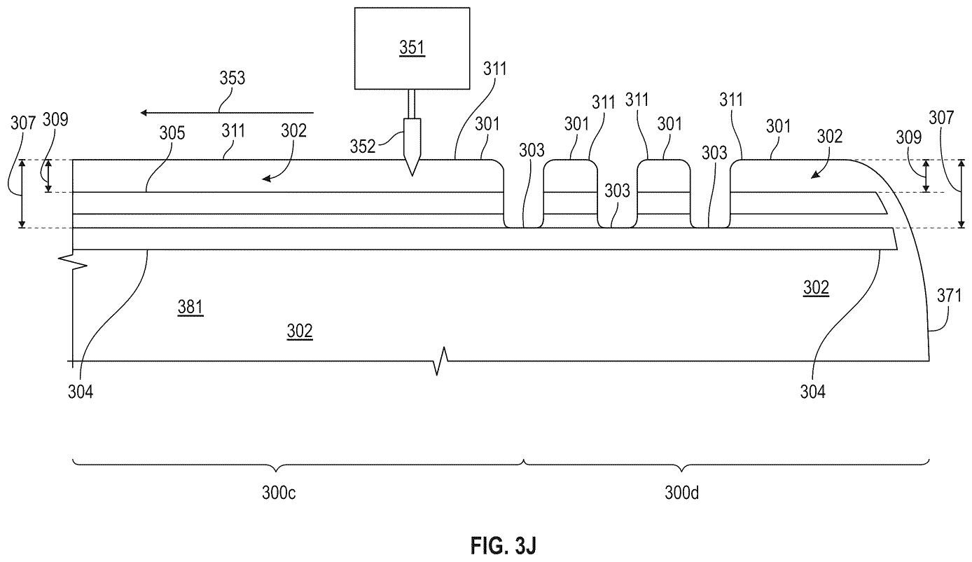

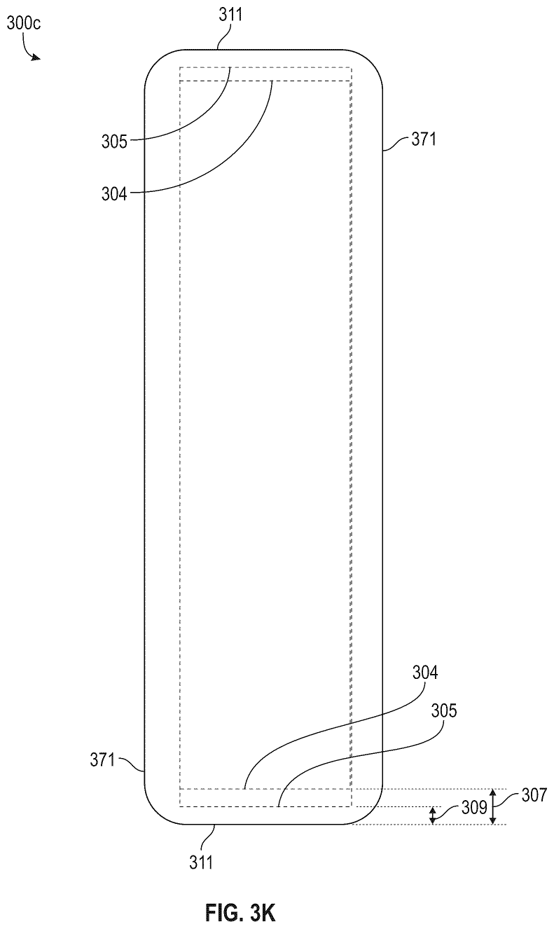

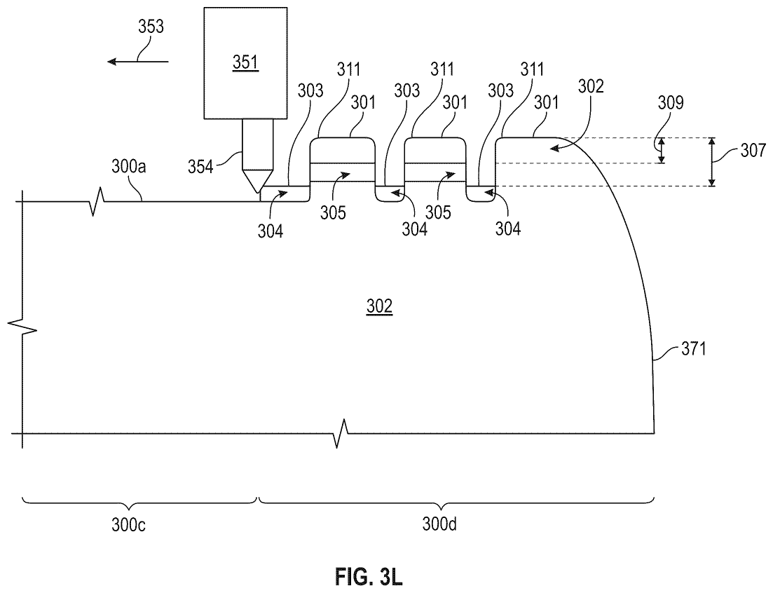

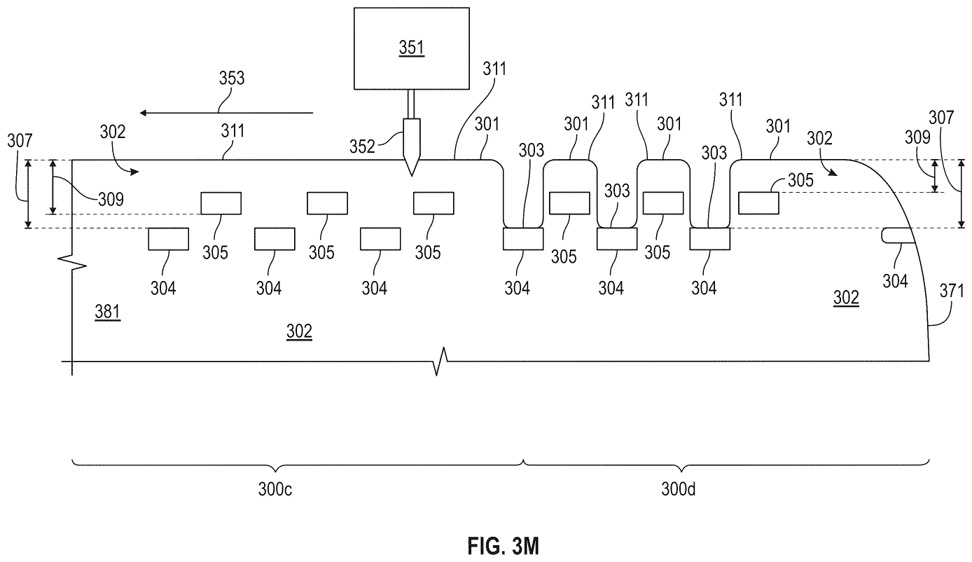

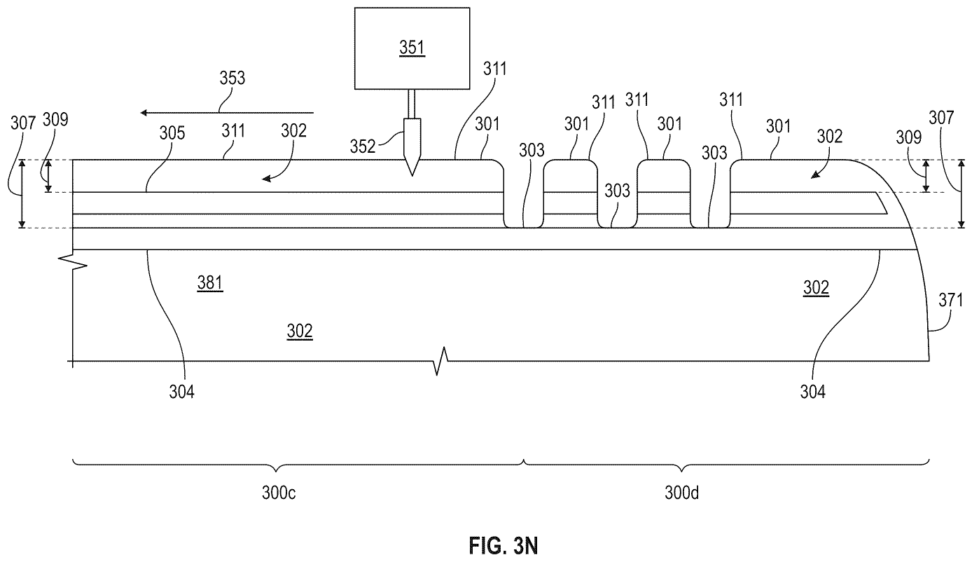

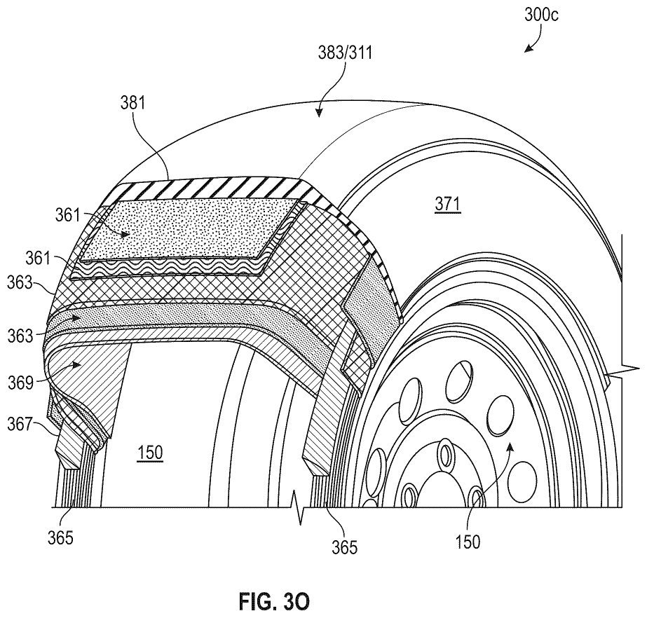

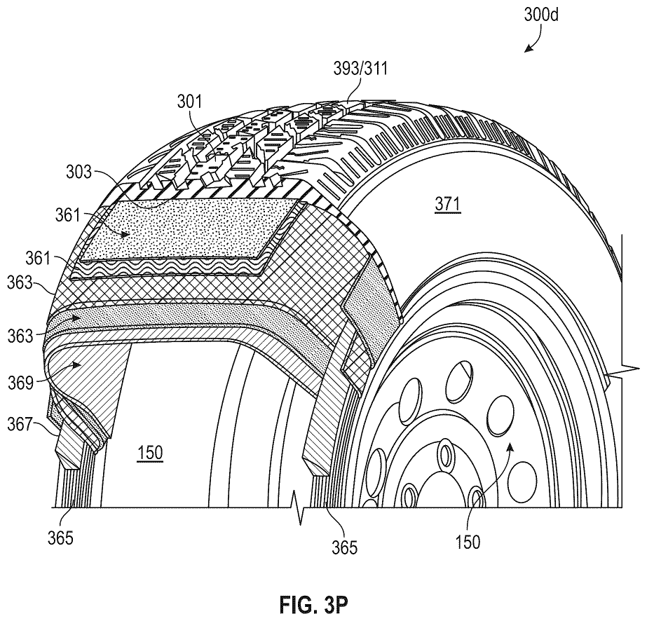

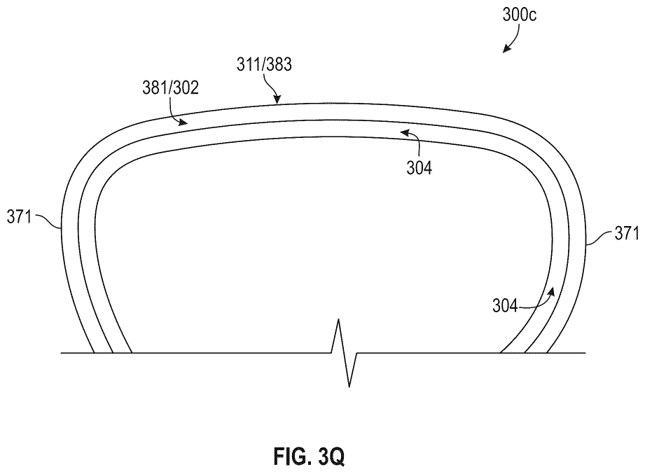

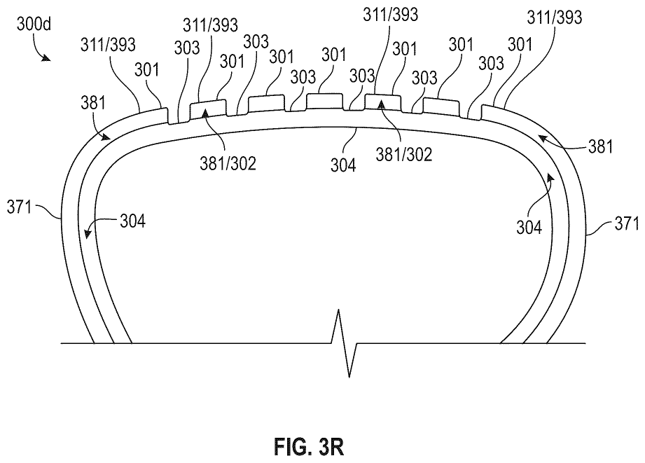

Note, reference numeral “100a” as used herein may be a tire 100 that has been modified according to at least one embodiment described herein and/or below; whereas, reference numeral “100” (without the “a”) as used herein may be a prior art tire 100 as described above and that has not been modified according to at least one embodiment of the present invention. In some embodiments, modified-tire 100a may be a tire 100 that has at least one tire-band 200 fitted into a groove 103 of that tire 100 (see e.g., FIG. 2A to FIG. 2I); and/or in some embodiments, modified-tire 100a may be a tire 100 that has a slick 300 or 300a (sleeve and/or membrane) fitted onto (over) at least some portions of that tire 100 (see e.g., FIG. 3A to FIG. 3D).

FIG. 2A shows a front (rear, top, and/or bottom) schematic view of modified-tire 100a, wherein at least one of the grooves 103 of that original tire 100 is at least partially covered over by a band 200 (a tire-band 200). FIG. 2B is perspective view of a single band 200 shown by itself (without showing modified-tire 100a). In some embodiments, band 200 is a separate component (part) that is configured to (removably) fit over and to least partially cover over a given groove 103 of a given tire 100. In some embodiments, band 200 is a separate component (part) that is configured to (removably) attach to and to least partially cover over a given groove 103 of a given tire 100. In some embodiments, band 200 may be configured to fit into groove 103. In some embodiments, band 200 may be configured to fit into a bottom of groove 103. In some embodiments, band 200 may be configured to cover over at least most of a bottom of groove 103. In some embodiments, band 200 may be constructed from one or more: plastics, thermoplastics, elastomers, silicone, rubber, resins, a portion thereof, combinations thereof, and/or the like. In some embodiments, band 200 may be configured to not become disassociated from a given groove 103 when that band 200 is within that groove 103 and when that band 200 is at least covering over a portion of a bottom of that groove 103 and while that groove 103 is experiencing typical centrifugal forces of a motor vehicle tire and while that groove 103 is experience typical temperatures of a vehicle tire. In some embodiments, band 200 may be one or more predetermined colors. In some embodiments, a color(s) of band 200 may be different from a color(s) of at least one of: tire 100, tread 101, groove 103, sidewall 107, shoulder 109, block 111, rib 113, sipe 115, dimple 117, wheel 150, a portion thereof, combinations thereof, and/or the like. In some embodiments, a color(s) of band 200 may be selected to augment, compliment, enhance, match, and/or contrast with a color(s) of: tire 100, tread 101, groove 103, sidewall 107, shoulder 109, block 111, rib 113, sipe 115, dimple 117, wheel 150, a portion thereof, combinations thereof, and/or the like. In some embodiments, an exterior surface of band 200 may be highly reflective and/or mirrored (e.g., with respect to light typically visible by a human).

In some embodiments, bands 200 shown in FIG. 2A may be in a stretched configuration, since those bands 200 are stretched over and into the grooves 103 that those bands 200 are (removably) fitted to (and/or attached to). Whereas, the (naked) band 200 shown in FIG. 2B may be in an unstretched configuration (a resting configuration). In some embodiments, stretched diameter 205 of band 200 shown in FIG. 2A may be larger than diameter 105 of groove 103, so that band 200 may stretch to fit over and onto and/or into groove 103. Whereas, unstretched diameter 207 of band 200 may be less than stretched diameter 205 and/or less than diameter 105 of groove 103. In some embodiments, band 200 may have an inherent elasticity (and/or stretchiness) that permits band 200 to be stretched to fit over and onto (and/or into) groove 103. In some embodiments, once a given band 200 has been stretched and fitted onto (and/or into) a given groove 103, that inherent elasticity (and/or stretchiness) of that band 200 may keep that band 200 from falling off of that groove 103, even when and while that tire 100 is being rotated as intended during driving (such as, but not limited to, up to speeds of 250 miles per hour (mph), 200 (mph), 150 (mph), or other predetermined speed). In some embodiments, band 200 may be configured to be rinsed, washed, and/or cleaned, either in place on groove 103 or separately (e.g., to remove road grime).

In some embodiments, preexisting tools (such as, but not limited to, a flat head screwdriver or other rigid elongate member 261) may be used to install, move, and/or remove a timing belt (or the like) may also be used for installing, moving, and/or removing band 200 with respect to a given groove 103. See e.g., FIG. 2C.

FIG. 2C shows a perspective view of tire 100 side-by-side with at least one band 200, wherein that band 200 is shown removed and/or detached from a groove 103 of that tire 100; thus, FIG. 2C may be considered an exploded view with respect to modified-tire 100a and band 200. The projection (broken) lines in FIG. 2C indicate that band 200 may be attached (or detached) to a groove 103 of tire 100 in at least some embodiments. Note, band 200 as shown in FIG. 2C is shown enlarged with respect to a given groove 103 of tire 100 that band 200 may be configured to fit into and that enlargement may be done to better show a general shape of a given band 200 in some embodiments; i.e., absent such enlargement, band 200 would appear with a smaller width and a smaller thickness. In some embodiments, band 200 may be attached (or detached) to a groove 103 of tire 100. In some embodiments, band 200 may be removably attached (or detached) to a groove 103 of tire 100. In some embodiments, at least one groove 103 of tire 100 may be fitted with a band 200. FIG. 2C may also show how a given tire 100 may be converted into a modified-tire 100a, by adding at least one band 200 to at least one groove 103 of tire 100.

FIG. 2C also shows an elongate-tool 261. In some embodiments, elongate-tool 261 may be rigid to substantially rigid. In some embodiments, elongate-tool 261 may be of a fixed and/or non-variable length. In some embodiments, elongate-tool 261 may be made at least mostly of at least one metal or of at least one metal alloy. In some embodiments, elongate-tool 261 may be used to install, move, and/or remove band 200 with respect to a given groove 103. In some embodiments, with respect to installation, elongate-tool 261 may be used to stretch a diameter of band 200 onto a given groove 103 of tire 100. In some embodiments, elongate-tool 261 may be a flathead screwdriver, a pry bar, or the like.

FIG. 2D shows a portion of a front (rear, top, and/or bottom) view of modified-tire 100a, with at least one of its grooves 103 fitted with a band 200. Note, while grooves 103 are called out in FIG. 2D, the bottoms of these grooves 103 in FIG. 2D are covered over by bands 200. Compare FIG. 2D to FIG. 1B, in FIG. 1B no bands 200 are shown and grooves 103 may be visible without obstruction.

FIG. 2E depicts a partial top perspective view of a given modified-tire 100a, wherein the grooves 103 (of that tire 100) are each fitted with its own (removable) band 200. FIG. 2F depicts a partial top view of the same given modified-tire 100a from FIG. 2E, wherein its grooves 103 (of that tire 100) are each fitted with its own band 200. Modified-tire 100a shown in FIG. 2E and in FIG. 2F may have (comprise) four separate and distinct grooves 103, with each such groove 103 being a recessed-portion in between raised-portions, such as, treads 101 (of that tire 100). Each such groove 103 (of that modified-tire 100a shown in FIG. 2E and in FIG. 2F) may entirely around an outside circumference of that tire 100 (of outside diameter 105) and without intersecting each other, and being disposed in between raised-portions, such as, treads 101 (of that tire 100). Also shown in FIG. 2E and in FIG. 2F may is a portion of human hand underneath a portion of a given band 200 and lifting that portion of that given band 200 at least partially out of its complementary groove 103; wherein this is shown to highlight that the bands 200 may be removable from their respective complimentary grooves 103 (of that tire 100), to show that bands 200 and grooves 103 may be separate and distinct structures from each other (in at least some embodiments); and/or to show how a given band 200 may fit into a given groove 103. In some embodiments, the bands 200 shown in FIG. 2E and/or in FIG. 2F may be bands 200 that are already made, manufactured, cured, solid, and/or solidified before being installed into groves 103. In some embodiments, the bands 200 shown in FIG. 2E and/or in FIG. 2F may be bands 200 shown in FIG. 2B and/or in FIG. 2C. In some embodiments, the bands 200 shown in FIG. 2E and/or in FIG. 2F may not be uncured or flowable band material 200a. Note, in reality and/or in practicality, it may be difficult to insert a portion of a human hand underneath a portion of band 200, wherein a remainder of that band 200 is already residing within a given groove 103 of a given tire 100, because the elasticity of that band 200 may be strong enough to overcome the centrifugal forces exerted by that tire 100 spinning at typical speeds for a wheeled vehicle, such as, but not limited to, speeds of 250 miles per hour (mph), 200 (mph), 150 (mph), or other predetermined speed).

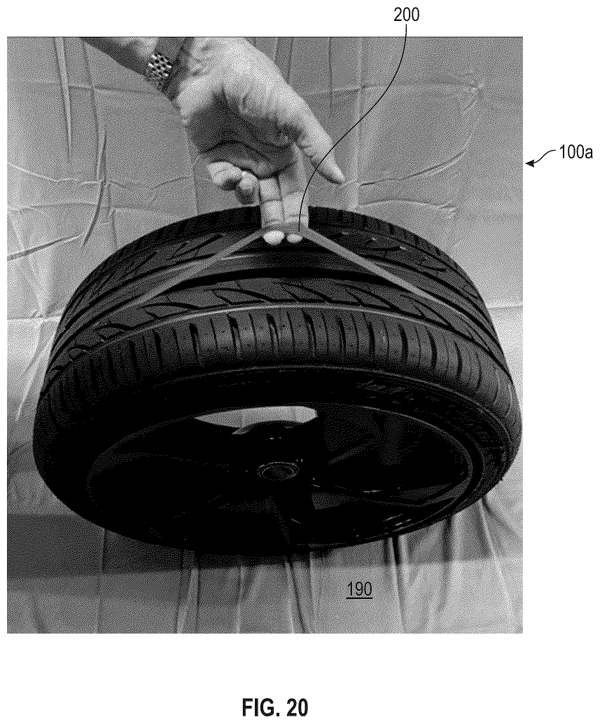

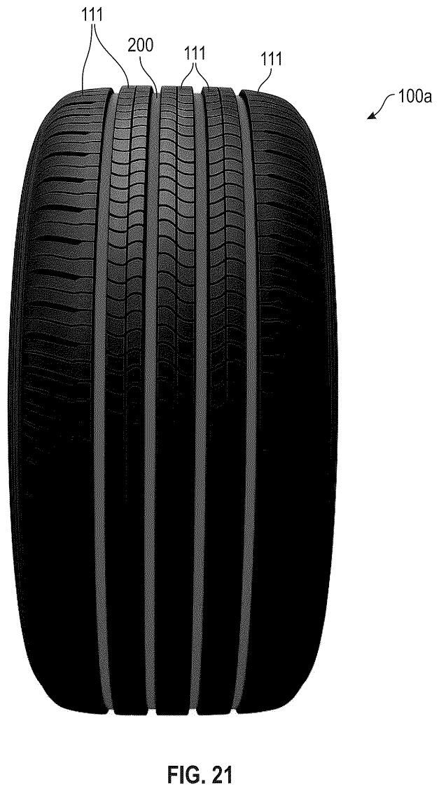

See e.g., FIG. 20 and FIG. 21 for color photographs of modified tire 100a fitted with tire-bands 200.

FIG. 2G shows a portion of a front (rear, top, and/or bottom) view of tire 100, with at least one of its grooves 103 fitted with a band 200. Note, while grooves 103 are called out in FIG. 2G, the bottoms of these grooves 103 in FIG. 2G are covered over by bands 200. Compare FIG. 2G to FIG. 1B, in FIG. 1B no bands 200 are shown and grooves 103 may be visible without obstruction.

Additionally, FIG. 2G shows four (4) different means (methods) for forming, creating, installing, and/or the like a given band 200 in place in a given groove 103 of a given tire 100 to form a given modified-tire 100a. In some embodiments, a given band 200 may be formed in place within a given groove 103 of tire 100 by using a caulk applicator 251 (or the like) to squeeze out band-material 200a (in a wet, liquid, slurry, gel, uncured, flowable, and/or the like form) from caulk applicator 251 and onto a bottom surface of that groove 103, and while working that caulk applicator 251 around a circumference of that groove 103 (around that outside diameter 105) of that given tire 100. Then such dispensed band-material 200a may cure (dry) in place within a bottom of groove 103 (in situ) to form band 200. In some embodiments, such curing (drying) may be activated and/or enhanced by shining a UV light upon that dispensed band-material 200a and/or by applying a heat source to that dispensed band-material 200a. In some embodiments, such curing (drying) may be activated and/or enhanced by exposure to one or more gases of the air, such as, but not limited to, oxygen. In some embodiments, such curing (drying) may be activated and/or enhanced by applying a vacuum to those elements. In some embodiments, such curing (drying) may be activated and/or enhanced by application of further different predetermined activating chemical (such as, but not limited to, two-part epoxies or water). In some embodiments, such curing (drying) may be a function of time, humidity, pressure, and/or temperature.

Continuing discussing FIG. 2G, in some embodiments, a given band 200 may be formed in place within a given groove 103 of tire 100 by using a spray applicator 253 (or the like) to spray out band-material 200a (in a wet, liquid, slurry, gel, uncured, flowable, and/or the like form) from spray applicator 253 and onto a bottom surface of that groove 103, and while working that spray applicator 253 around a circumference of that groove 103 (around that outside diameter 105) of that given tire 100. Then such dispensed band-material may cure (dry) to form band 200. In some embodiments, such curing (drying) may be activated and/or enhanced by shining a UV light upon that dispensed band-material 200a and/or by applying a heat source to that dispensed band-material 200a. In some embodiments, such curing (drying) may be activated and/or enhanced by exposure to one or more gases of the air, such as, but not limited to, oxygen. In some embodiments, such curing (drying) may be activated and/or enhanced by applying a vacuum to those elements. In some embodiments, such curing (drying) may be activated and/or enhanced by application of further different predetermined activating chemical (such as, but not limited to, two-part epoxies or water). In some embodiments, such curing (drying) may be a function of time, humidity, pressure, and/or temperature.

Continuing discussing FIG. 2G, in some embodiments, a given band 200 may be formed in place within a given groove 103 of tire 100 by using a brush applicator 255 (or the like) to brush or paint band-material 200a (in a wet, liquid, slurry, gel, uncured, flowable, and/or the like form) from brush applicator 255 and onto a bottom surface of that groove 103, and while working that brush applicator 255 around a circumference of that groove 103 (around outside diameter 105) of that given tire 100. Then such dispensed band-material may cure (dry) to form band 200. In some embodiments, such curing (drying) may be activated and/or enhanced by shining a UV light upon that dispensed band-material 200a and/or by applying a heat source to that dispensed band-material 200a. In some embodiments, such curing (drying) may be activated and/or enhanced by exposure to one or more gases of the air, such as, but not limited to, oxygen. In some embodiments, such curing (drying) may be activated and/or enhanced by applying a vacuum to those elements. In some embodiments, such curing (drying) may be activated and/or enhanced by application of further different predetermined activating chemical (such as, but not limited to, two-part epoxies or water). In some embodiments, such curing (drying) may be a function of time, humidity, pressure, and/or temperature.

Continuing discussing FIG. 2G, in some embodiments, an exterior surface of the dispensed band-material, that forms band 200, e.g., from caulk applicator 251, spray applicator 253, brush applicator 255, and/or the like, may have one or more predetermined color(s).

Continuing discussing FIG. 2G, in some embodiments, a given band 200 may be formed in place within a given groove 103 of tire 100 by wrapping a bottom of groove 103 with a section (portion) of tape 257. In some embodiments, that section of tape 257 is sized with respect to its length to be a complementary match up with the outside diameter 105 of the given groove 103 that is being targeted (intended) to receive that section (portion) of tape 257. In some embodiments, once that section of tape 257 is applied around the entirety of that groove 103 (around outside diameter 105), then band 200 is formed from that applied section of tape 257. In some embodiments, a back (rear) side of that tape 257 may be configured to adhere to and/or stick to the bottom of a given groove 103. In some embodiments, an exterior surface (e.g., a non-adhesive surface) of that tape 257 may have one or more predetermined color(s).

Continuing discussing FIG. 2G, in some alternative embodiments, caulk applicator 251, spray applicator 253, brush applicator 255, and/or the like may apply an adhesive, glue, and/or epoxy to a bottom surface of groove 103 (around outside diameter 105); and then a band 200 may be fitted onto that dispensed and applied adhesive, glue, and/or epoxy to be adhered to the bottom of that groove 103. Curing of such applied adhesive, glue, and/or epoxy may be enhanced by UV light, heat, ultrasound, gas, pressure, temperature, humidity, and/or chemical agents.

FIG. 2H shows caulk applicator (gun) 251 in a form factor of a caulk gun or gun like applicator that uses at least one applicator tip 252 to dispense band-material 200a (in a wet, liquid, slurry, gel, uncured, flowable, and/or the like form). FIG. 2H also shows a partial cutaway section of caulk applicator (gun) 251, that reveals flowable band-material 200a located within caulk applicator (gun) 251. In some embodiments, a given applicator tip 252 may be operatively connected to caulk applicator (gun) 251 to dispense band-material 200a (in a wet, liquid, slurry, gel, uncured, flowable, and/or the like form). In some embodiments, there may be a plurality of different sized and/or different shaped applicator tips 252, wherein each such applicator tip 252 (selected from the plurality of applicator tips 252) may be configured to be operatively connected to caulk applicator (gun) 251 to dispense band-material 200a (in a wet, liquid, slurry, gel, uncured, flowable, and/or the like form) in a bead of band-material 200a that has particular characteristics, such as, but not limited to, bead width. Thus, different shaped and/or different sized applicator tip(s) 252 may be used to apply band-material 200a to a particular tire 100 groove 103 (e.g., of a particular width and/or depth). In some embodiments, a given applicator tip 252 may configured to fit into a given groove 103 of a given tire 100 (e.g., with respect to size [dimensions] and/or shape of that given applicator tip 252). In some embodiments, the flowable band-material 200a being extruded out from a given applicator tip 252 (e.g., by caulk applicator (gun) 251) may be heated. In some embodiments, caulk applicator (gun) 251 may have a heating means; and/or the flowable band-material 200a being fed to caulk applicator (gun) 251 may have already been heated.

Note, in an alternative embodiment, reference numeral “251” shown in FIG. 2H may be for a heat gun and/or an applicator with heating functionality (e.g., its extruded output may be heated).

FIG. 2I shows another version and/or embodiment of a given caulk applicator (gun) 251 that is configured for extruding hot, melted, liquid, and/or flowable band-material 200a from its applicator tip 252. In some embodiments, caulk applicator (gun) 251 may be fed with a long string (rope) of material-to-be-melted 271 that caulk applicator (gun) 251 then heats to a point where via heat and/or pressure hot, melted, liquid, and/or flowable band-material 200a is extruded from an applicator tip 252 of caulk applicator (gun) 251 (e.g., this may be the same or similar to filament fed 3D printers and/or similar to a hot glue gun). In some embodiments, material-to-be-melted 271 before entering caulk applicator (gun) 251 may be solid and flexible (and at ambient room temperature); and may be fed (dispensed) from a spool or the like. In some embodiments, caulk applicator (gun) 251 may comprise a heating means that heats received material-to-be-melted 271 to a point where that received material-to-be-melted 271 becomes flowable band-material 200a. In some embodiments, caulk applicator (gun) 251 may comprise an electrical-power-cord 281 for receiving electrical power (e.g., from a local building electrical power supply or the like) to power its heating means and its means for extruding flowable band-material 200a. In some embodiments, caulk applicator (gun) 251 may comprise one or two handles 283. In some embodiments, (hot) flowable band-material 200a may be configured to adhere to (attach to) tire 100 tread 101 and/or groove 103 native material(s).

In some embodiments, a given tire-band 200 (band 200) may be configured to operate and communicate with a groove 103 of a tire 100. In some embodiments, tire-band 200 (band 200) may be configured to fit entirely within a given groove 103 of that tire 100. Note, when at least one such band 200 may be fitted to a given groove 103 of that tire 100, then that tire 100 may be referred to as modified-tire 100a. In some embodiments, tire-band 200 (band 200) may be configured to be installed entirely within a given groove 103 of that tire 100. In some embodiments, when the given tire-band 200 (band 200) is fitted (installed) within a given groove 103, that given tire-band 200 (band 200) may be configured to (always) be below the two adjacent raised-tread-elements 101 of that tire 100, when the two adjacent raised-tread-elements 101 of that tire 100 are at least substantially (mostly) unworn. See e.g., FIG. 2A to FIG. 2I.

With respect to that tire 100, its at least one groove 103 has a groove-bottom that is a recessed-portion of that tire 100 that is disposed between two adjacent raised-tread-elements 101 (such as, a tread block 111 and/or a rib 113) of that tire 100. These two adjacent raised-tread-elements 101 (such as, a tread block 111 and/or a rib 113) of the tire 100 are raised up from the groove-bottom (of the given at least one groove 103). These at least two adjacent raised-tread-elements 101 (such as, a tread block 111 and/or a rib 113) of the tire 100 come into periodic direct physical contact with a road surface 190 during intended rolling use of the tire. The groove-bottom (of the given at least one groove 103) runs around a circumference of the tire 100, at an outside diameter 105 of the tire 100 (i.e., the groove 103 diameter). This outside diameter 105 of the tire 100 (i.e., the groove 103 diameter) is less than an outermost-outside-diameter of the tire 100 (i.e., a tire 100 diameter around the tread 101 elements exterior surfaces)-when those tread 101 elements are at least substantially (mostly) unworn. See e.g., FIG. 1A to FIG. 1F.

In some embodiments, tire-band 200 (band 200) when fitted entirely within the groove 103 of tire 100, may cover over at least most of the groove-bottom of that particular groove 103. In some embodiments, tire-band 200 (band 200) may serve as a protective cover for the at least most of the groove-bottom (of the given groove 103 of the given tire 100) that the tire-band 200 (band 200) may cover over. See e.g., FIG. 2A, FIG. 2D, FIG. 2E, and FIG. 2F.

In some embodiments, tire-band 200 (band 200) may have (comprise) a shape that is at least substantially a hollow right cylinder shape. In some embodiments, this hollow right cylinder shape of a given band 200, may have (comprise) a width that is less than a width of the groove-bottom of the given groove 103 (of the given tire 100). In some embodiments, the width of tire-band 200 (band 200) may be greater than a thickness of tire-band 200 (band 200). In some embodiments, tire-band 200 (band 200) may may have (comprise) a shape that is at least substantially a: hollow right cylinder shape, a hollow closed loop, a close ring, a close disk, a closed disk, a portion thereof, combinations thereof, and/or the like. See e.g., FIG. 2A, FIG. 2B, FIG. 2C, FIG. 2D, FIG. 2E, and FIG. 2F.

In some embodiments, a given tire-band 200 (band 200) may be of at least one predetermined color. In some embodiments, a given tire-band 200 (band 200) may be configured to be a different color from the two adjacent raised-tread-elements 101 (such as, a tread block 111 and/or a rib 113) of the tire 100. See e.g., FIG. 2A to FIG. 2I.

In some embodiments, vehicles of a given fleet may use color-coded tires 100 (modified-tires 100a) by using colored tire-bands 200 (bands 200). The fleet may be privately owned, government owned, or combinations thereof. In some embodiments, the at least one predetermined color of a given tire-band 200 (band 200) may be assigned (e.g., in a database or the like records keeping system) to at least one function of a vehicle-fleet-management-system. In some embodiments, the at least one function is associated with a vehicle (of the fleet) that uses the tire 100 (modified-tire 100a) with the given tire-band 200 (band 200). In some embodiments, the at least one function may be correspond to at least one of: a job-site location (e.g., where that vehicle is to be driven to), a location (e.g., a location assigned to that vehicle), a driver (e.g., a driver assigned to that vehicle), a worker (e.g., a worker assigned to that vehicle), a user (e.g., a user assigned to that vehicle), a task (e.g., for a specific construction and/or maintenance task, a security task, a patrol task, etc.), a use (e.g., as transportation of a golf-cart for certain holes), a route (e.g., specific roads intended to be used), a portion thereof, combinations thereof, and/or the like. And thus, by merely observing the color(s) of band(s) 200 fitted to tires 100 of a given vehicle, one can know the at least one function for that vehicle in the given fleet.

In some embodiments, tire-band 200 (band 200) may made at least substantially from at least one of: an elastomer, a silicone, a rubber, a plastic, a thermoplastic, a portion thereof, or a combination thereof. In some embodiments, tire-band 200 (band 200) may squeeze the circumference at the outside diameter 105 of the tire 100 by tire-band 200 (band 200) having an inherent elastic property.

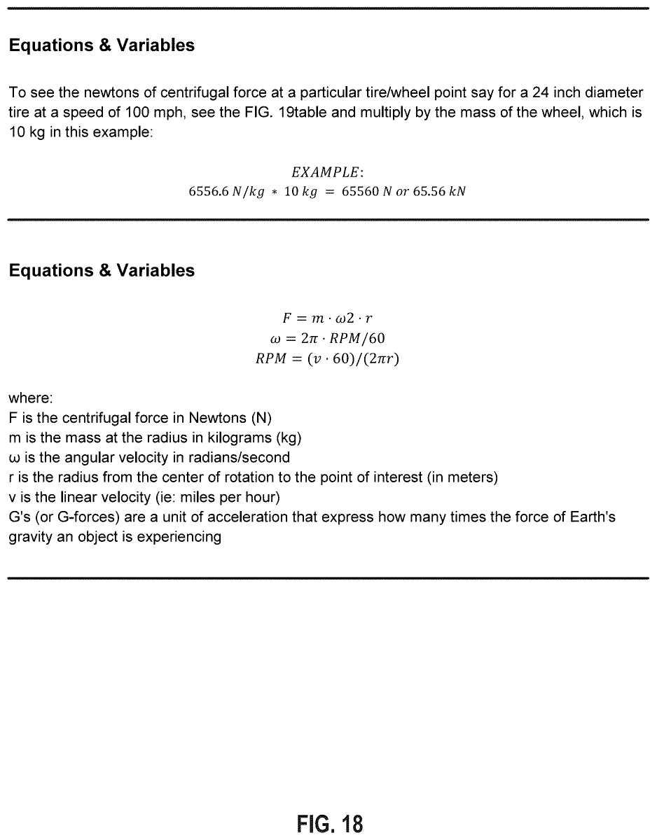

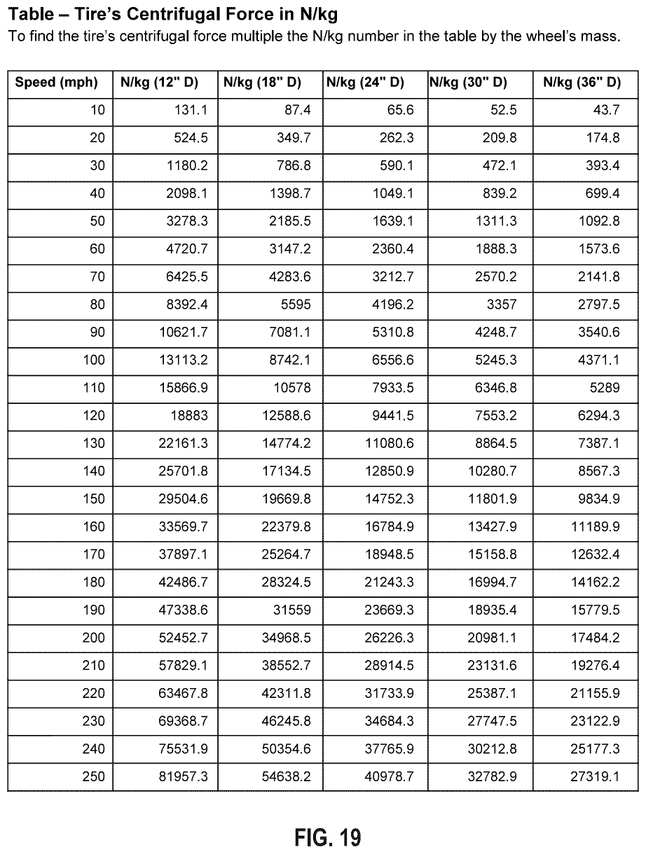

Tire 100 (and/or modified-tire 100a) may be for use on a given vehicle. In some embodiments, when tire-band 200 (band 200) may be fitted entirely within groove 103, tire-band 200 (band 200) may be configured to not become removed from that groove 103 while that tire 100 (and/or modified-tire 100a) rotates as that vehicle is driven as intended. That vehicle (with at least one such modified-tire 100a) driven as intended may include driving at a given speed (or less) for a particular situation/circumstance (e.g., on public road(s) and/or on private road(s)). That vehicle (with at least one such modified-tire 100a) driven as intended may include driving at a given speed (or less) of: 250 miles per hour (mph), 225 mph, 200 mph, 175 mph, 150 mph, 125 mph, 120 mph, 115 mph, 105 mph, 100 mph, 95 mph, 90 mph, 85 mph, 80 mph, 75 mph, 70 mph, 65 mph, or 60 mph. In some embodiments, a given tire-band 200 (band 200) may stay within the groove 103 (of the given modified-tire 100a) by that given tire-band 200 (band 200) being configured to overcome a centrifugal force of that given modified-tire 100 a when that given modified-tire 100 a is rotating at a speed (or less) of: 250 mph, 225 mph, 200 mph, 175 mph, 150 mph, 125 mph, 120 mph, 115 mph, 105 mph, 100mph, 95 mph, 90 mph, 85 mph, 80 mph, 75 mph, 70 mph, 65 mph, or 60 mph; and wherein that given modified-tire 100a has a tire outermost-outside-diameter selected from a range of 36 inches to 12 inches. In some embodiments, a given tire-band 200 (band 200) may be configured to overcome a centrifugal force of the given modified-tire 100a rotating at a speed of: 250 mph, 225 mph, 200 mph, 175 mph, 150 mph, 125 mph, 120 mph, 115 mph, 105 mph, 100 mph, 95 mph, 90 mph, 85 mph, 80 mph, 75 mph, 70 mph, 65 mph, or 60 mph, such that given tire-band 200 (band 200) stays within that given groove 103 of that given modified-tire 100a when that given modified-tire 100a is rotating at that speed or less; and wherein that given modified-tire 100a has a tire outermost-outside-diameter selected from a range of 36 inches to 12 inches. See also, FIG. 18 and FIG. 19 regarding calculating such centrifugal force of a given modified-tire 100a. In some embodiments, the means by which that given tire-band 200 (band 200) may stay within the groove 103 (of the given modified-tire 100a) and overcome the applicable centrifugal force may be: by the elastic property of that tire-band 200 (band 200); by welding of that given tire-band 200 (band 200) to the groove-bottom of that groove 103; by adhering that given tire-band 200 (band 200) to the groove-bottom of that groove 103; a portion thereof; combinations thereof; and/or the like. See e.g., FIG. 2A to FIG. 2I.

In some embodiments, a given tire-band 200 (band 200) may be configured to stay within the groove 103 when that given tire-band 200 (band 200) and/or its modified-tire 100a is at a temperature selected from a range of: 200 degrees Fahrenheit to zero degrees Fahrenheit; 200 degrees Fahrenheit to 35 degrees Fahrenheit; 175 degrees Fahrenheit to 35 degrees Fahrenheit; 150 degrees Fahrenheit to 35 degrees Fahrenheit; or 45 degrees Fahrenheit to zero degrees Fahrenheit.

With respect to FIG. 2G, in some embodiments, a given tire-band 200 (band 200) may be adhered to the at least most of the groove-bottom (of a given groove 103) by a least one of: an adhesive, a glue, an epoxy, a portion thereof, combinations thereof, and/or the like. In some embodiments, a given tire-band 200 (band 200) may be formed within the given groove 103 by spraying a flowable form 200a of the tire-band 200 (band 200) into that groove 103. In some embodiments, that flowable form 200a that was sprayed into that groove 103 may then cure into the given tire-band 200 (band 200) that is solid. In some embodiments, a given tire-band 200 (band 200) may be formed within the given groove 103 by painting a flowable form 200a of the tire-band 200 (band 200) into that groove 103. In some embodiments, that flowable form 200a that was painted into that groove 103 may then cure into the given tire-band 200 (band 200) that is solid. In some embodiments, a given tire-band 200 (band 200) may be formed within the given groove 103 by extruding a flowable form 200a of the tire-band 200 (band 200) into that groove 103. In some embodiments, that flowable form 200a that was extruded into that groove 103 may then cure into the tire-band 200 (band 200) that is solid. In some embodiments, such spraying, painting, and/or extrusion may be done, at least in part, by a tool of: caulk applicator (gun) 251, applicator tip 252, spray applicator 253, brush applicator 255, a portion thereof, combinations thereof, and/or the like. In some embodiments, a given tire-band 200 (band 200) may be formed within the given groove 103 by attaching a length of adhesive tape 257 to the at least most of the groove-bottom (of that given groove 103) along the circumference at the outside diameter 105 of that groove-bottom. In some embodiments, once that length of adhesive tape 257 is so installed, then that installed length of adhesive tape 257 may be an embodiment of tire-band 200 (band 200). See e.g., FIG. 2G.

In some embodiments, installation of a given band 200 upon a given tire 100 (to make a modified-tire 100a) enhances and/or increases visibility of that modified-tire 100a because of the difference(s) in color(s) as between that installed band 200 and that tire 100. This enhanced and/or increased visibility of modified-tire(s) 100a fitted with band(s) 200, is further increased the more high contrast the color(s) difference(s) between color(s) of those installed band(s) 200 and its tire 100. And that enhanced and/or increased visibility is a safety feature of bands 200. In some embodiments, a given tire-band 200 (band 200) may serve (function) to increase vehicular safety by making modified-tires 100a fitted with tire-bands 200 (bands 200) (e.g., a modified-tire 100a fitted with at least one band 200) easier to see by an external observer (e.g., a person), by that tire-band 200 (band 200) being a different color from a color of the two adjacent raised-tread-elements 101 of the given modified-tire 100a where that tire-band 200 (band 200) is installed on-as compared to a tire 100 without any tire-bands 200 installed and/or as compared to a tire 100 where its raised-tread-elements 101 and its grooves 103 are all the same color.

In some embodiments, at least one tire-band 200 (band 200) may be provided in a kit and/or a system configuration that may comprise that at least one tire-band 200 (band 200) and at least one tire 100. In some embodiments, a kit and/or a system may comprise at least one tire 100; and for each such tire 100 (of that kit/system), that kit/system may further comprise at least one tire-band 200 (band 200) (so that there may be at least one tire-band 200 [band 200] for each such tire 100 of that kit/system).

In some embodiments, a method for fitting, attaching, securing, placing, and/or using a band 200 (e.g., a tire-band 200) on a tire 100 may comprise steps of: a step of stretching the band 200 around an outside circumference of the tire 100 and pushing the band into a groove 103 of the tire, where that groove 103 is a recessed channel that runs around a circumference of the tire 100, where the circumference of the tire 100 is less than the outside circumference of the tire 100. This may be repeated for other groove(s) 103 of that tire 100. In some embodiments, a method for fitting, attaching, securing, placing, and/or using a plurality of bands 200 (e.g., tire-bands 200) on a tire 100 comprising steps of: for each groove 103 of the tire 100, a step of stretching at least one band 200, selected from the plurality of bands 200, around an outside circumference of the tire 100 and pushing the at least one band 200 into the groove 103 of the tire 100, where each groove 103 is a recessed channel that runs around a circumference of the tire 100, where the circumference of the tire 100 is less than the outside circumference of the tire 100. In some embodiments, once a given band 200 may be pushed into a given groove 103, then inherent elasticity of that band 200 may keep that band 200 fitted into a bottom of that groove 103 (and even while that modified-tire 100a may be spinning/rotating as intended and experiencing centrifugal forces and/or temperature increases).

In some embodiments, a given tire-band 200 (band 200) may be completely devoid of studs, spikes, projections, and/or the like that may protrude and/or extend from a flat surface of the given band 200. In some embodiments, a given tire-band 200 (band 200) may be completely devoid of studs, spikes, projections, and/or the like traction enhancing features that may protrude and/or extend from a flat surface of the given band 200. In some embodiments, tire-band 200, a portion thereof, and/or the like, are not configured for nor intended for retreading applications nor for traction against a given road surface 190. In some embodiments, band 200 (tire-band 200) when fitted to a given tire 100, does not cover over raised-portion(s) and/or tread 101 elements of that given tire 100.

In some embodiments, a given tire-band 200 (band 200) may comprise a plurality of studs, spikes, projections, and/or the like that may protrude and/or extend from a flat surface of the given band 200. In some embodiments, a given tire-band 200 (band 200) may comprise a plurality of studs, spikes, projections, and/or the like traction enhancing features that may protrude and/or extend from a flat surface of the given band 200. In some embodiments, tire-band 200, a portion thereof, combinations thereof, and/or the like, may be configured for and/or intended for retreading applications and/or for providing traction with (against) road surfaces 190.

FIG. 3A shows a perspective view of tire 100 side-by-side with a sleeve 300 (slick 300, membrane 300, or skin 300), wherein that sleeve 300 is shown removed and/or detached from that tire 100; thus, FIG. 3A may be considered an exploded view with respect to a modified-tire 100a and its attached (fitted) over sleeve 300. Note, for this paragraph, the “a” portion of reference numeral “300a” may be ignored. The projection (broken) lines in FIG. 3A indicate that sleeve 300 may be attached (or detached) to tire 100 in at least some embodiments. In some embodiments, sleeve 300 may be attached (or detached) to tire 100. In some embodiments, sleeve 300 may be removably attached (or detached) to tire 100. In some embodiments, tire 100 may be fitted with sleeve 300. In some embodiments, sleeve 300 is a separate component (part) that is configured to (removably) attach to and to least mostly cover over the grooves 103 and/or the tread 101 of a given tire 100. FIG. 3A may also show how a given tire 100 may be converted into a modified-tire 100a, by adding at least one sleeve 300 over and onto the elements of tire 100 that otherwise would come into a road's surface during intended use (such as, tread 101 elements). Thus, in some embodiments, sleeve 300 may be a condom, skin, and/or membrane for covering over at least the tread 101 elements and/or the grooves 103 of tire 100. In some embodiments, sleeve 300 may be configured to not become disassociated from tire 100 when that sleeve 300 is wrapped around and in direct physical communication with exterior raised elements (e.g., treads 101) of tire 100 and while that tire 100 is experiencing typical centrifugal forces of a motor vehicle tire and while that tire 100 is experience typical temperatures of a vehicle tire. In some embodiments, sleeve 300 may have an inherent elastic property. In some embodiments, sleeve 300 may be constructed from one or more: plastics, thermoplastics, elastomers, silicone, rubber, resin, a portion thereof, combinations thereof, and/or the like. In some embodiments, sleeve 300 may be one or more predetermined colors. In some embodiments, sleeve 300 may be colored to match a tread pattern of a given tire 100. In some embodiments, sleeve 300 may have a general hollow cylindrical shape.

Continuing discussing FIG. 3A, in some embodiments, sleeve 300 may have an inherent elasticity (and/or stretchiness) that permits sleeve 300 to be stretched to fit over and onto groove(s) 103 and/or tread 101 of a given tire 100 to form a given modified-tire 100a. Note, for this paragraph, the “a” portion of reference numeral “300a” may be ignored. In some embodiments, once a given sleeve 300 has been stretched and fitted onto groove(s) 103 and/or tread 101 of a given tire 100, the inherent elasticity (and/or stretchiness) of that sleeve 300 may keep that sleeve 300 from dissociating (falling off) from that tire 100 and from dissociating (falling off) that tire 100 when that tire 100 experiences centrifugal forces and/or temperatures typical of a wheeled vehicle during intended use. In some embodiments, an elasticity (and/or stretchiness) of sleeve 300 may be activated and/or enhanced by specific application of heat (e.g., via a heat gun) when sleeve 300 is first fitted onto tire 100. In some embodiments, sleeve 300 may be loosely fitted over groove(s) and/or tread 101 of a given tire 100, and then using a heat gun (such as, heat gun 251) (or the like), sleeve 300 may be shrunk fit to that tire 100. In some embodiments, when a given sleeve 300 is attached to (fitted to) a given tire 100, some portions of that sleeve 300 may cover over shoulder(s) 109 and/or sidewalls 107 of that tire 100 (which may help that sleeve 300 remain in place on that tire 100). In some embodiments, with respect to a given sleeve 300 attached to a given tire 100, upon normal use of that tire 100, portions of sleeve 300 that had initially covered over the tread 101 may wear down such that the only portions of sleeve 300 that remain are those that cover over the groove(s) 103 of that tire 100. In some embodiments, sleeve 300 may be configured to be rinsed, washed, and/or cleaned, either in place on tire 100 or separately to remove road grime from exterior surfaces of sleeve 300.

FIG. 3A shows a perspective view of tire 100 side-by-side with an “untextured sleeve 300a” (smooth sleeve 300a), wherein that untextured sleeve 300a is shown removed and/or detached from that tire 100. In some embodiments, untextured sleeve 300a may be at least substantially (mostly) to entirely devoid of outer exterior surface texturing. In some embodiments, the outer exterior surface of untextured sleeve 300a may be at least substantially (mostly) to entirely smooth and/or untextured. In some embodiments, untextured sleeve 300a may be attached (or detached) to tire 100. In some embodiments, untextured sleeve 300a may be removably attached (or detached) to tire 100. In some embodiments, tire 100 may be fitted with untextured sleeve 300a to form modified-tire 100a. In some embodiments, once untextured sleeve 300a may be fitted onto a given tire 100, that attached and fitted untextured sleeve 300a may take on the textures of tread 101 and/or of grooves 103 of that given unmodified tire 100. In some embodiments, untextured sleeve 300a may be one or more predetermined colors. In some embodiments, untextured sleeve 300a may be colored to match a tread pattern of a given tire 100. In some embodiments, untextured sleeve 300a may have a general hollow cylindrical shape.

FIG. 3B shows a perspective view of tire 100 side-by-side with a “textured sleeve 300b,” wherein that textured sleeve 300b is shown removed and/or detached from that tire 100. In some embodiments, textured sleeve 300b may be attached (or detached) to tire 100. In some embodiments, textured sleeve 300b may be removably attached (or detached) to tire 100. In some embodiments, tire 100 may be fitted with textured sleeve 300b to form modified-tire 100a. In some embodiments, textured sleeve 300b may have a general hollow cylindrical shape. In some embodiments, that general hollow cylindrical shape of a given textured sleeve 300b may be shaped to have a geometry that is complementary to the geometry of the tread 101 and/or to the groove(s) 103 of a particular tire 100, such that when that textured sleeve 300b is attached to that tire 100, specific portions of that textured sleeve 300b fit over and into the groove(s) 103 of that tire 100. That is, whatever tread 101 and/or groove(s) 103 pattern may exist in tire 100, a given textured sleeve 300b may be manufactured with complementary (matching) patterning and/or texturing to match the preexisting patterning of that particular tire 100. In some embodiments, once textured sleeve 300b may be fitted onto a given tire 100, that attached and fitted textured sleeve 300b may have the same or substantially the same textures and/or patterns of tread 101 and/or of grooves 103 of that given tire 100 by virtue of the shape, patterning, and/or texturing of that given textured sleeve 300b. In some embodiments, textured sleeve 300b may be one or more predetermined colors. In some embodiments, textured sleeve 300b may be colored to match a tread pattern of a given tire 100.

Note, with respect to reference numerals “300,” “300a,” and “300b”; “300a” and “300b” are merely sub-types of sleeves 300, namely, an untextured and a textured version, respectively. In some embodiments, discussion of sleeve 300 without the “a” or “b” subscript, may be applied to untextured sleeve 300a or to textured sleeve 300b. In some embodiments, use of reference numeral “300” herein without the “a” or “b” subscript, may be replaced with reference numeral “300a” or “300b.”

FIG. 3C shows a perspective view of a given tire 100 that has been fitted with a given sleeve 300 (which may have been untextured sleeve 300a or textured sleeve 300b) to form a given modified-tire 100a. In some embodiments, FIG. 3A or FIG. 3B may be an exploded view of FIG. 3C. Note, how in some embodiments, the patterning and/or texturing of tread 101 and/or of groove(s) 103 of a given tire 100 may be communicated to and/or appear on an exterior portion of sleeve 300 as shown in FIG. 3C. In some embodiments, once a given sleeve 300 has been (removably) attached to a given tire 100, some of that tire 100 sidewall 107 may be at least partially covered over by portion(s) of sleeve 300. In some embodiments, when a given sleeve 300 has been (removably) attached to a given tire 100, portion(s) of sleeve 300 that cover over portion(s) of sidewall 107, may help that given sleeve 300 be retained (attached) to that given tire 100.

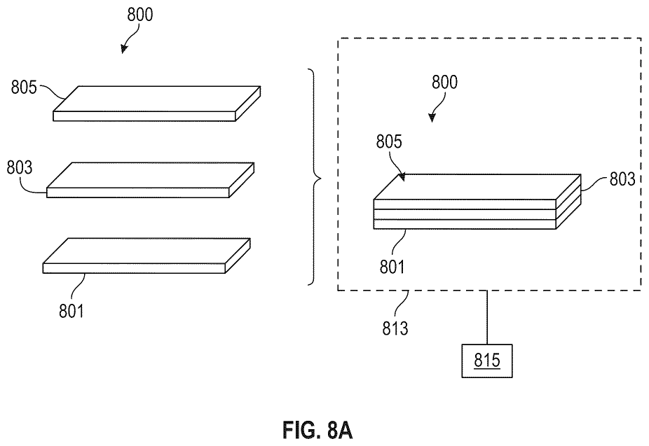

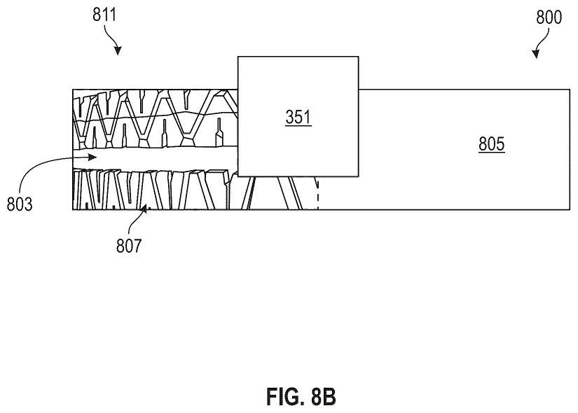

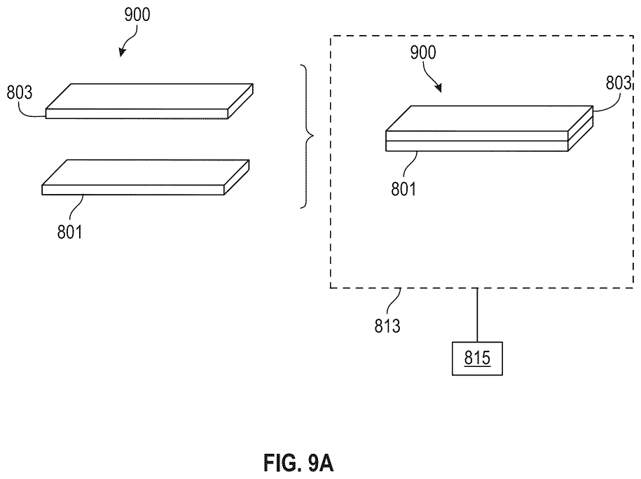

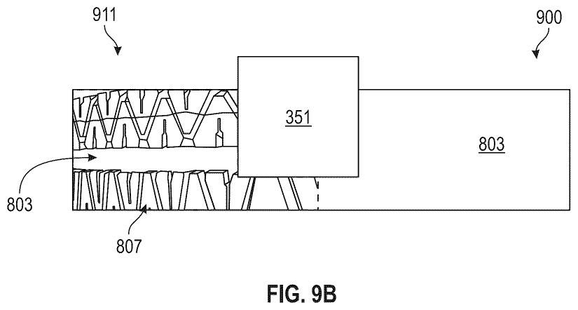

In an alternative embodiment, FIG. 3C shows a perspective view of a given textured-tire 300d that has been made by a machine 351 operating upon a blank-tire 300c (as shown and discussed in FIG. 3E to FIG. 3P, and in FIG. 8A to FIG. 9B).

FIG. 3D shows a front (rear, top, and/or bottom) schematic view of modified-tire 100a, wherein at least most of the grooves 103 and/or the tread 101 of that tire 100 is covered over by at least one sleeve 300.

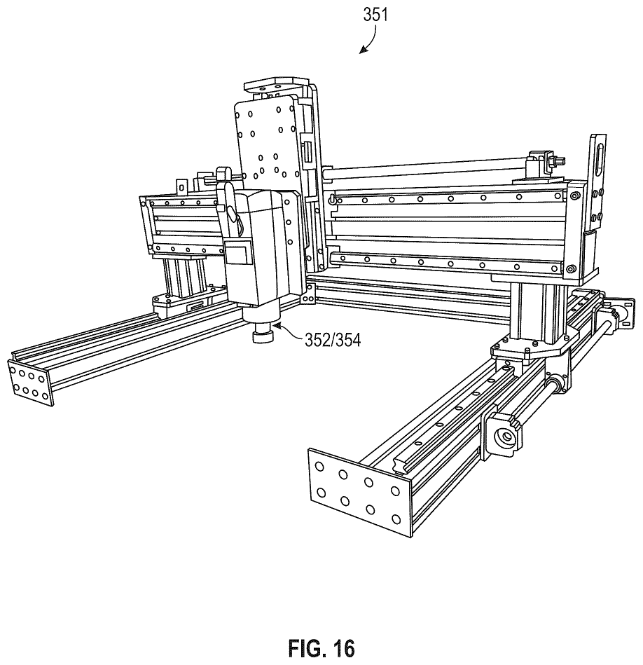

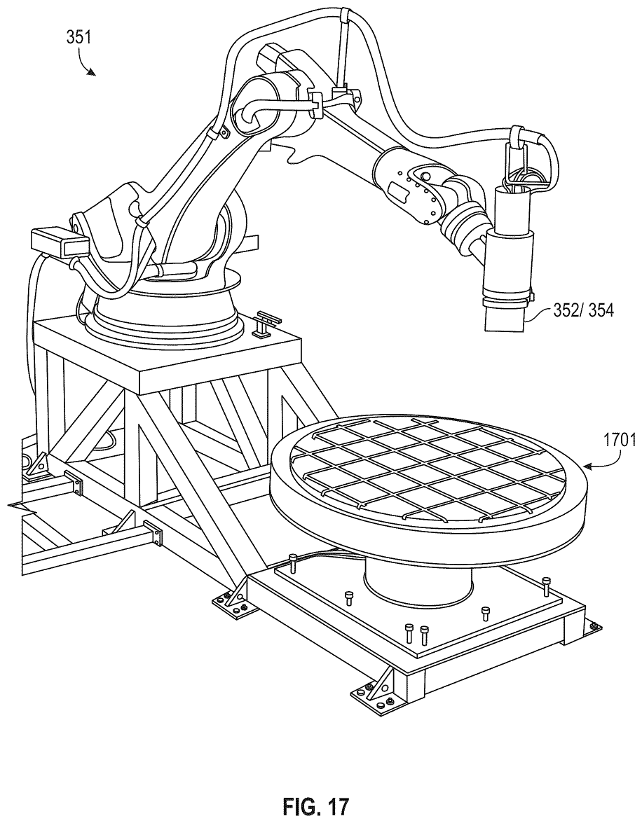

FIG. 3E shows a removal machine 351 (or the like) operating on a blank-tire 300c to form a textured-tire 300d, by cutting and/or routing material out of (removing material from) blank-tire 300c. In some embodiments, blank-tire 300c may be an untextured tire, i.e., a tire without any treads, but that is ready to have treads formed (e.g., carved) from its outer exterior curved surface. See also FIG. 3O for a cross-sectional perspective view of a portion of blank-tire 300c. See also FIG. 3P for a cross-sectional perspective view of a portion of textured-tire 300d. In some embodiments, removal machine 351 may remove material from the work surface (e.g., the outer/exterior curve surface of blank-tire 300c) that removal machine 351 is working on (e.g., by cutting, routing, carving, melting, grinding, and/or the like). In some embodiments, removal machine 351 may be a CNC (computer numerical control) machine 351 (or the like). In some embodiments, removal machine 351 may be a CNC router machine. In some embodiments, CNC machine 351 (or the like) may be programmed for to cut away and/or rout away material from a given blank-tire 300c to form (create) a given textured textured-tire 300d of a predetermined and/or specific pattern and/or texture. In some embodiments, the cutting (routing) element(s) of CNC machine 351 (or the like) may be mechanical in nature, such as, but not limited to, a router bit (tip) selected from a plurality of router bits (tips) (e.g., tool-head 352 in FIG. 3F). In some embodiments, the router bit (tip) used in CNC machine 351 (or the like) may be configured for working in a traditional CNC machine. In some embodiments, the cutting (routing) element(s) of CNC machine 351 (removal machine 351) (or the like) may be electromagnetic in nature, such as, but not limited to, a laser and/or other energy releasing transducer (e.g., an ultrasonic transducer). In some embodiments, the cutting (routing) element(s) of CNC machine 351 (removal machine 351) (or the like) may be hydrologic in nature, such as, but not limited to, a high pressure directed jet of water (or other liquid, gas, and/or plasma). In some embodiments, CNC machine 351 (removal machine 351) (or the like) may be a preexisting and/or traditional CNC machine that may be used in industrial applications for cutting tire rubber or the like. See FIG. 16 and FIG. 17 for example machines 351.

Continuing discussing FIG. 3E, in an alternative embodiment, textured-tire 300d may be formed by an additive manufacturing process such as but limited to, 3D printing, using hot hydraulic tread molds, injection molding, applicator gun 251, a 3D printer 351, and/or the like. That is, in some embodiments, reference numeral 351 may be for an additive machine, such as, but not limited to, a 3D printer (or applicator gun 251). So, FIG. 3E may show an alternative embodiment where additive machine 351 is extruding material onto the curved outer exterior surface of blank-tire 300c to form a patterned and/or textured-tire 300d. See e.g., FIG. 3E.

Continuing discussing FIG. 3E, with respect to either removal machine 351 (e.g., a CNC machine) or additive machine 351 (e.g., a 3D printer) embodiments, its head (e.g., routing head 352 or print head 354, respectively) and/or its mounting structure (e.g., table and/or mandril) for the blank-tire 300c/textured-tire 300 d, may be configured to move in at least three dimensions (3D), i.e., an x-axis direction, a y-axis direction, a z-axis direction, in a radial direction, a portion thereof, combinations thereof, and/or the like. See FIG. 16 and FIG. 17 for example machines 351.

FIG. 3F shows a cross-sectional schematic block diagram of a given removal machine 351 operating upon a section of a given blank-tire 300c to generate regions/portions of textured-tire 300d after a tool-head (removal-element) 352 (of that removal machine 351) has passed and worked on those regions/portions. In some embodiments, removal machine 351 may be a CNC machine, a lathe machine, a mill machine, a laser cutter machine, a plasma cutter machine, a water jet cutting machine, a portion thereof, combinations thereof, and/or the like. In some embodiments, removal machine 351 may comprise at least one tool-head 352. In some embodiments, tool-head 352 or a portion thereof, may be a physical region that directly physically touches (contacts) portions/regions of blank-tire 300c to carve-away, cut-away, slice-away, saw-away, chop-away, vibrate-away, melt-away, vaporize-away, grind-away, abrade-away, blow-away, a portion thereof, combinations thereof, and/or the like material of blank-tire 300c to form regions/portions of textured-tire 300d. In some embodiments, tool-head 352 or a portion thereof, may be a region that causes removal of material of blank-tire 300c to form regions/portions of textured-tire 300d in a manner by melting-away, vaporizing-away, blowing-away, a portion thereof, combinations thereof, and/or the like the material of blank-tire 300c to form regions/portions of textured-tire 300d. In some embodiments, tool-head 352 or a portion thereof, may be a cutting head, a cutting tool, a cutting bit, a spinning bit, an acoustic cutter, an ultrasonic cutter, a laser emitter, a plasma emitter, an energy emitter, a transducer, a water jet emitter (nozzle), a portion thereof, combinations thereof, and/or the like. In some embodiments, tool-head 352 or a portion thereof, may comprise a bit configured for spinning (rotation). In some embodiments, that bit may comprise one or more surfaces configured for carving-away, cutting-away, slicing-away, sawing-away, chopping-away, vibrating-away, melting-away, vaporizing-away, grinding-away, abrading-away, blowing-away, a portion thereof, combinations thereof, and/or the like material of untextured (blank) sleeve/tire 300a. In some embodiments, that bit may comprise carbide elements, diamond elements, abrasive elements, a portion thereof, combinations thereof, and/or the like. In some embodiments, tool-head 352 or a portion thereof, may spin, rotate, vibrate, reciprocate, a portion thereof, combinations thereof, and/or the like. In FIG. 3F reference numeral “353” may be associated with an arrow indicating a direction of movement of tool-head 352 (and/or a direction of movement of at least portion(s) of removal machine 351).

Continuing discussing FIG. 3F, in some embodiments, removal machine 351 and/or tool-head 352 may be configured to (entirely) move around (and/or through) (at least portions of) blank-tire 300c to form textured-tire 300d. In some embodiments, removal machine 351 (or a portion thereof) and/or tool-head 352 may comprise one to six degrees of freedom of movement (and/or articulation). In some embodiments, removal machine 351 (or a portion thereof) and/or tool-head 352 may be configured to move in x-axis directions, y-axis directions, z-axis directions, radial directions, arc directions, x-y plane directions, x-z plane directions, z-y plane directions, in the x-y plane, in the x-z plane, in the z-y plane, to spin (rotate), a portion thereof, combinations thereof, and/or the like. In some embodiments, removal machine 351 and/or tool-head 352 may comprise one or more rails, gantries, robotic arm(s), a portion thereof, combinations thereof, and/or the like to support its components and/or to facilitate intended operational movement. In some embodiments, removal machine 351 and/or tool-head 352 may comprise one or more stepper motor(s), piston(s), actuator(s), and/or the like for moving portion(s) of removal machine 351 and/or tool-head 352 along its rails, gantries, robotic arm(s), a portion thereof, combinations thereof, and/or the like. In some embodiments, removal machine 351 and/or tool-head 352 may comprise one or more sensor(s). In some embodiments, sensor(s) of removal machine 351 and/or of tool-head 352 may be configured for determining real-time and/or dynamic position(s) of portion(s) of removal machine 351, tool-head 352, untextured (blank) sleeve/tire 300a, textured tire 300b, a portion thereof, combinations thereof, and/or the like. See FIG. 16 and/or FIG. 17 for examples of machines 351.

Continuing discussing FIG. 3F, in some embodiments, tool-head 352 acting upon blank-tire 300c may generate regions/portions of textured-tire 300d. In some embodiments formed regions/portions of textured-tire 300d may comprise at least one raised-portion (tread) 301 and/or at least one recessed-portion (groove) 303. In some embodiments, exterior-surface 311 may be intended to come into (periodic) direct physical contact with a given road surface 190 as blank-tire 300c/textured-tire 300 d spins (rotates) against that given road surface 190. In some embodiments, an outside (facing) exterior curved perimeter surface of blank-tire 300c/textured tire 300b may be exterior-surface 311. In some embodiments, raised-portion (tread) 301 may be a surface portion of textured-tire 300d that is most exterior. For example, with respect to textured-tire 300d, exterior surfaces (exterior-surface 311) of textured-tire 300d are intended to come into regular periodic contact with a given road surface 190, then raised-portion (tread) 301 may be a surface portion (exterior-surface 311) that is intended to come into direct physical contact with the given road surface 190 under normal driving conditions. In some embodiments, recessed-portion 303 may be a portion of textured-tire 300d that is recessed (sunken and/or inset) away from a given (proximal and/or adjacent) raised-portion (tread) 301 by at least some fixed distance of depth (e.g., depth 307 in FIG. 3G) from exterior-surface 311. Continuing discussing FIG. 3F, with respect to a cross-section through textured-tire 300d, in some embodiments, each given recessed-portion 303 may be flanked by two opposing, separate, distinct, and adjacent raised-portions (treads) 301. With respect to a cross-section through textured-tire 300d, in some embodiments, each given raised-portion (tread) 301 may be flanked by at least one adjacent recessed-portion 303. In some embodiments, a given textured-tire 300d may comprise two opposing, separate, and distinct raised-portions (treads) 301 that are each adjacent to, associated with, linked with, and/or in communication with one separate sidewall of that textured-tire 300d; and in between those two opposing, separate, and distinct raised-portions (treads) 301 there may be at least one other raised-portion (tread) 301 that is not adjacent to nor in communication with either sidewall. With respect to a cross-section through textured-tire 300d, in some embodiments, each given raised-portion (tread) 301 that is not adjacent and/or in communication with a sidewall, may be flanked by two opposing, separate, distinct, and adjacent recessed-portions 303. In some embodiments, removal machine 351 may be programed to generate a completed textured-tire 300d with a plurality of raised-portions (treads) 301 and a plurality of recessed-portions 303, that result in a predetermined and/or programmable pattern (e.g., tread pattern). In some embodiments, depths, widths, heights, and/or the like of raised-portion(s) (tread(s)) 301 and/or of recessed-portion(s) 303 may be determined by a program (e.g., computer program) that is configured to instruct removal machine 351. In some embodiments, depths, widths, heights, and/or the like of raised-portion(s) (tread(s)) 301 and/or of recessed-portion(s) 303 may be uniform, constant, and/or non-variable with respect to each other. In some embodiments, at least some of the depths, the widths, the heights, and/or the like of raised-portion(s) (tread(s)) 301 and/or of recessed-portion(s) 303 may be different, non-uniform, and/or variable with respect to each other (e.g., according to a specific computer program's instructions for operation of removal machine 351).

FIG. 3G shows a cross-sectional schematic block diagram of a given removal machine 351 operating upon a section of a given blank-tire 300c to generate regions/portions of textured-tire 300d after tool-head 352 (of that removal machine 351) has passed and worked on those regions/portions. In FIG. 3G reference numeral “353” may be associated with an arrow indicating a direction of movement of tool-head 352 (and/or a direction of movement of at least portion(s) of removal machine 351). In some embodiments, blank-tire 300c and/or textured-tire 300d may comprise at least one: raised-portion (tread) 301, region-of-first-color 302, recessed-portion 303, region-of-second-color 304, depth-of-groove 307 (recessed-depth 307), exterior-surface 311, and interior-surface 313. In some embodiments, blank-tire 300c and/or textured-tire 300d may comprise at least one: raised-portion (tread) 301, region-of-first-color 302, recessed-portion 303, region-of-second-color 304, wear-depth-gauge (tread-depth-gauge) 305, depth-of-groove 307 (recessed-depth 307), depth-of-gauge 309, exterior-surface 311, and interior-surface 313.

Continuing discussing FIG. 3G, in some embodiments, at least most (a majority) of material(s) of blank-tire 300c/textured-tire 300d (e.g., by mass and/or weight) may be region-of-first-color 302. In some embodiments, region-of-first-color 302 may be of at least one color. In some embodiments, region-of-first-color 302 may be of at least one predetermined color. Traditionally, all of a given 100 tire has been at least mostly (substantially) black (aside sometimes from sidewalls that had been at least partially white in some instances [as in “white wall tires”]). In some embodiments, region-of-first-color 302 may be black. In some embodiments, region-of-first-color 302 may be at least mostly (substantially) black. In some embodiments, all of blank-tire 300c/textured-tire 300d material(s) may be region-of-first-color 302, except for region(s) of: region-of-second-color 304, wear-depth-gauge (tread-depth-gauge) 305 (when present), belt(s) 361, body plies 363, bead 365, bead filler 367, inner-liner 369, a portion thereof, combinations thereof, and/or the like. In some embodiments, all of blank-tire 300c/textured-tire 300d material(s) may be region-of-first-color 302, except for region(s) of: region-of-second-color 304, wear-depth-gauge (tread-depth-gauge) 305 (when present), belt(s) 361, body plies 363, bead 365, bead filler 367, inner-liner 369, sidewall(s) 371, a portion thereof, combinations thereof, and/or the like. In some embodiments, region-of-second-color 304, wear-depth-gauge (tread-depth-gauge) 305 (when present), and/or sidewall(s) 371 may be of different color(s) as compared to color(s) of region-of-first-color 302. In some embodiments, region-of-second-color 304, wear-depth-gauge (tread-depth-gauge) 305 (when present), and/or sidewall(s) 371 may be of different color(s) or as same color(s) as compared to color(s) of region-of-first-color 302. See also, FIG. 30 for blank-tire 300c and FIG. 3P for textured-tire 300d.

Continuing discussing FIG. 3G, in some embodiments, blank-tire 300c and/or textured-tire 300d may comprise at least one region-of-second-color 304. In some embodiments, blank-tire 300c and/or textured-tire 300d may comprise a plurality of regions-of-second-color 304. In some embodiments, region-of-second-color 304 may be located at a depth of a depth-of-groove 307 (recessed-depth 307) from a reference point on a nearest exterior-surface 311 portion of blank-tire 300c and/or textured-tire 300d. In some embodiments, at least one recessed-portion 303 (of a given textured-tire 300d) may distally terminate at a given region-of-second-color 304, wherein the distal end of the given recessed-portion 303 is disposed opposite from a nearest exterior-surface 311 portion of textured-tire 300d. In some embodiments, each recessed-portion 303 (of a given textured-tire 300d) may distally terminate at a given region-of-second-color 304, wherein the distal end of the given recessed-portion 303 is disposed opposite from a nearest exterior-surface 311 portion of textured-tire 300d. In some embodiments, region-of-second-color 304 begins at depth-of-groove 307 (recessed-depth 307) and where a given recessed-portion 303 terminates away from a nearest exterior-surface 311 portion of textured-tire 300d. In some embodiments, region-of-second-color 304 may be located directly under a given recessed-portion 303 and visually accessible from above (outside) that recessed-portion 303. In some embodiments, at a bottom of a given recessed-portion 303 may be a given region-of-second-color 304. In some embodiments, region-of-second-color 304 may not be located in nor directly under a given raised-portion (tread) 301. In some embodiments, a given region-of-second-color 304 may be a singular band that is (fixedly) (entirely) embedded within a given blank-tire 300c. In some embodiments, a given region-of-second-color 304 may only become visually accessible, once its associated (linked and/or paired) recessed-portion 303 is formed. Operation of removal machine 351 and/or removal-element 352 upon blank-tire 300c to yield textured-tire 300d, may visually uncover region(s)-of-second-color 304 (e.g., within the distal bottoms at least some of the recessed-portion(s) 303). In some embodiments, region-of-second-color 304 may be of at least one color. In some embodiments, region-of-second-color 304 may be of at least one predetermined color. In some embodiments, color(s) of region-of-second-color 304 may be different from color(s) of region-of-first-color 302. In some embodiments, color(s) of region-of-second-color 304 may be different from color(s) of wear-depth-gauge (tread-depth-gauge) 305. In some embodiments, color(s) of region-of-second-color 304 may be different from color(s) of region-of-first-color 302 and/or different from color(s) of wear-depth-gauge (tread-depth-gauge) 305. In some embodiments, color(s) of region-of-second-color 304 may be selected so as to be high-contrast with respect to color(s) of region-of-first-color 302 and/or color(s) of wear-depth-gauge (tread-depth-gauge) 305. Utilizing such a high-contrast colors scheme on tires (e.g., tires 300, 300b, and/or 300d) may increase the tire's visibility with respect to external observers, such as, but not limited to, other drivers and as such may contribute to vehicular safety and vehicular collision mitigation. This enhanced visibility may also aid location determined of a parked vehicle fitted with such colored tires 300, 300b, and/or 300d. For example, and without limiting the scope of the present invention, raised-portions (treads) 301 (and region-of-first-color 302) may be black, while region(s)-of-second-color 304 (at the bottoms of the recessed-portions [channels/grooves] 303) may be some bright color (such as, but not limited to, red, yellow, green, blue, white, or the like). (In some embodiments, color(s) of region-of-second-color 304 may be different or the same as color(s) of: region-of-first-color 302 and/or of wear-depth-gauge (tread-depth-gauge) 305.) Continuing discussing FIG. 3G, in some embodiments, blank-tire 300c and/or textured-tire 300d may comprise at least one region of wear-depth-gauge (tread-depth-gauge) 305. In some embodiments, wear-depth-gauge (tread-depth-gauge) 305 may be a visual tread wear down gauge, such that once the given tread (raised-portion) 301 becomes sufficiently worn down, that its formerly encapsulated wear-depth-gauge (tread-depth-gauge) 305 becomes visually accessible, then an external observe will know by visual cue (visual observation) that the given tire 300d may be ready for replacement. In some embodiments, blank-tire 300c and/or textured-tire 300d may comprise a plurality of regions of wear-depth-gauges (tread-depth-gauges) 305. In some embodiments, tread-depth-gauge 305 may be located at a depth of depth-of-gauge 309 from a reference point on a nearest exterior-surface 311 portion of blank-tire 300c and/or textured-tire 300d. In some embodiments, depth-of-groove 307 (recessed-depth 307) and depth-of-gauge 309 may both be fixed and finite depths extending into material(s) of blank-tire 300c and/or textured-tire 300d, but of different depths from each other. In some embodiments, depth-of-groove 307 (recessed-depth 307) and depth-of-gauge 309 may both be fixed and finite depths extending into blank-tire 300c and/or textured-tire 300d from a nearest exterior-surface 311 portion, but of different depths from each other. In some embodiments, depth-of-gauge 309 may be shorter (shallower) than depth-of-groove 307 (recessed-depth 307). In some embodiments, depth-of-groove 307 (recessed-depth 307) may be associated with an initial (starting) depth of region-of-second-color 304 of raised-portions 301 (from exterior-surface 311 of unworn raised-portions 301); whereas, depth-of-gauge 309 may be associated with an initial (starting) depth of tread-depth-gauge 305. In some embodiments, at least one raised-portion (tread) 301 (of a given textured tire 300b) may comprise within it a given tread-depth-gauge 305 (at least when that given raised-portion (tread) 301 is substantially [mostly] unworn). In some embodiments, at least one raised-portion (tread) 301 (of a given textured-tire 300d) may house and/or encapsulate within it a given tread-depth-gauge 305 (at least when that given raised-portion (tread) 301 is substantially unworn). In some embodiments, each raised-portion (tread) 301 (of a given textured-tire 300d) may comprise within it a given tread-depth-gauge 305. In some embodiments, each raised-portion (tread) 301 (of a given textured-tire 300d) may house and/or encapsulate within each such raised-portion (tread) 301 at least one tread-depth-gauge 305 (at least when the given raised-portion (tread) 301 is substantially unworn). In some embodiments, tread-depth-gauge 305 begins at depth-of-gauge 309. In some embodiments, tread-depth-gauge 305 may be located directly under a given exterior-surface 311 of a given raised-portion 301; however, that tread-depth-gauge 305 only becomes visible from above (outside) once its associated (linked/paired) raised-portion (tread) 301 has worn down to the depth-of-gauge 309. In some embodiments, tread-depth-gauge 305 may not be located in nor under a given recessed-portion 303. In some embodiments, a given tread-depth-gauge 305 may be a singular band that is (fixedly) (initially entirely) embedded within a given blank-tire 300c. In some embodiments, a given tread-depth-gauge 305 may be a singular band that is (fixedly) embedded within a given blank-tire 300c, beginning at depth-of-gauge 309 and directly under exterior-surface 311 of at least one raised-portion (tread) 301 (once that raised-portion 301 may be formed). In some embodiments, tread-depth-gauge 305 may be of at least one color. In some embodiments, tread-depth-gauge 305 may be of at least one predetermined color. In some embodiments, color(s) of tread-depth-gauge 305 may be different from color(s) of region-of-first-color 302 and/or different from color(s) of region-of-second-color 304. In some embodiments, color(s) of tread-depth-gauge 305 may be selected so as to be high-contrast with respect to color(s) of region-of-first-color 302 and/or with respect to color(s) of region(s)-of-second-color 304. Utilizing such a high-contrast colors scheme on tires may increase a probability of discovering that a tire's tread(s) 301 have worn down to a point where tire replacement may be desired from a safety perspective. For example, and without limiting the scope of the present invention, raised-portions (treads) 301 (and region-of-first-color 302) may be black, while tread-depth-gauge 305 may be some bright color (such as, but not limited to, red, yellow, green, blue, white, or the like). (In some embodiments, color(s) of tread-depth-gauge 305 may be different or the same as color(s) of: region-of-first-color 302 and/or of region-of-second-color 304.) Some embodiments, blank-tire 300c and/or textured-tire 300d may be with or without tread-depth-gauge(s) 305.

FIG. 3H is a top view, a bottom view, a front view, or a rear view of a given blank-tire 300c, according to least one embodiment. In some embodiments, exterior-surface 311 may be intended to come into direct physical contact with a given road surface 190 as blank-tire 300c and/or textured-tire 300d spins (rotates) against that given road surface 190. In some embodiments, an outside (facing) curved exterior surface(s) of blank-tire 300c and/or textured-tire 300d may be exterior-surface 311. Bands 304 and bands 305 are shown in FIG. 3H in broken lines to indicate that such bands may be (fixedly) (entirely) embedded inside of (solid) material(s) of blank-tire 300c. Bands 304 may be regions-of-second-color 304. Bands 305 may be tread-depth-gauges 305. FIG. 3H also shows depth-of-groove 307 (recessed-depth 307) associated with where bands 304 may begin within the (solid) material(s) of blank-tire 300c. FIG. 3H also shows depth-of-gauge 309 associated with where bands 305 may begin within the (solid) material(s) of blank-tire 300 c. FIG. 3H also includes sectional-line 31-3I that FIG. 3I is generated from.

FIG. 3I is side view (left or right) of a cross-section through an embodiment of a blank-tire 300c or of a textured-tire 300d, wherein the resulting cross-section overall has a ring or a disc (disk) shape. FIG. 3I is cross-sectional view through sectional-line 3I-3I of FIG. 3H. FIG. 3I shows exterior-surface 311 that runs around an exterior outer curved perimeter (circle) of blank-tire 300c/textured-tire 300d. In some embodiments, exterior-surface 311 may be intended to come into direct physical contact with a given road surface 190 as blank-tire 300c/textured-tire 300d spins (rotates) against that given road surface 190. In some embodiments, an outside (facing) curved exterior perimeter boundary of this overall ring or disc (disk) shape of blank-tire 300c/textured-tire 300d may be exterior-surface 311. Note, from the angle the cross-section of FIG. 3I was generated, exterior-surface 311 may look the same or substantially similar in both blank-tire 300c and in textured-tire 300d. FIG. 3I shows interior-surface 313 that runs around an interior (inside facing) curved perimeter (circle) of blank-tire 300c/textured-tire 300d. In some embodiments, interior-surface 313 may be intended to come into at least partial direct physical contact with an exterior diameter of a wheel's rim (e.g., wheel 150) and/or to physically contact an inner tube. In some embodiments, an interior (inside facing) perimeter boundary of this overall ring or disc (disk) shape of blank-tire 300c/textured-tire 300d may be interior-surface 313. In some embodiments, exterior-surface 311 and interior-surface 313 may be disposed opposite from each other. In some embodiments, exterior-surface 311 and interior-surface 313 may be at least substantially (mostly) parallel to each other. In some embodiments, exterior-surface 311 may run at a first fixed radius with respect to a center 315 of blank-tire 300c and/or textured-tire 300d. In some embodiments, interior-surface 313 may run at a second fixed radius with respect to a center 315 of blank-tire 300c and/or textured-tire 300d. In some embodiments, the first fixed radius may be larger than the second fixed radius. In some embodiments, center 315 may be an axial center of blank-tire 300c and/or textured-tire 300d, upon which blank-tire 300c and/or textured-tire 300d may spin (rotate). In some embodiments, disposed between exterior-surface 311 and interior-surface 313 may be material(s) of blank-tire 300c or textured-tire 300d. In some embodiments, the material(s) disposed between exterior-surface 311 and interior-surface 313 may be at least partially to at least mostly solid.

Continuing discussing FIG. 3I, in some embodiments, blank-tire 300c and/or textured-tire 300d may comprise at least one region-of-first-color 302. In some embodiments, a majority of a material of blank-tire 300c and/or textured-tire 300d may all or mostly be region-of-first-color 302. In some embodiments, a majority of upper/top regions of blank-tire 300c and/or textured-tire 300d may all or mostly be region-of-first-color 302. Note, while reference numeral “302” is called out in three distinct portions of FIG. 3I, these are all the very same region-of-first-color 302 and only show up as distinct regions in FIG. 3I as an artefact of generating the cross-section. In some embodiments, blank-tire 300c and/or textured-tire 300d may comprise at least one region-of-second-color 304. In some embodiments, untextured tire 300a and/or textured-tire 300d may comprise at least one region-of-second-color 304 for each distinct recessed-portion (channel) 303 of textured-tire 300d. In some embodiments, each distinct recessed-portion (channel) 303 (of textured-tire 300d) may distally end (terminate) at a region-of-second-color 304 (wherein that distal end of the given recessed-portion (channel) 303 is disposed opposite from a nearest exterior-surface 311). In some embodiments, blank-tire 300c and/or textured-tire 300d may comprise a plurality of regions-of-second-color 304. In some embodiments, region(s)-of-second-color 304 may be (fixedly) (entirely) embedded within material(s) of blank-tire 300c, beginning at depth-of-groove 307 (recessed-depth 307). In some embodiments, a given region-of-second-color 304 may be exteriorly visually revealed (visible) once its associated (linked) recessed-portion (channel) 303 is formed, beginning at depth-of-groove 307 (recessed-depth 307). In some embodiments, blank-tire 300c and/or textured-tire 300d may comprise at least one region of wear-depth-gauge (tread-depth-gauge) 305. In some embodiments, blank-tire 300c and/or textured-tire 300d may comprise at least one region of wear-depth-gauge (tread-depth-gauge) 305 for each distinct raised-portion (tread) 301 of textured-tire 300d. In some embodiments, each distinct raised-portion (tread) 301 (of textured-tire 300d) may comprise inside a given wear-depth-gauge (tread-depth-gauge) 305, when that given raised-portion (tread) 301 is in a substantially (mostly) unworn condition. In some embodiments, blank-tire 300c and/or textured-tire 300d may comprise a plurality of regions of wear-depth-gauge (tread-depth-gauge) 305. In some embodiments, regions of wear-depth-gauge (tread-depth-gauge) 305 may be (fixedly) (initially entirely) embedded within material(s) of blank-tire 300c and/or textured-tire 300d, beginning at depth-of-gauge 309. In some embodiments, regions of wear-depth-gauge (tread-depth-gauge) 305 may be (fixedly) (initially entirely) embedded within material(s) of raised-portion (tread) 301, beginning at depth-of-gauge 309. In some embodiments, a given region of wear-depth-gauge (tread-depth-gauge) 305 may be exteriorly revealed (visible) once its associated (linked) raised-portion (tread) 301 has been formed and has been worn down to depth-of-gauge 309. In some embodiments, region(s)-of-second-color 304 may be located further away from exterior-surface 311 as compared to region(s) of wear-depth-gauge (tread-depth-gauge) 305. In some embodiments, region(s)-of-second-color 304 may be located closer to interior-surface 313 as compared to region(s) of wear-depth-gauge (tread-depth-gauge) 305. In some embodiments, region(s) of wear-depth-gauge (tread-depth-gauge) 305 may be located closer to exterior-surface 311 as compared to region(s)-of-second-color 304. In some embodiments, region(s) of wear-depth-gauge (tread-depth-gauge) 305 may be located further away from interior-surface 313 as compared to region(s)-of-second-color 304. In FIG. 3I bands 305 may be tread-depth-gauges 305; and these bands 305 may be shown in broken lines in FIG. 3I because bands 305 may be (fixedly) (initially entirely) embedded within (solid) material(s) of blank-tire 300c and/or textured-tire 300d. In some embodiments, with respect to a given blank-tire 300c and/or textured-tire 300d, region-of-first-color 302, region-of-second-color 304, and/or wear-depth-gauge (tread-depth-gauge) 305 may all be made from the same material(s) as each other, aside from colorant (color) differences. In some embodiments, with respect to a given blank-tire 300c and/or textured-tire 300d, region-of-first-color 302, region-of-second-color 304, and/or wear-depth-gauge (tread-depth-gauge) 305 may all be made from the same material(s), aside from colorant (color) differences, that vehicle tires are made from.

FIG. 3J shows a cross-sectional schematic block diagram of a given removal machine 351 operating upon a section of a given blank-tire 300c to generate regions/portions of textured-tire 300d after tool-head 352 (of that removal machine 351) has passed and worked on those regions/portions. FIG. 3J is similar to FIG. 3G, except in FIG. 3J the region-of-second-color 304 and the tread-depth-gauge 305 are each organized as a cylindrical sheet that are fixedly embedded within material(s) of blank-tire 300c; as opposed, to being discreet pluralities of bands 304 and bands 305 that are fixedly embedded within material(s) of blank-tire 300c as shown in FIG. 3G. However, note depth-of-groove 307 (recessed-depth 307) associated with region-of-second-color 304 may be the same in both FIG. 3J and in FIG. 3G; and similarly, depth-of-gauge 309 associated with tread-depth-gauge 305 may be the same in both FIG. 3J and in FIG. 3G.

In FIG. 3J, wherever machine 351 and/or tool-head 352 form a given recessed-portion 303 (to depth-of-groove 307 [recessed-depth 307]) with respect to a transverse width of blank-tire 300c, may result in region-of-second-color 304 becoming visible at the bottom of such formed recessed-portion 303 because region-of-second-color 304 may run at least most of the transverse width of blank-tire 300c (see also, FIG. 3K).

In FIG. 3J, wherever machine 351 and/or tool-head 352 form a given raised-portion (tread) 301 with respect to the transverse width of blank-tire 300c, may result in that formed raised-portion (tread) 301 containing a section of tread-depth-gauge 305 because tread-depth-gauge 305 may run at least most of the transverse width of blank-tire 300c at the depth-of-gauge 309 (see also, FIG. 3K).

FIG. 3K is a top view, a bottom view, a front view, or a rear view of a given blank-tire 300c, according to least one embodiment. In some embodiments, blank-tire 300c may comprise at least one cylindrical sheet of region-of-second-color 304 fixedly (at least partially to completely) embedded within material(s) of blank-tire 300c at a depth-of-groove 307 (recessed-depth 307). In some embodiments, blank-tire 300c may comprise at least one cylindrical sheet of tread-depth-gauge 305 fixedly embedded within material(s) of blank-tire 300c at a depth-of-gauge 309. FIG. 3K is similar to FIG. 3H, except in FIG. 3K the region-of-second-color 304 and the tread-depth-gauge 305 are each organized as a cylindrical sheet that are fixedly embedded within material(s) of blank-tire 300c; as opposed, to being discreet pluralities of bands 304 and bands 305 that are fixedly embedded within material(s) of blank-tire 300c as shown in FIG. 3H. However, note depth-of-groove 307 (recessed-depth 307) associated with region-of-second-color 304 may be the same in both FIG. 3K and in FIG. 3H; and similarly, depth-of-gauge 309 associated with tread-depth-gauge 305 may be the same in both FIG. 3K and in FIG. 3H.

Note, if FIG. 3K had included sectional-line 3I-3I, then FIG. 3I could be generated from such a sectional line in FIG. 3K; i.e., a same section line both FIG. 3K and FIG. 3H (e.g., sectional-line 3I-3I) would generate the same figure, that of FIG. 3I (i.e., embedded sheets or embedded bands looks the same in FIG. 3I).

With respect to FIG. 3K, FIG. 3I may be interpreted to show blank-tire 300c comprising at least one cylindrical sheet of region-of-second-color 304 fixedly embedded within material(s) of blank-tire 300c at a depth-of-groove 307 (recessed-depth 307). With respect to FIG. 3K, FIG. 3I may be interpreted to show blank-tire 300c comprising at least one cylindrical sheet of tread-depth-gauge 305 fixedly embedded within material(s) of blank-tire 300c at a depth-of-gauge 309.

FIG. 3L shows a cross-sectional schematic block diagram of a given additive machine (3D printer) 351 operating upon a section of a given blank-tire 300c to generate regions/portions of textured-tire 300d after print-head 354 (of that additive machine 351) has passed and worked on those regions/portions. FIG. 3L may be similar to FIG. 3G, except in FIG. 3L machine 351 (and/or its print-head 354) may be adding material onto blank-tire 300c to form textured-tire 300d, in a 3D printing (additive manufacturing) fashion; whereas, machine 351 (and/or its tool-head 352) in FIG. 3G may be removing material from blank-tire 300c to generate textured-tire 300d. With respect to FIG. 3L, in some embodiments, blank-tire 300c may not comprise any regions-of-second-color 304 nor any tread-depth-gauges 305. With respect to FIG. 3L, in some embodiments, blank-tire 300c may not comprise: raised-portions (treads) 301, recessed-portions 303, regions-of-second-color 304, tread-depth-gauges 305, depth-of-groove 307, depth-of-gauge 309, and/or exterior-surface 311. With respect to FIG. 3L, in some embodiments, blank-tire 300c may not comprise at least one of: raised-portions (treads) 301, region-of-first-color 302, recessed-portions 303, regions-of-second-color 304, tread-depth-gauges 305, depth-of-groove 307, depth-of-gauge 309, and/or exterior-surface 311. With respect to FIG. 3L, in some embodiments, raised-portions (treads) 301, region-of-first-color 302, recessed-portions 303, regions-of-second-color 304, tread-depth-gauges 305, depth-of-groove 307 (recessed-depth 307), depth-of-gauge 309, and/or exterior-surface 311 may be formed by print-head 354 adding material(s) onto blank-tire 300c to form textured-tire 300d. In some embodiments, raised-portions (treads) 301, region-of-first-color 302, recessed-portions 303, regions-of-second-color 304, tread-depth-gauges 305, depth-of-groove 307 (recessed-depth 307), depth-of-gauge 309, and/or exterior-surface 311 may be formed by print-head 354 adding material(s) onto an outer exterior curves surface of blank-tire 300c to form textured-tire 300d.

FIG. 3M shows a cross-sectional schematic block diagram of a given removal machine 351 operating upon a section of a given blank-tire 300c to generate regions/portions of textured-tire 300d after tool-head 352 (of that removal machine 351) has passed and worked on those regions/portions. FIG. 3M is substantially similar to FIG. 3G, except in FIG. 3M one or more region-of-second-color 304 (recessed-color 304) may extend to (onto) and/or may be visible on/from sidewall 371 of textured-tire 300d. In some embodiments, non-conflicting discussing of FIG. 3G may also apply to FIG. 3M. In some embodiments, textured-tire 300d may comprise tire sidewalls 371. In some embodiments, textured-tire 300d may comprise colored region(s)/portion(s) 304 on its sidewall 371. In some embodiments, colored region(s)/portion(s) 304 of sidewall 371 may be at least one predetermined color. In some embodiments, colored region(s)/portion(s) 304 of sidewall 371 may be the same color(s) as region(s)-of-second-color 304 (recessed-color 304) located in recessed-portion(s) 303 of textured-tire 300d. In some embodiments, other regions/portions of sidewall 371 of textured-tire 300d, other than colored region(s)/portion(s) 304 of sidewall 371, may have at least one different color that may be different from the color(s) of colored region(s)/portion(s) 304 of sidewall 371.

FIG. 3N shows a cross-sectional schematic block diagram of a given removal machine 351 operating upon a section of a given blank-tire 300c to generate regions/portions of textured-tire 300d after tool-head 352 (of that removal machine 351) has passed and worked on those regions/portions. FIG. 3N is substantially similar to FIG. 3J, except in FIG. 3N one or more region-of-second-color 304 (recessed-color 304) may extend to and/or may be visible on/from sidewall 371 of textured-tire 300d. In some embodiments, non-conflicting discussing of FIG. 3J may also apply to FIG. 3N. In some embodiments, textured-tire 300d may comprise tire sidewalls 371. In some embodiments, textured-tire 300d may comprise colored region(s)/portion(s) 304 on its sidewall 371. In some embodiments, colored region(s)/portion(s) 304 of sidewall 107 may be at least one predetermined color. In some embodiments, colored region(s)/portion(s) 304 of sidewall 371 may be the same color(s) as region(s)-of-second-color 304 (recessed-color 304) located in recessed-portion(s) 303 of textured-tire 300d. In some embodiments, other regions/portions of sidewall 371 of textured-tire 300d, other than colored region(s)/portion(s) 304 of sidewall 371, may have at least one different color that may be different from the color(s) of colored region(s)/portion(s) 304 of sidewall 371.

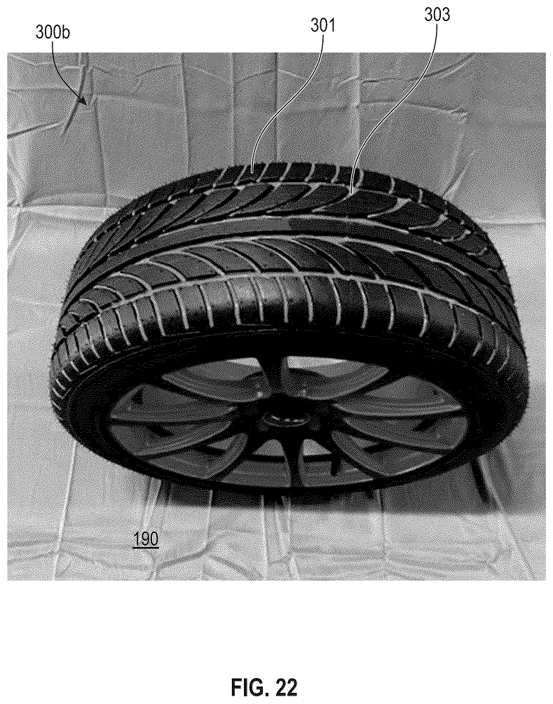

See e.g., FIG. 22 to FIG. 26 for color photographs of textured-tire 300d with different colored recessed-portions versus color of the raised-portions.

FIG. 3O is a perspective cross-sectional view through a portion of a given blank-tire 300c (tire-blank 300c) according to at least one embodiment of the present invention. In some embodiments, blank-tire 300c may be configured to be acted upon (e.g., by machine 351) to result in a finished textured-tire 300d. Compare FIG. 3O to FIG. 3P. FIG. 30 shows a portion of a given blank-tire 300c. FIG. 3P shows a portion of a given textured-tire 300d. Continuing discussing FIG. 30, in some embodiments, wherein blank-tire 300c may be at least substantially the same as a preexisting tire 100, except that blank-tire 300c has no tread elements 101 on an outer exterior surface 383 of blank-tire 300c that are intended to come into periodic direct physical contact with a road surface 190. For example, and without limiting the scope of the present invention, in some embodiments, blank-tire 300c may comprise: at least one belt 361 (such as, but not limited to, a steel belt); at least one body ply 363; at least one bead 365; at least one bead filler 367; an inner-liner 369; and/or sidewalls 371 (e.g., as those terms are normally/typically applied to a given motor vehicle tire). In some embodiments, at least one belt 361; at least one body ply 363; at least one bead 365; at least one bead filler 367; an inner-liner 369; and sidewalls 371-of a given blank-tire 300c may be at least substantially to exactly the same as such components in a preexisting tire 100. However, in some embodiments, blank-tire 300c may be devoid of tread elements 101. See e.g., FIG. 30.

Continuing discussing FIG. 3O, in some embodiments, blank-tire 300c may comprise tread-precursor-material 381/805 that may be exteriorly located to an outermost belt 361 of the blank-tire 300 c. In some embodiments, tread-precursor-material 381/805 may (completely) wrap around an outer circumference of the outermost belt 361. In some embodiments, tread-precursor-material 381/805 may comprise (include) the outer exterior surface 383 of the blank-tire 300c that is intended to come into periodic direct physical contact with the road surface 190. See e.g., FIG. 30.

Continuing discussing FIG. 3O, in some embodiments, at least a portion of the tread-precursor-material 381/805 may be intended to be (permanently) removed from the blank-tire 300c and once removed, may form the finished textured-tire 300d. In some embodiments, at least a portion of the tread-precursor-material 381 may be (permanently) removed from the blank-tire 300c to a recessed-depth 307 (from outer exterior surface 383) (and once so removed, may form the finished textured-tire 300d). In some embodiments, this removal of tread-precursor-material 381/805 may be done by machine 351. See e.g., FIG. 3O.

Continuing discussing FIG. 3O, in some embodiments, the removal of the at least a portion of the tread-precursor-material 381 may form a tread pattern of the finished textured-tire 300d. In some embodiments, this tread pattern may comprise at least one raised-portion 301 and at least one recessed-portion 303. In some embodiments, this tread pattern may comprise a plurality of raised-portions 301 and a plurality of recessed-portions 303. In some embodiments, this tread pattern may be predetermined. In some embodiments, this tread pattern may match a tread pattern of a preexisting tire 100 (in a worn or unworn state). In some embodiments, the removal of the at least a portion of the tread-precursor-material 381/805 may be done by machine 351. In some embodiments, machine 351 may be a CNC machine (such as, but not limited to, a CNC router machine). See e.g., FIG. 3O.

Continuing discussing FIG. 3O, in some embodiments, the blank-tire 300c may comprise at least one layer 304/803 that may be (entirely) (fixedly) embedded within the tread-precursor-material 381/805 (at a recessed-depth 307 from outer exterior surface 383/393). In some embodiments, the blank-tire 300c may comprise at least one layer 304/803 that may be at least partially (fixedly) embedded within the tread-precursor-material 381/805 (at a recessed-depth 307 from outer exterior surface 383/393); e.g., in embodiments when at least a portion of at least one layer 304/803 may be exteriorly visible on sidewall 371 (and without machine 351 making it visible). In some embodiments, when at least some portion of the tread-precursor-material 381/805 may be (permanently) removed from the blank-tire 300c, then where the at least some portion of the tread-precursor-material 381/805 has been removed (e.g., by operation of machine 351 upon blank-tire 300c) (e.g., to recessed-depth 307), then the at least one layer 304/803 may become visible to an observer that is external to the blank-tire 300 c. In some embodiments, the at least one layer 304/803 may be a first color 304 (recessed-color 304) and the tread-precursor-material 381/805 may be a second color 302 (majority color 302 or raised-color 302). Note, use of “first” and “second” in this manner is arbitrary, e.g., color 302 could have been referred to as a first color 302. In some embodiments, the first color 304 (recessed-color 304) and the second color 302 (majority color 302 or raised-color 302) may be different colors from each other. In some embodiments, at least some raised-portion(s) 301 and at least some recessed-portion(s) 303 may be different colors from each other. This different coloring may aid in enhancing and/or providing for visibility of textured-tire 300d. See e.g., FIG. 3O.

Continuing discussing FIG. 3O, in some embodiments, the blank-tire 300c may comprise at least one tread-wear-gauge-layer 305 that may be (initially entirely) (fixedly) embedded within the tread-precursor-material 381/805 at a gauge-depth 309 from the outer exterior surface 383. In some embodiments, when the outer exterior surface 383 wears down to the gauge-depth 309, then the at least one tread-wear-gauge-layer 305 may become visible to an observer that is external to the blank-tire 300c (and/or external to textured-tire 300d). In some embodiments, the at least one tread-wear-gauge-layer 305 may be a first color 305 (gauge-color 305) and the tread-precursor-material 381/805 may be is a second color 302 (majority color 302 or raised-color 302). In some embodiments, the first color 305 (gauge-color 305) and the second color 302 (majority color 302 or raised-color 302) may be different colors from each other. In some embodiments, the color 305 (of the tread-wear-gauge-layer 305) and the recessed-color 304 (color at the bottoms of at least some recessed-portions 303) may be different colors from each other. See e.g., FIG. 30.

FIG. 3P is a perspective cross-sectional view through a portion of a given textured-tire 300d according to at least one embodiment of the present invention. For example, and without limiting the scope of the present invention, FIG. 3P shows a processing and/or manufacturing result from machine 351 acting upon a given blank-tire 300c to yield and/or generate a given textured-tire 300d. FIG. 3P (textured-tire 300d) may differ from FIG. 3O, in that FIG. 3P (textured-tire 300d) shows and/or includes formed tread elements; whereas, FIG. 30 (blank-tire 300c) does not. In some embodiments, textured-tire 300d (just like blank-tire 300c) may comprise: at least one belt 361 (such as, but not limited to, a steel belt); at least one body ply 363; at least one bead 365; at least one bead filler 367; an inner-liner 369; and/or sidewalls 371 (e.g., as those terms are normally applied to a given tire). In some embodiments, the belt(s) 361, ply(s) 363; bead 365, bead filler 367, inner-liner, and/or sidewalls 371 of a given blank-tire 300c are the same belt(s) 361, ply(s) 363; bead 365, bead filler 367, inner-liner, and/or sidewalls 371 in a textured-tire 300d that was formed from that given blank-tire 300c. In some embodiments, outer exterior surface 393 may be outer most curved exterior surfaces of raised-portions 301 of textured-tire 300d. In some embodiments, outer curved exterior surface 393 of textured-tire 300d may be an equivalent and/or same structure as outer curved exterior surface 383 of blank-tire 300c; i.e., both may be outermost curved exterior surface(s) of their respective tire structure that is/are intended to come into periodic direct physical contact with a given road surface 190 during intended (normal) rolling use of the given tire. However, structurally outer exterior surface 393 may differ from outer curved exterior surface 383, in that outer curved exterior surface 383 may be at least substantially (mostly) a single outer most curved exterior surface of blank-tire 300c; whereas, outer curved exterior surface(s) 393 may be many outer most curved exterior surfaces of textured-tire 300d that are broken up by the plurality of recessed-portions 303. In some embodiments, outer exterior surface 383 and/or outer exterior surface 393 may be replaced with exterior-surface 311. In some embodiments, with respect to FIGS. 3O and 3P, the upper most layer, with the diagonal fill pattern, with reference numeral 381 in FIG. 3O, may comprise upper-most-color 302, recessed-color 304, and/or wear-gauge 305; and may form raised-portions 301 and recessed-portions 303.

FIG. 3Q is a cross-sectional view through an upper portion of a given blank-tire 300c (tire-blank 300c). FIG. 3Q is similar to FIG. 3O, except in FIG. 3Q belt(s) 361, body plies 363, bead 365, bead filler 367, and inner-liner 369 may be omitted (but could be present in some embodiments); and/or FIG. 3Q may show how at least one colored-underlayment 304 layer may line tread-precursor-material 381 layer (outer most color 302) to an interior (inside) of tread-precursor-material 381 (outer most color 302). In some embodiments, the outermost layer 381 (layer 805) may be bonded to (attached to) at least one colored-underlayment 304 layer (inner layer 304/803), via welding, heat, surface melting, adhesive, glue, epoxy, layer adhesion, solvent bonding, extrusion, injection molding, vacuum sealing, vacuum forming, a portion thereof, combinations thereof, and/or the like. In some embodiments, the outermost layer 381 (layer 805) may be bonded to (attached to) at least one colored-underlayment 304 layer (inner layer 304/803) before or after those (at least) two layers are formed into a circular tire like shape. In some embodiments, forming into the circular tire like shape may be done via heat and/or vacuum forming. In some embodiments, the outermost layer 381 (layer 805) and the at least one colored-underlayment 304 layer (inner layer 304/803) may be formed (manufactured) separately from each other or together (and then joined [bonded] together). In some embodiments, the outermost layer 381 (layer 805) and the at least one colored-underlayment 304 layer (inner layer 304/803) may be extruded separately from each other or together (and then joined together). In some embodiments, the outermost layer 381 (layer 805) and the at least one colored-underlayment 304 layer (inner layer 304/803) may be formed (manufactured) as one integral unit of at least two bonded (joined) together layers (and then formed into the circular tire like shape if not already in that shape). In some embodiments, the outermost layer 381 (layer 805) and the at least one colored-underlayment 304 layer (inner layer 304/803) may be extruded as one integral unit of at least two bonded (joined) together layers (and then formed into the circular tire like shape). In some embodiments, the outermost layer 381 (layer 805) may be bonded to (attached to) at least one colored-underlayment 304 layer (inner layer 304/803) before machine 351 operates upon the outermost layer 381 (layer 805) (to form textured-tire 300d). In some embodiments, either the outermost layer 381 (layer 805) or the at least one colored-underlayment 304 layer (inner layer 304/803) may extend onto the sidewall(s) 371. In some embodiments, both the outermost layer 381 (layer 805) and the at least one colored-underlayment 304 layer (inner layer 304/803) may extend onto the sidewall(s) 371. In some embodiments, the positional relationship between the outermost layer 381 (layer 805) and the at least one colored-underlayment 304 layer (inner layer 304/803) may be maintained on the sidewall(s) 371 as well as where treads may be intended to be formed.

FIG. 3R is a cross-sectional view through an upper portion of a given textured-tire 300d (that may be made from a given blank-tire 300c). FIG. 3R is similar to FIG. 3P, except in FIG. 3R belt(s) 361, body plies 363, bead 365, bead filler 367, and inner-liner 369 may be omitted (but could be present in some embodiments); and/or FIG. 3R may show how at least one colored-underlayment 304 layer may line tread-precursor-material 381 (outer most color 302) to an interior (inside) of the tread-precursor-material 381 (outer most color 302) layer.

FIG. 3R may be a result of machine 351 acting upon at least some regions of tread-precursor-material 381 of a given blank-tire 300c to form a given textured-tire 300d.

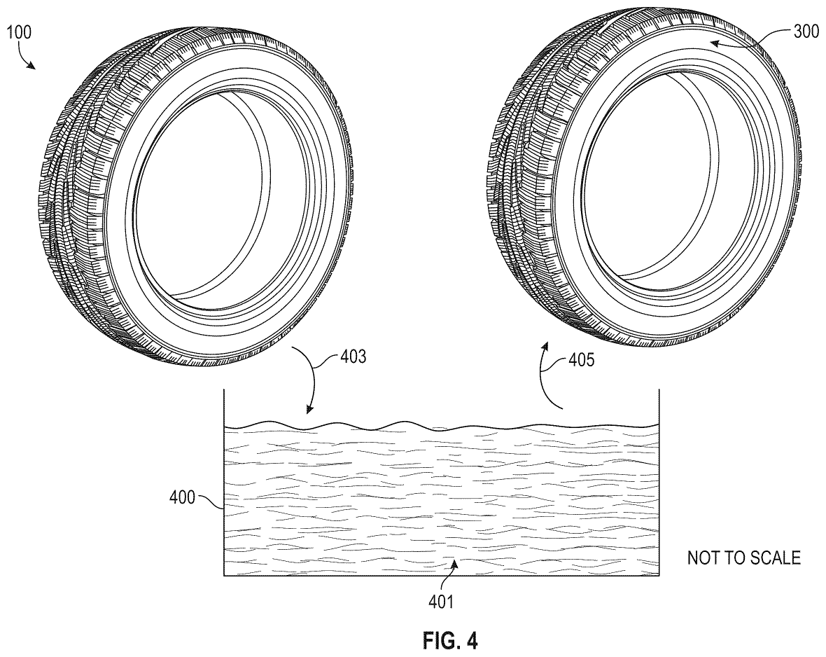

FIG. 4 shows how a given tire 100 may be dipped into a dipping bath 400 of fluid-sleeve-material 401, then removed from that bath 400, so that the fluid-sleeve-material 401 that is covering over an exterior of tire 100 may cure (dry) to form sleeve 300 on that tire 100 (forming a modified-tire 100a). In some embodiments, dipping bath 400 may be a container that is configured to hold (house) at least a predetermined volume of a liquid (or in a gel, slurry, or flowable form) and to not overflow when a tire 100 is dipped into the liquid (e.g., fluid-sleeve-material 401) within bath 400. In some embodiments, bath 400 may be open or openable at its top (e.g., for tire 100 access). In some embodiments, fluid-sleeve-material 401 may be a liquid, fluid, gel, slurry, flowable, uncured, and/or the like form of cured (solid, dried, and/or hardened) sleeve 300 (over an exterior of tire 100). In some embodiments, such curing (drying) may be activated and/or enhanced by shining a UV light upon that dipped fluid-sleeve-material 401 and/or by heating that applied dipped fluid-sleeve-material 401. In some embodiments, such curing (drying) may be activated and/or enhanced by exposure to one or more gases of the air, such as, but not limited to, oxygen. In some embodiments, such curing (drying) may be activated and/or enhanced by application of further different predetermined activating chemical (such as, but not limited to, two-part epoxies or water). In some embodiments, such curing (drying) may be a function of time, humidity, pressure, and/or temperature. In some embodiments, arrow 403 may designate a process (or step) of dipping a given tire 100 into bath 400 to be temporarily covered over by fluid-sleeve-material 401. In some embodiments, arrow 407 may designate a process (or step) of removing a previously dipped tire 100 from bath 400, so that the fluid-sleeve-material 401 covering over that tire 100 may then cure, dry, harden, and/or solidify into sleeve 300 that is attached to that given tire 100 (and thus forming modified-tire 100a). In some embodiments, any undesired burrs and/or cured, dried, hardened, and/or solidified drips of sleeve 300 may be removed using typical machining, deburring, sanding, grinding, cutting, and/or the like operations. In some embodiments, fluid-sleeve-material 401 may be one or more predetermined colors.

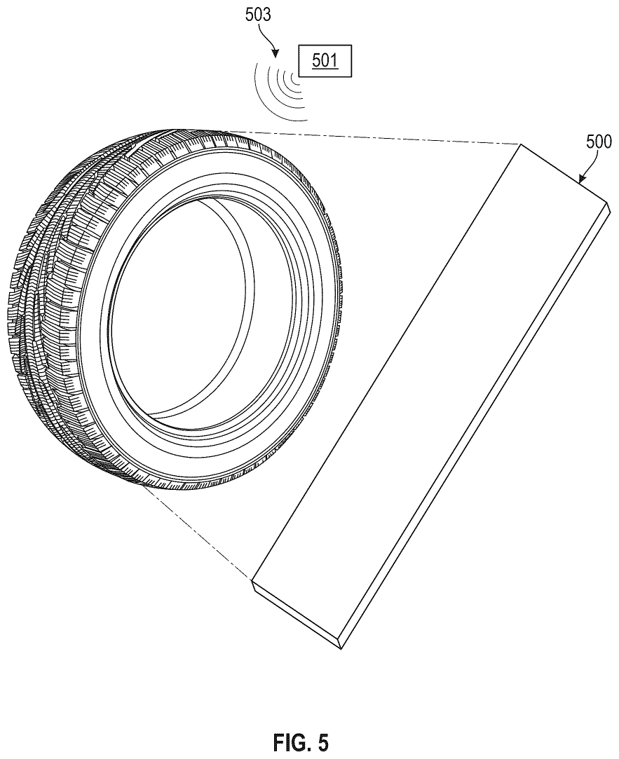

FIG. 5 shows a perspective view of tire 100 side-by-side with a sheet 500, wherein that sheet 500 is shown removed and/or detached from that tire 100; thus, FIG. 5 may be considered an exploded view with respect to tire 100 and sheet 500. The projection (broken) lines in FIG. 5 indicate that sheet 500 may be attached (or detached) to tire 100 in at least some embodiments. In some embodiments, sheet 500 may be attached (or detached) to tire 100 to form modified-tire 100a. In some embodiments, sheet 500 may be removably attached (or detached) to tire 100. In some embodiments, tire 100 may be fitted with sheet 500 to form modified-tire 100a. In some embodiments, sheet 500 is a separate component (part) that is configured to (removably) attach to and to least mostly cover over the grooves 103 and/or the tread 101 of a given tire 100. In some embodiments, once a given sheet 500 is attached to a given tire 100, that sheet 500 may become a sleeve 300, such as shown in FIG. 3C and/or in FIG. 3D. In some embodiments, sheet 500 may be curved around a circumference of tire 100 to form sleeve 300 or to begin forming sleeve 300. In some embodiments, once sheet 500 has been curved around the circumference of tire 100, that curved sheet 500 may be heat treated to heat shrink curved sheet 500 to the external surface geometry of tread 101 and/or of groove(s) 103 of that given tire, using heat source 501, to form sleeve 300 attached to that given tire 100. In some embodiments, sheet 500 may be one or more predetermined colors. In some embodiments, sheet 500 may be a flat and/or planar member. In some embodiments, sheet 500 may have a fixed, finite, and/or non-variable length, width, and/or thickness (e.g., before any heat treatment). In some embodiments, prior to cutting sheet 500 to a particular length, sheet 500 may exist in a roll configuration. In some embodiments, sheet 500 may have a thickness selected from: one (1) millimeter (mm) to twenty (20) mm. In some embodiments, sheet 500 may have a thickness selected from: one-thirty-second ( 1/32) inch to one half (½) inch. In some embodiments, sheet 500 may be flexible, bendable, pliable, moldable, stretchable, non-rigid, and/or the like. In some embodiments, sheet 500 may be have dimensions that are configured to at least fit around a circumference of a given tire 100. In some embodiments, a surface of sheet 500 that physically contacts tire 100 may have one or more adhesives, glues, and/or epoxies that are configured to attach sheet 500 to tire 100. In some embodiments, heat source 501 may emit heat 503. In some embodiments, heat source 501 may be used to direct heat 503 at sheet 500 that is wrapping and/or curving around a circumference of tire 100 to heat shrink sheet 500 to tire 100 and/or to attach sheet 500 to tire 100, to form sleeve 300 attached to that given tire 100. In some embodiments, heat source 501 may emit heat 503 via convection, radiation, conduction, combinations thereof, and/or the like. In some embodiments, sheet 500 may be used to form a blank sleeve 300a or a textured sleeve 300b; i.e., sheet 500 may be blank or textured. The CNC machine 351 (or the like) process shown in FIG. 3E, FIG. 3F, FIG. 3G, FIG. 3J, FIG. 3M, and/or FIG. 3N may be applied to a given blank sheet 500 to generate a textured sheet 500.

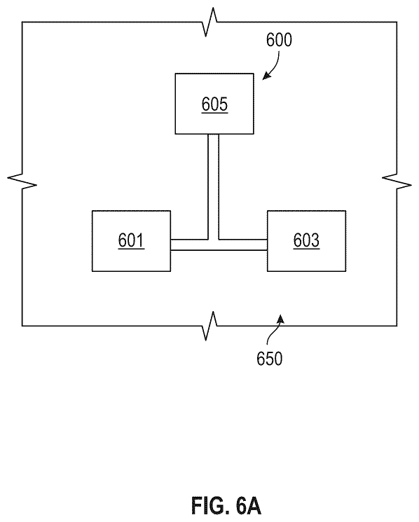

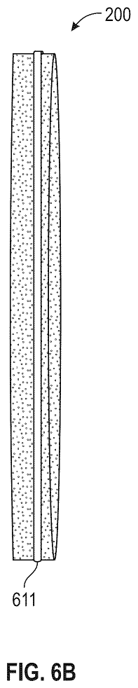

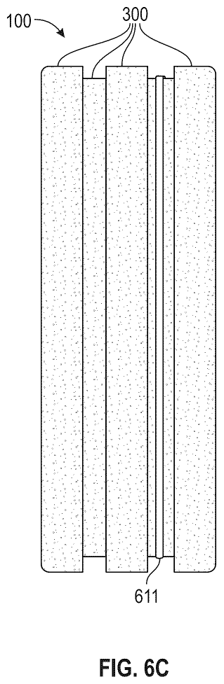

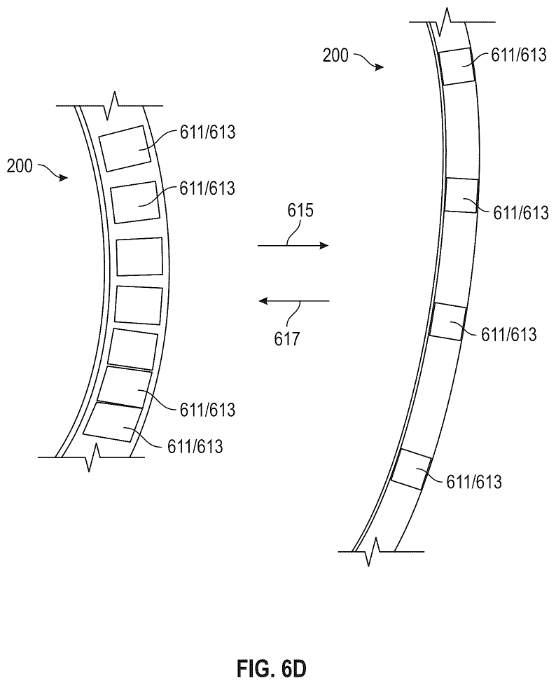

FIG. 6A shows at least one electronic circuit 600 as part of a portion of at least one article 650. In some embodiments, article 650 may be selected from at least one of: tire-band 200, sleeve 300, sleeve 300a, textured sleeve 300b, blank-tire 300c, textured-tire 300d, raised-portion 301, recessed-portion 303, bottom of recessed-portion 303, region/color 304, wear-depth-gauge 305, sheet 500, sole-of-footwear 701, first-layer (inner-layer) 803, second-layer (outer-layer) 805, layer (raised portion) 807, article 1000, raised-portion 1001, recessed-portion 1003, bottom of recessed-portion 1003, a portion thereof, combinations thereof, and/or the like. In some embodiments, the at least one circuit 600 may be one or more of: on, in, attached to, (fixedly) embedded in and/or on, suspended within and/or on, dispersed within and/or on, a portion thereof, combinations thereof, and/or the like, with respect to a portion of article 650. In some embodiments, article 650 may comprise at least one circuit 600. In some embodiments, circuit 600 may comprise at least one LED (light emitting diode) light source 601 and at least one power-source 603. In some embodiments, the at least one LED light source 601 and at least one power-source 603 may be operatively linked (connected) together (e.g., via one or more electrically conductive wires). In some embodiments, the power-source 603 may provide electrical energy to LED light source 601 such that LED light source 601 lights up and emits light. In some embodiments, LED light source 601 may be configured to emit (predetermined) light of different: white color, non-white colors, brightness, intensity, lumens, temperature, and/or the like. In some embodiments, power-source 603 may be configured to store, collect, and/or harvest electrical energy. In some embodiments, power-source 603 may be configured to supply electrical energy to LED light source(s) 601. In some embodiments, power-source 603 may be selected from at least one of (or one or more of): a battery, a rechargeable battery, a capacitor, an antenna for harvesting electromagnetic energy, a Peltier circuit, a thermoelectric generator (TEG), a Seebeck generator, a solid-state device, combinations thereof, and/or the like. In some embodiments, the heat, the centrifugal force, and/or the centripetal force of a rotating tire 100 may cause power-source 603 to produce electricity for use by operatively connected LED light source(s) 601. In some embodiments, on a location (such as, but not limited to a wheel well) of a vehicle with tire 100, an electromagnetic source (e.g., a transmitting antenna) may broadcast electromagnetic energy that power-source 603 may harvest to produce electricity for use by operatively connected LED light source(s) 601.

Continuing discussing FIG. 6A, in some embodiments, circuit 600 may comprise at least one LED light source 601, at least one power-source 603, and at least one controller 605. In some embodiments, the at least one LED light source 601, the at least one power-source 603, and/or the controller 605 may be operatively linked (connected) together (e.g., via one or more electrically conductive wires). In some embodiments, controller 605 may be configured to control operation of LED light source 601 and/or of power-source 603. In some embodiments, controller 605 may be selected from one or more of: a printed circuit board (PCB), a programmable logic controller (PLC), a computer, a portion thereof, combinations thereof, and/or the like.

FIG. 6B shows at least one LED light strip 611 as being part of at least one tire-band 200 (band 200). In some embodiments, band 200 may comprise and/or may be a LED light strip 611. In some embodiments, band 200 may comprise a LED light strip 611 and an operatively connected power source. In some embodiments, the LED light strip 611 may be configured to emit light of different: white color, non-white colors, brightness, intensity, lumens, temperature, and/or the like. In some embodiments, the power source may be one or more batteries, which may be rechargeable in some embodiments. In some embodiments, the power source may be a circuit that is configured to generate electricity from heat, thermal differences, and/or from applied force. In some embodiments, the power source may be a Peltier circuit. In some embodiments, normal rotation (spinning) of tire 100 against a road surface 190 during driving, with attached band(s) 200 may generate sufficient heat and/or force to energize a LED light strip 611 of a band 200. In some embodiments, LED light strip 611 may comprise one or more circuit(s) 600.

FIG. 6C shows at least one LED light strip 611 as being part of a given sleeve 300. In some embodiments, sleeve 300 may comprise at least one LED light strip 611. In some embodiments, sleeve 300 may comprise a LED light strip 611 and an operatively connected power source. In some embodiments, the LED light strip 611 may be configured to emit light of different: white color, non-white colors, brightness, intensity, lumens, temperature, and/or the like. In some embodiments, the power source may be one or more batteries, which may be rechargeable in some embodiments. In some embodiments, the power source may be a circuit that is configured to generate electricity from heat, thermal differences, and/or from applied force. In some embodiments, the power source may be a Peltier circuit. In some embodiments, normal rotation (spinning) of tire 100 against a road surface 190 during driving, with attached sleeve 300 may generate sufficient heat and/or force to energize a LED light strip 611 of sleeve 300. In some embodiments, LED light strip 611 may comprise one or more circuit(s) 600.

FIG. 6D shows a portion of a given tire-band 200 both in its unstretched configuration and in its stretched configuration. In some embodiments, tire-band 200 may comprise an elastic property. In some embodiments, tire-band 200 may be at least partially elastic. Arrow 615 represents tire-band 200 transitioning from its unstretched configuration to its stretched configuration. Whereas, arrow 617 represents tire-band 200 transitioning from its stretched configuration to its unstretched configuration. Note, when tire-band 200 may be more wide and more thick in its unstretched configuration as compared to its stretched configuration. Tire-band 200 may be less wide and less thick in its stretched configuration as compared to its unstretched configuration.

Continuing discussing FIG. 6D, in some embodiments, tire-band 200 may comprise at least one LED/light-emitting-source 611 and/or at least one reflector 613. In some embodiments, attached to tire-band 200 may be at least one LED/light-emitting-source 611 and/or at least one reflector 613. In some embodiments, LED/light-emitting-sources 611 and/or reflectors 613 located on tire-band 200 may be located closer to each other when that tire-band 200 may be in its unstretched configuration as opposed to its stretched configuration. In some embodiments, LED/light-emitting-sources 611 and/or reflectors 613 located on tire-band 200 may be located further from each other when that tire-band 200 may be in its stretched configuration as opposed to its unstretched configuration. In some embodiments, accounting for spatial locations of LED/light-emitting-sources 611 and/or reflectors 613 located on tire-band 200 may be considered with respect to stretched configuration versus unstretched configuration of that tire-band 200. When modified-tire 100a, with at least one tire-band 200 fitted into one of its grooves 103, when spinning (rolling) spacing between LED/light-emitting-sources 611 and/or reflectors 613 located on that given tire-band 200 may be irrelevant and/or not important from an external observer point of view. Reflector(s) and/or reflective material(s) as discussed herein may be reflective with respect to light in the visual spectrum to humans.

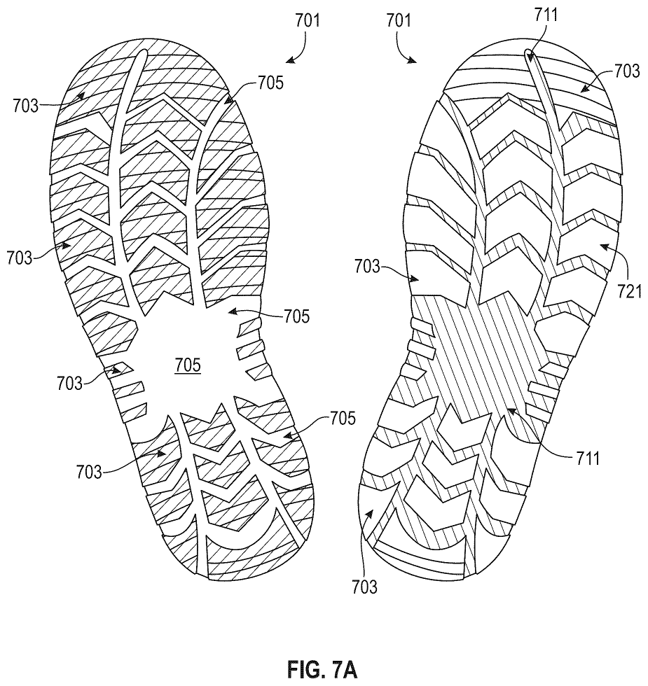

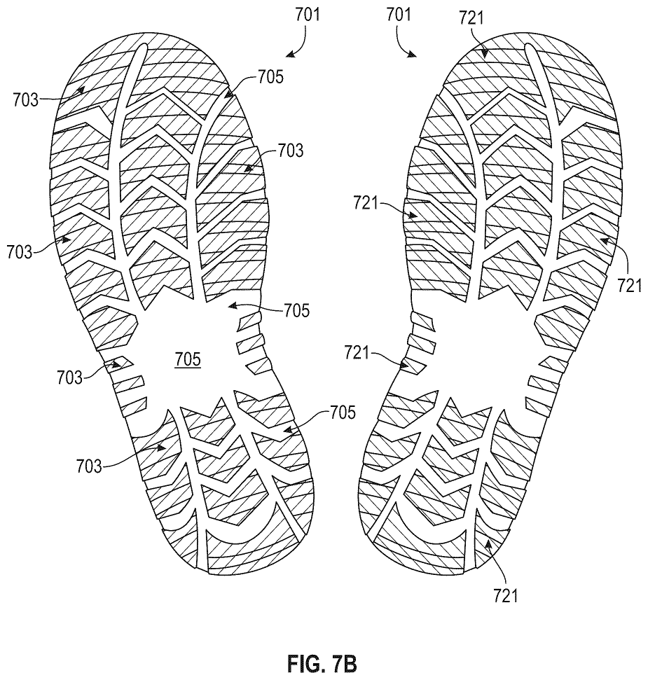

FIG. 7A shows a bottom view of a pair of shoes (footwear), such that the bottom of the soles 701 is being shown. The bottom of sole 701 (of a given article of footwear) has raised portions 703 and recessed regions 705, respectively, that generally operate to provide traction to the wearer, much in the same way as tread 101 and grooves 103 of a given tire 100 with respect to the tire's use on a given road surface 190. In FIG. 7A, two soles 701 are shown side by side and from their bottoms, a left side sole 701 and right side sole 701, according to an external observer looking at FIG. 7A. In FIG. 7A the raised portions 703 shown in the left side sole 701 are shown with a diagonal pattern. Whereas, in FIG. 7A the fill-material 711 shown in the right side sole 701 are shown in a different diagonal pattern. In FIG. 7A the recessed regions 705 are shown in the left side sole 701 without any pattern; and the recessed regions 705 in the right side sole 701 are covered by fill-material 711; although, in some embodiments, fill-material 711 need not cover all of the recessed regions 705 of a given sole 701. In some embodiments, the fill-material(s) 711 that form a given band 200 and/or a given sleeve 300 or a different fill-material 711, may be configured to at least partially fill in and attach within void volume recessed spaces 705 on the bottom of footwear (such as, but not limited to, a bottom sole 701 of a shoe). In some embodiments, such material(s) 711 may be of at least one predetermined color and/or with an ability to light up. In some embodiments, at least some to all of the recessed regions 705 of a given sole 701 of a given article of footwear, may be at least partially filled in with fill-material 711. In some embodiments, any recessed regions 705 of a given sole 701 of a given article of footwear, that may receive fill-material 711, that received fill-material 711 may stay in place by one or more of: glue, adhesive, epoxy, and/or the like being applied between the fill-material 711 and the recessed region 705; and/or by heat and/or ultrasonic welding between the fill-material 711 and the recessed region 705. In some embodiments, raised portions 703, recessed portions 705, and/or fill-material 711 may be different colors from each other. In some embodiments, raised portions 703 and recessed portions 705 may be different colors from each other. In some embodiments, raised portions 703 and fill-material 711 may be different colors from each other. In some embodiments, this addition of fill-material 711 to sole 701 may result in a bottom appearance of sole 701 such that at least some of raised portion(s) 703 and recessed region(s) 705 have different colors from each other. In some embodiments, fill-material 711 may comprise one or more circuits 600.

FIG. 7B shows a bottom view of a pair of shoes (footwear), such that the bottom of the soles 701 is being shown. In FIG. 7B, two soles 701 are shown side by side and from their bottoms, a left side sole 701 and right side sole 701, according to an external observer looking at FIG. 7B. In FIG. 7B the raised portions 703 shown in the left side sole 701 are shown with a diagonal pattern. Whereas, in FIG. 7B the added-material 721 shown in the right side sole 701 are shown in a different diagonal pattern. In FIG. 7B the raised portions 703 in the right side sole 701 are covered by added-material 721; although, in some embodiments, added-material 721 need not cover all of the raised portions 703 of a given sole 701. In FIG. 7B the recessed regions 705 are shown in both the left side sole 701 and the right side sole 701 without any pattern. In some embodiments, the added-material(s) 721 that form a given band 200 and/or a given sleeve 300 or a different added-material 721, may be configured to at least partially attach to raised portion(s) 703 on the bottom of footwear (such as, but not limited to, a bottom sole 701 of a shoe). In some embodiments, such added-material(s) 721 may be of at least one predetermined color and/or with an ability to light up. In some embodiments, at least some to all of the raised portion(s) 703 of a given sole 701 of a given article of footwear, may receive added-material 721. In some embodiments, any raised portion(s) 703 of a given sole 701 of a given article of footwear, that may receive added-material 721, that received added-material 721 may stay in place by one or more of: glue, adhesive, epoxy, and/or the like being applied between the added-material 721 and the raised portion 703; and/or by heat and/or ultrasonic welding between the added-material 721 and the raised portion 703. In some embodiments, raised portions 703, recessed portions 705, and/or added-material 721 may be different colors from each other. In some embodiments, raised portions 703 and recessed portions 705 may be different colors from each other. In some embodiments, recessed portions 705 and added-material 721 may be different colors from each other. In some embodiments, this addition of added-material 721 to sole 701 may result in a bottom appearance of sole 701 such that at least some of raised portion(s) 703 and recessed region(s) 705 have different colors from each other. In some embodiments, added-material 721 may comprise one or more circuits 600.

In some embodiments, the material(s) of construction of fill-material 711 and/or added-material 721 may be the same or substantially (mostly) the same type of material(s) as the material(s) of construction of sole 701, raised portion(s) 703, recessed region(s) 705, and/or the like. In some embodiments, the material(s) of construction of fill-material 711 and/or added-material 721 may be configured for attachment to the material(s) of construction of sole 701, raised portion(s) 703, recessed region(s) 705, and/or the like. In some embodiments, the material(s) of construction of fill-material 711 may be the same or substantially (mostly) the same as the material(s) of construction for added-material 721. However, in some embodiments, fill-material 711 and/or added-material 721 may have (show) one or more predetermined color(s), which may differ from color(s) of sole 701, raised portion(s) 703, recessed region(s) 705. In some embodiments, color(s) of raised portion(s) 703 may differ from color(s) of recessed region(s) 705. In some embodiments, sole 701, raised portion 703, recessed region 705, fill-material 711, and/or added-material 721 may be made from at least one: plastic, elastomer, rubber, silicone, thermoplastic, resin, epoxy, a portion thereof, combinations thereof, and/or the like. Note with respect to the materials of construction, it is not desired nor intended to thereby unnecessarily limit the present invention by reason of such disclosure.

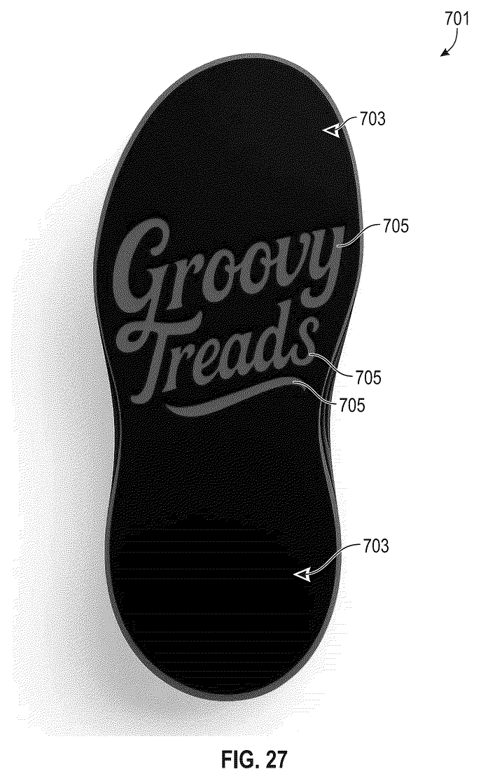

See e.g., FIG. 27 for a color photograph of textured sole-of-footwear 701 with different colored recessed-portions versus color of the raised-portions.

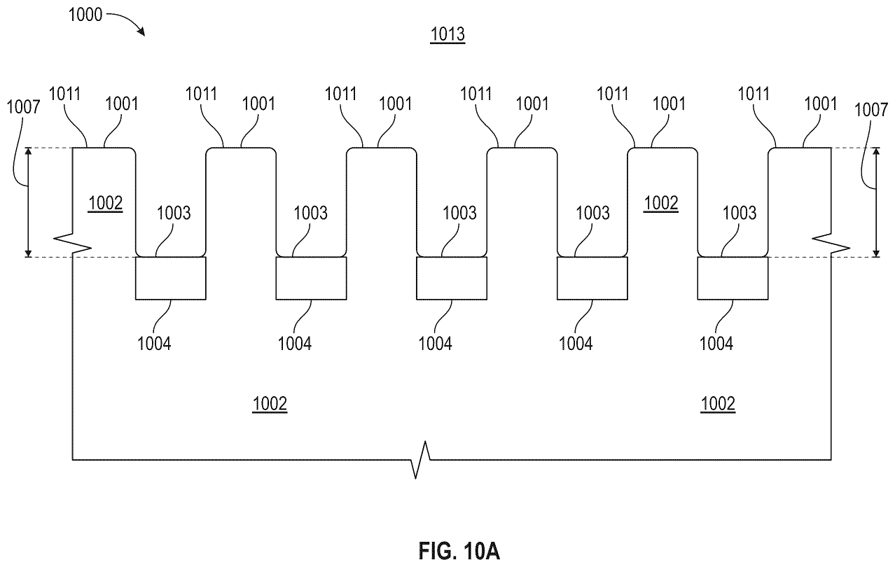

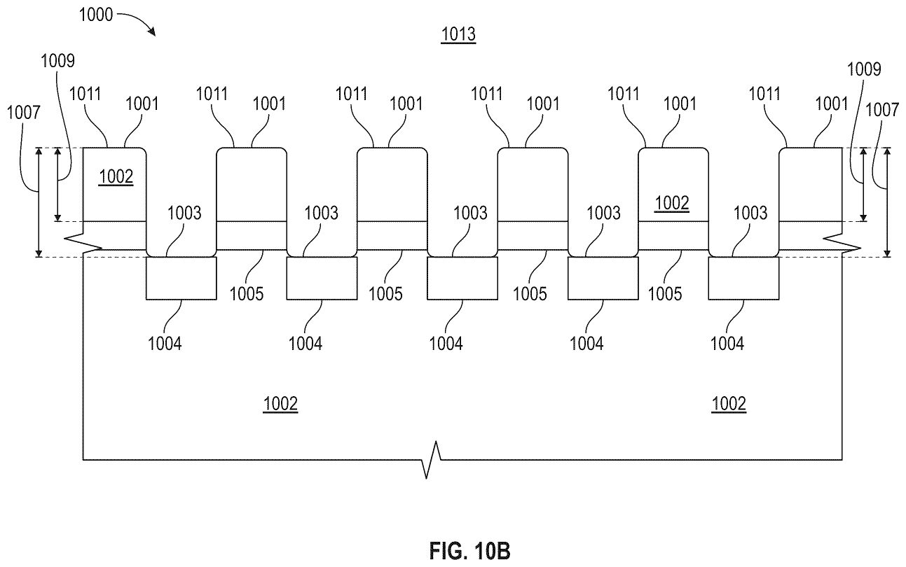

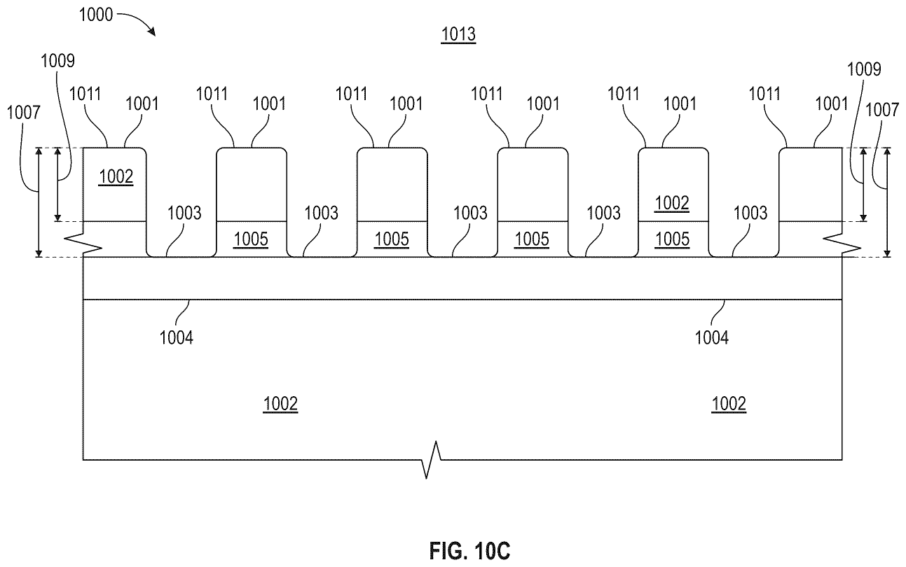

In some embodiments, a sole-of-footwear 701 may comprise a plurality of raised-portions 703/1001 and a plurality of recessed-portions 705/1003. In some embodiments, exterior-most surfaces (e.g., exterior-surfaces 1011) of the plurality of raised-portions 703 may be intended to come into removable direct physical contact with a ground surface when footwear that includes (comprises) that sole-of-footwear 701 may be used as intended upon that ground surface. In some embodiments, each recessed-portion 705, selected from the plurality of recessed-portions 705, may be directly adjacent to at least one raised-portion 703, selected from the plurality of raised-portions 703. In some embodiments, each recessed-portion 705, selected from the plurality of recessed-portions 705, may be recessed with respect to the exterior-most surfaces (e.g., exterior-surfaces 1011) of the plurality of raised-portions 703. In some embodiments, each raised-portion 703, selected from the plurality of raised-portions 703/1001, may be raised with respect to bottoms of the plurality of recessed-portions 705/1003. In some embodiments, at least some of upper regions of the plurality of raised-portions 703/1001 may be a first-color 1002 (exterior-most color 1002). In some embodiments, at least some of the bottoms of the plurality of recessed-portions 705/1003 may be a second-color 1004 (recessed-color 1004). In some embodiments, first-color 1002 may be referred to as exterior-most color 1002 when raised-portions 703/1001 may be at least substantially (mostly) unworn. If raised-portions 703/1001 becomes substantially worn down, then first-color 1002 may no longer be an exterior-most color; i.e., first-color 1002 and second-color 1004 could be at a same or similar depth with respect to each other once raised-portions 703/1001 becomes substantially worn down. In some embodiments, second-color 1004 may be referred to as recessed-color 1004 when raised-portions 703/1001 may be at least substantially (mostly) unworn. If raised-portions 703/1001 becomes substantially worn down, then second-color 1004 may no longer be a recessed-color; i.e., first-color 1002 and second-color 1004 could be at a same or similar depth with respect to each other once raised-portions 703/1001 becomes substantially worn down. In some embodiments, the first-color 1002 (exterior-most color 1002) and the second-color 1004 (recessed-color 1004) may be different colors from each other. See e.g., FIG. 7A, FIG. 7B, FIG. 10A, FIG. 10B, and FIG. 10C.

In some embodiments, the sole-of-footwear 701 may comprises a visual-wear-depth-gauge 1005. In some embodiments, the visual-wear-depth-gauge 1005 may be (fixedly) embedded within one or more raised-portions 703/1001, selected from the plurality of raised-portions 703/1001, at a first-depth 1009 (depth-of-gauge 1009) from the exterior-most surfaces 1011 of the plurality of raised-portions 703/1001. In some embodiments, the visual-wear-depth-gauge 1005 may be a third-color. In some embodiments, the first-depth 1009 (depth-of-gauge 1009) may be with respect to when the plurality of raised-portions 703/1001 may be at least substantially (mostly) unworn. In some embodiments, when the plurality of raised-portions 703/1001 may be at least substantially unworn, then the visual-wear-depth-gauge 1005 may not be visible from an exterior of the sole-of-footwear 701. In some embodiments, when the plurality of raised-portions 703/1001 may be at least substantially unworn, then the visual-wear-depth-gauge 1005 may not be visually visible to an external observer that is outside of sole-of-footwear 701. In some embodiments, the third-color (of visual-wear-depth-gauge 1005) may be different from: the second-color 1004 (recessed-color 1004); the first-color 1002 (exterior-most color 1002); and/or both the first-color 1002 (exterior-most color 1002) and the second-color 1004 (recessed-color 1004). In some embodiments, the visual-wear-depth-gauge 1005 becomes visible when a height of the plurality of raised-portions 703/1001 wears down to the first-depth 1009 (depth-of-gauge 1009). In some embodiments, the at least some of the bottoms of the plurality of recessed-portions 705/1003 that may be of the second-color 1004 (recessed-color 1004), may be located at a second-depth 1007 (recessed-depth 1007) from the exterior-most surfaces 1011 of the plurality of raised-portions 703/1001. In some embodiments, the second-depth 1007 (recessed-depth 1007) may be greater to or equal to the first-depth 1009 (depth-of-gauge 1009). In some embodiments, the second-depth 1007 (recessed-depth 1007) may be greater to the first-depth 1009 (depth-of-gauge 1009). In some embodiments, the second-depth 1007 (recessed-depth 1007) may be greater to the first-depth 1009 (depth-of-gauge 1009) when the plurality of raised-portions 703/1001 are at least substantially (mostly) unworn. In some embodiments, the second-depth 1007 (recessed-depth 1007) may be with respect to when the plurality of raised-portions 703/1001 may be at least substantially (mostly) unworn. See e.g., FIG. 10B and FIG. 10C.

In some embodiments, with respect to sole-of-footwear 701, the first-color 1002 (exterior-most color 1002) and the second-color 1004 (recessed-color 1004) may be different colors from each other to increase pedestrian visibility of a person wearing the footwear that includes the sole-of-footwear 701, as compared to a different-sole-of-footwear where its raised-elements and its recessed-elements of that different-sole-of-footwear are all a same color. In some embodiments, the first-color 1002 (exterior-most color 1002) and the second-color 1004 (recessed-color 1004) may be different colors from each other to increase pedestrian safety of a person wearing the footwear that includes the sole-of-footwear 701, as compared to a different-sole-of-footwear where its raised-elements and its recessed-elements of that different-sole-of-footwear are all a same color. See e.g., FIG. 7A, FIG. 7B, FIG. 10A, FIG. 10B, and FIG. 10C.

Personnel of a given organization may wear one or more uniforms. Those uniforms may include (comprise) footwear. That footwear may include (comprise) sole-of-footwear 701. Those uniforms, including (comprising) sole-of-footwear 701, may have at least some portion(s) that may be colored (such as, but not limited to, recessed region(s) 705/1003) to be color coded. A particular color coding may be associated with particular functions. In some embodiments, personnel uniforms of a given organization may use color-coded soles-of-footwear 701. The personnel uniforms may be privately owned, government owned, or combinations thereof. The personnel uniforms may be associated with a private entity, a government entity, a public entity, a non-profit entity, an organization, or combinations thereof. In some embodiments, the at least one predetermined color of a given recessed region(s) 705/1003 (and/or of raised portion 703/1001) may be assigned (e.g., in a database or the like records keeping system) to at least one function of a personnel-uniform-management-system. In some embodiments, the first-color 1002 (exterior-most color 1002) may be a predetermined color. In some embodiments, the second-color 1004 (recessed-color 1004) may be a predetermined color. In some embodiments, the first-color 1002 (exterior-most color 1002) or the second-color 1004 (recessed-color 1004) may be a predetermined color. In some embodiments, the predetermined color(s) of the sole-of-footwear 701 may be assigned to at least one function of the personnel-uniform-management-system. In some embodiments, that at least one function may be associated with a uniform (of an organization) that uses such color-coded soles-of-footwear 701. In some embodiments, the at least one function may be correspond to at least one of: a job-site location (e.g., where the personnel is supposed to work at), a location (e.g., a location assigned to that soles-of-footwear 701), a driver (e.g., a driver assigned to that soles-of-footwear 701), a worker (e.g., a worker assigned to that soles-of-footwear 701), a user (e.g., a user assigned to that soles-of-footwear 701), a task (e.g., a task to be performed by a wearer of that soles-of-footwear 701), a use, a portion thereof, combinations thereof, and/or the like. And thus, by merely observing the color-coded soles-of-footwear 701 of a given footwear as part of a uniform, one (and/or a computing system) can (may) know the at least one function for that sole-of-footwear 701 (of its uniform).

In some embodiments, with respect to sole-of-footwear 701, the second-color 1004 (recessed-color 1004) may be formed by spraying an initially liquid form of the second-color 1004 (recessed-color 1004) onto the at least some of the bottoms, of the plurality of recessed-portions 705/1003, that dries and/or cures in place as the (solid/cured) second-color 1004 (recessed-color 1004). In some embodiments, the second-color 1004 (recessed-color 1004) may be formed by painting a liquid form of the second-color 1004 (recessed-color 1004) onto the at least some of the bottoms, of the plurality of recessed-portions 705/1003, that dries and/or cures in place as the (solid/cured) second-color 1004 (recessed-color 1004). In some embodiments, the second-color 1004 (recessed-color 1004) may be formed by extruding a liquid form of the second-color 1004 (recessed-color 1004) onto the at least some of the bottoms, of the plurality of recessed-portions 705/1003, that dries and/or cures in place as the (solid/cured) second-color 1004 (recessed-color 1004).

In some embodiments, the footwear, that the given sole-of-footwear 701 is part of, may be selected from at least one of: a shoe, a sneaker, a boot, a sandal, a loafer, a slipper, a cleat, a pump, a heel, a clog, a thong, a flip-flop, a moccasin, a hightop, a wing-tip, a wader, an article that at least partially covers over a foot of a person, an article that protects the foot, an article that attaches to the foot, an articles that is worn by the foot, footwear that has a sole element, and/or the like.

In some embodiments, sole-of-footwear 701, article 1000, a portion thereof, combinations thereof, and/or the like, may be made by/from at least one of: casting, molding, injection molding, CNC machining, 3D printing, machining operations, heating operations, welding operations, annealing operations, vacuum operations, extrusion, a portion thereof, combinations thereof, and/or the like.

FIG. 8A shows a perspective view of subassembly 800 both in an exploded (dissembled or pre-assembled) configuration and in an assembled configuration (shown side-by-side to each other). In some embodiments, subassembly 800 may comprise at least two layers, a first-layer 803 and a second-layer 805. In some embodiments, subassembly 800 may comprise a substrate 801, first-layer 803, and second-layer 805. In some embodiments, first-layer 803 may be attached to substrate 801. In some embodiments, substrate 801 may be a carcass layer of a given tire 100. In some embodiments, the carcass layer of a given tire 100 may be the outermost rubber layer(s) of a tire, outside of any steel belts, but before the tread 101. In some embodiments, substrate 801 may be a crown ply of a given tire 100. In some embodiments, the crown plies of a given tire 100 may be the outermost rubber layer(s) of a tire, outside of any steel belts, but before the tread 101. In some embodiments, substrate 801 may be an inner most layer of a sole of footwear that is not intended to make physical contact with the ground (e.g., when a wearer is wearing and using the footwear in a normal intended manner). In some embodiments, substrate 801 may be an inner most layer of a sole of footwear, not including the outer sole. In some embodiments, substrate 801 may be: a non-tread layer of a tire 100, a non-tread layer of article 300, a layer of article 1000, a layer of a floormat 1400, or a layer of a vehicle bed liner 1500; wherein the layer of substrate 801 is not intended to come into direct physical contact with at least one or more of: the ground, a road surface 190, bottoms of footwear, and/or objects placed on top of article 1000/liner 1500.

Continuing discussing FIG. 8A, in some embodiments, (a surface of) first-layer 803 may be attached (directly) to (a surface of) substrate 801 by one or more of: glue, adhesive, epoxy, welding, heat welding, ultrasonic welding, solvent bonding, combinations thereof, and/or the like. In some embodiments, first-layer 803 may be disposed (directly) between substrate 801 and second-layer 805 (without any intervening materials located therebetween aside from glues, adhesives, and/or epoxies [when any are utilized]). In some embodiments, opposing surfaces of first-layer 803 may be in direct physical contact with substrate 801 and with second-layer 805, respectively (without any intervening materials located therebetween aside from glues, adhesives, and/or epoxies [when any are utilized]). In some embodiments, (a surface of) first-layer 803 may be attached (directly) to (a surface of) second-layer 805 by one or more of: glue, adhesive, epoxy, welding, heat welding, ultrasonic welding, solvent bonding, combinations thereof, and/or the like. In some embodiments, the surface of first-layer 803 that is attached to substrate 801 is not attached to second-layer 805. In some embodiments, the surface of first-layer 803 that is attached to second-layer 805 is not attached to substrate 801. In some embodiments, first-layer 803 and second-layer 805 may be attached to each other before first-layer 803 is attached to substrate 801. In some embodiments, first-layer 803 and second-layer 805 may be attached to each other after or concurrently when first-layer 803 is attached to substrate 801.

Continuing discussing FIG. 8A, in some embodiments, enhancement and/or completion of the attachment (adhesion and/or welding) between first-layer 803 and second-layer 805, and/or between first-layer 803 and substrate 801 may occur by placing such items within a vacuum chamber 813 while a pressure within that vacuum chamber 813 may be maintained at less than the local (ambient) atmospheric pressure by virtue of a vacuum pump 815 (or the like) that is operationally connected to vacuum chamber 813, for at least some minimal predetermined amount of time. The broken lines outlining a parallelogram in FIG. 8A may indicate a boundary of vacuum chamber 813. Note, in some embodiments, such a vacuum chamber 813 and/or vacuum pump 815 may not be used.

Continuing discussing FIG. 8A, in some embodiments, with respect to subassembly 800 in its assembled configuration, first-layer 803 may be located closer to substrate 801 as compared to second-layer 805, as such first-layer 803 may also be referred to as inner-layer 803. In some embodiments, with respect to subassembly 800 in its assembled configuration, second-layer 805 may be located further away from substrate 801 as compared to first-layer 803, as such second-layer 805 may also be referred to as outer-layer 805 and/or as raised-layer 805, and/or as outer most exterior layer 805.

Further, while FIG. 8A shows substrate 801, first-layer 803, and second-layer 805 as planar sheet materials in a generally flat configuration, any of these planar sheet materials may be flexible (bendable and/or rollable) (such as, but not limited to, sheet 500); and as such any of these planar sheet materials may be in curved configuration such as sleeve 300 is found curving on and around a given tire 100 curving around the curved exterior surfaces of that given tire 100.

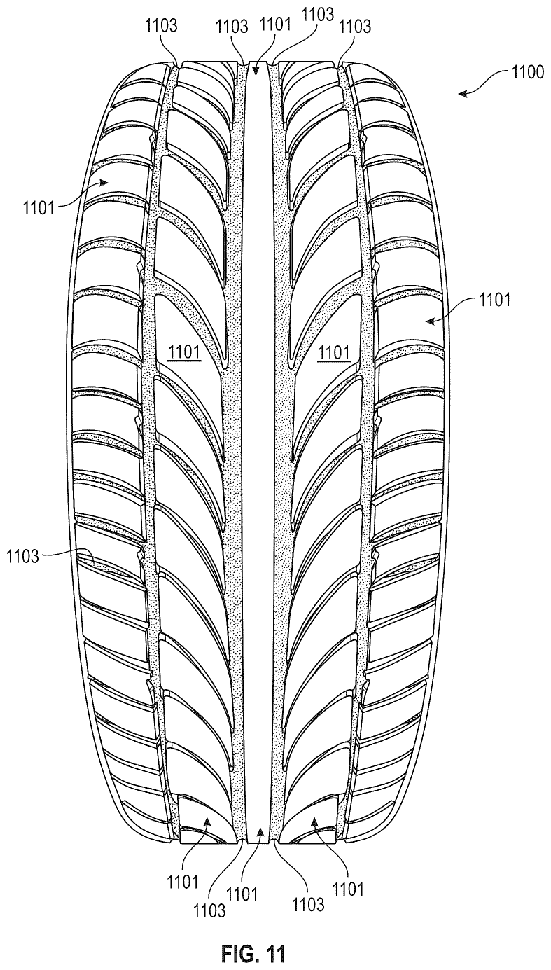

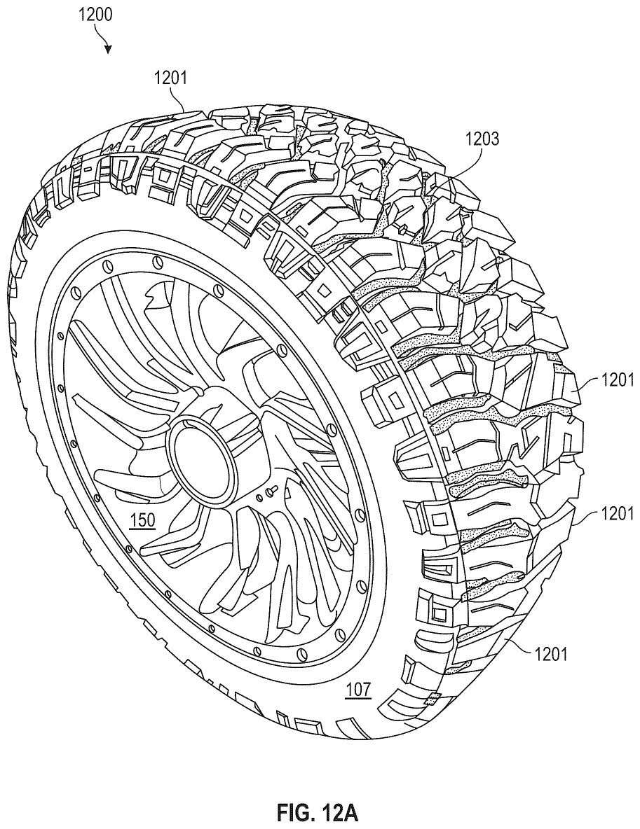

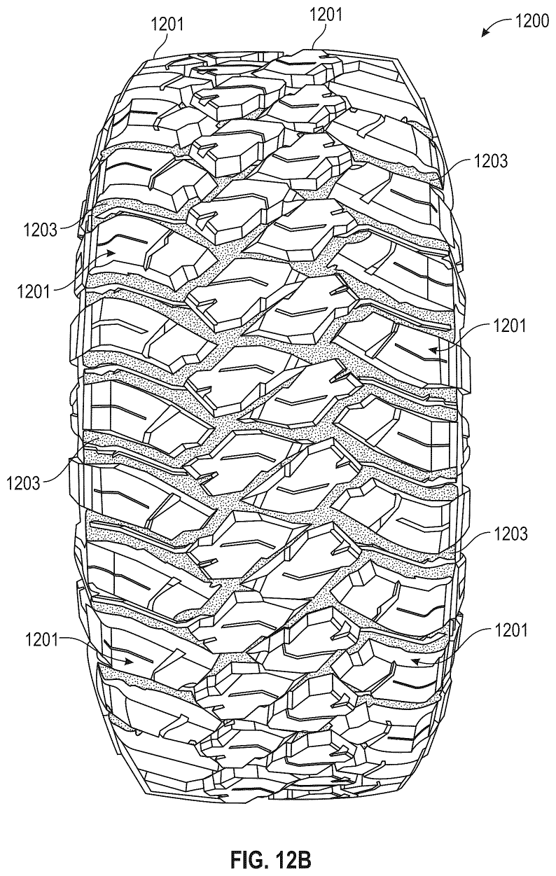

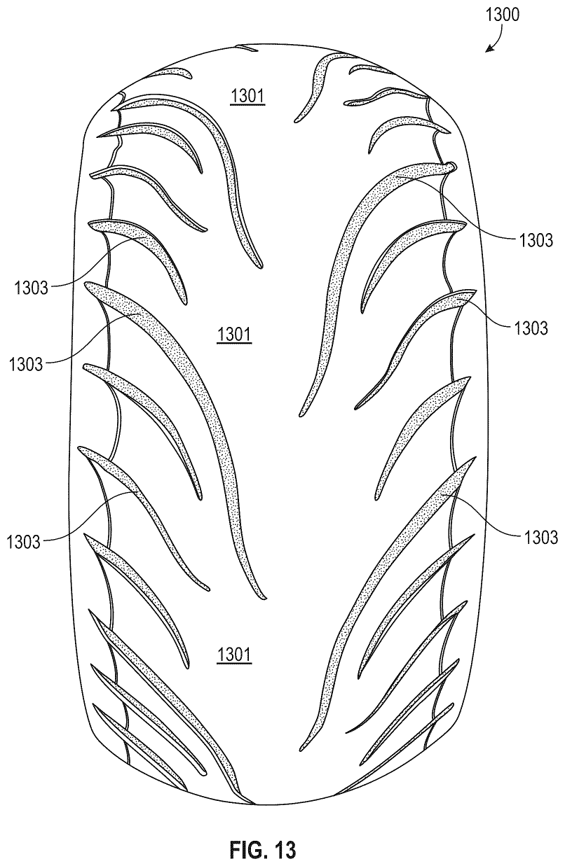

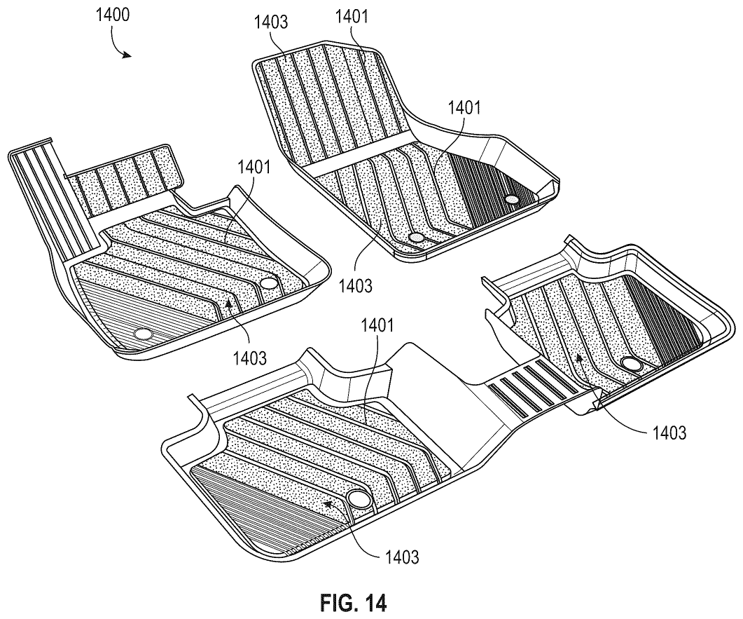

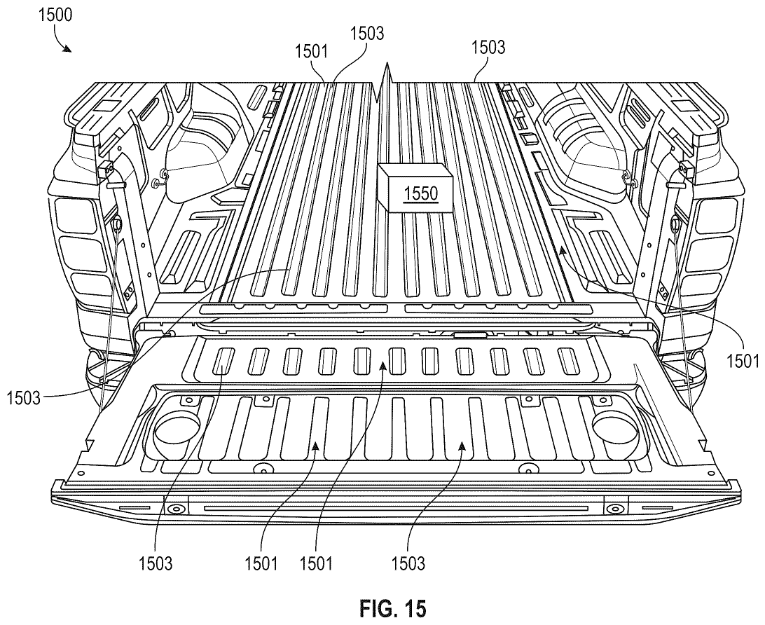

FIG. 8B may show an outer view of subassembly 800 being converted into (final) assembly 811 by use of removal machine 351 operating upon second-layer 805 to form tread 807 from second-layer 805, which also reveals portions of first-layer 803 by removal machine 351 removing material of second-layer 805 by cutting and/or routing such second-layer 805 material away from subassembly 800 to form assembly 811. In some embodiments, tread 807 may be raised textured portion(s) 807. In some embodiments, assembly 811 may comprise first-layer 803 and second-layer 805, wherein second-layer 805 may be configured as tread 807; and first-layer 803 may only be exteriorly visible because second-layer 805 material has been removed resulting in revealed first-layer 803 acting as recessed portion(s) and/or as groove(s) (channel(s)). In some embodiments, assembly 811 may also further comprise substrate 801 (as well as, first-layer 803 and second-layer 805, wherein second-layer 805 may be configured as tread 807). In some embodiments with respect to assembly 811, first-layer 803 may be disposed (directly) between substrate 801 and tread 807 (without any intervening materials located therebetween aside from glues, adhesives, and/or epoxies). In some embodiments, opposing surfaces of first-layer 803 may be in direct physical contact with substrate 801 and with tread 807, respectively (without any intervening materials located therebetween aside from glues, adhesives, and/or epoxies [when utilized]). In some embodiments, tread 807 may be tread 101 and/or raised-portion(s) 301. In some embodiments, tread 807 may be raised portion 703 of a sole 701 of a given article of footwear. In some embodiments, textured portion(s) 807 may be at least one of: raised-portion 1001, raised-portion (tread) 1101, raised-portion (tread) 1201, raised-portion (tread) 1301, raised-portion 1401, and/or raised-portion 1501 (see e.g., FIG. 10, FIG. 11, FIG. 12, FIG. 13, FIG. 14, and FIG. 15 respectively).

Continuing discussing FIG. 8B, in some embodiments, tread 807 (textured portion(s) 807) may be of the same color(s) and of the same material(s) type(s) of second-layer 805, as tread 807 (textured portion(s) 807) is made by cutting away material from second-layer 805 of subassembly 800 into a predetermined pattern. In some embodiments, first-layer 803 may be a different color from second-layer 805. In some embodiments, first-layer 803 may be a different color from tread 807 (textured portion(s) 807).

Continuing discussing FIG. 8B, in some embodiments, a color or colors of second-layer 805 may be different from a color or colors of first-layer 803. Thus, as removal machine 351 forms tread 807 (textured portion(s) 807), the formerly hidden color(s) of first-layer 803 are revealed (exposed) in the grooves, sipes, dimples and/or the like of tread 807 (textured portion(s) 807) when and where removal machine 351 cuts entirely through a depth of second-layer 805 and removes that material. In some embodiments, removal machine 351 may be setup and/or programmed to cut entirely through a depth of second-layer 805 when acting upon second-layer 805 in at least some locations of second-layer 805 to expose the immediate underlaying first-layer 803. Where removal machine 351 cuts entirely through the depth of second-layer 805, then first-layer 803 and its color(s) are revealed in such exposed locations on assembly 811.

Continuing discussing FIG. 8B, in some embodiments, removal machine 351 acting upon second-layer 805 to form tread 807(textured portion(s) 807), may occur before first-layer 803 is attached to substate 801, but after first-layer 803 is attached to second-layer 805. In some embodiments, removal machine 351 acting upon second-layer 805 to form tread 807 (textured portion(s) 807), may occur after first-layer 803 is attached to substate 801 and after first-layer 803 is attached to second-layer 805.

Thus, FIG. 8A and FIG. 8B, taken together may show how a given tire, the bottom of footwear, article 1000, tire 1100, tire 1200, tire 1300, floormat 1400, and/or liner 1500 may have at least two different predetermined color(s)-with respect to their raised portions versus their recessed portions.

FIG. 9A shows a perspective view of subassembly 900 both in an exploded (dissembled or pre-assembled) configuration and in an assembled configuration (shown side-by-side to each other). In some embodiments, subassembly 900 may comprise first-layer 803. In some embodiments, subassembly 900 may comprise substrate 801 and first-layer 803. In some embodiments, subassembly 900 may not include second-layer 805.

Further, while FIG. 9A shows substrate 801 and first-layer 803 as planar sheet materials in a generally flat configuration, any of these planar sheet materials may be flexible (bendable and/or rollable) (such as, but not limited to, sheet 500); and as such any of these planar sheet materials may be in curved configuration such as in article 300 found on a given tire 100 curving around the curved exterior surface(s) of that given tire 100.

Continuing discussing FIG. 9A, in some embodiments, enhancement and/or completion of the attachment (adhesion and/or welding) between first-layer 803 and substrate 801 may occur by placing such items within vacuum chamber 813 while a pressure within that vacuum chamber 813 may be maintained at less than the local (ambient) atmospheric pressure by virtue of vacuum pump 815 (or the like) that is operationally connected to vacuum chamber 813, for at least some minimal predetermined amount of time. The broken lines outlining a parallelogram in FIG. 9A may indicate a boundary of vacuum chamber 813. Note, in some embodiments, such a vacuum chamber 813 and/or vacuum pump 815 may not be used.

Continuing discussing FIG. 9A, in some embodiments, first-layer 803 may be a different color from substrate 801. In some embodiments, first-layer 803 may be a different color from tread 807. Note, tread 807 is not shown in FIG. 9A as tread 807 may not be part of subassembly 900 (in some embodiments); however, tread 807 may be shown in FIG. 9B where additive machine 351 may be laying down tread 807 on top of surface of first-layer 803. In some embodiments, a color or colors of substrate 801 may be different from a color or colors of first-layer 803. In some embodiments, a color or colors of tread 807 may be different from a color or colors of first-layer 803. Thus, as additive machine 351 adds material to form tread 807 onto the (top and/or exterior) surface of first-layer 803, at least two different colors become visible, at least one color of first-layer 803 (where not covered by tread 807) and at least one different color of tread 807. In some embodiments, additive machine 351 may be setup and/or programmed to add material onto (a top/exterior surface of) first-layer 803 to create tread 807 upon first-layer 803 in a particular and/or predetermined pattern. Where additive machine 351 does not entirely cover over a portion of first-layer 803, then at least two different colors of assembly 811 are revealed to an external observer.

Continuing discussing FIG. 9A, in some embodiments, additive machine 351 acting upon first-layer 803 to form tread 807 thereon, may occur before first-layer 803 is attached to substate 801. In some embodiments, additive machine 351 acting upon first-layer 803 to form tread 807 thereon, may occur after first-layer 803 is attached to substate 801.

FIG. 9B may show an outer view of subassembly 900 being converted into (final) assembly 911 by use of additive machine 351 (such as, but not limited to, a 3D printer) operating upon (top/exterior surface of) first-layer 803 to form tread 807 by additive machine 351 adding material on top of a surface of first-layer 803, in a predetermined pattern, to form tread 807 (textured raised portion 807) adhered (attached) to first-layer 803. In some embodiments, assembly 911 may comprise first-layer 803 and tread 807 (raised portion 807). In some embodiments, assembly 911 may also further comprise substrate 801 (as well as, first-layer 803 and tread 807 [raised portion 807]). In some embodiments, from a print head 354 or the like of additive machine 351, (hot, molten, liquid, gel, slurry, flowable, paste consistency like, flexible filament, and/or the like) material may be extruded onto a surface of first-layer 803 to form tread 807. In some embodiments, tread 807 (raised portion 807) may be attached (directly) to (a surface of) first-layer 803 by one or more of: glue, adhesive, epoxy, heat welding, ultrasonic welding, combinations thereof, and/or the like.

In some embodiments, with respect to assembly 911 in its assembled configuration, first-layer 803 may be located closer to substrate 801 as compared to tread 807 (raised portion 807), as such first-layer 803 may also be referred to as inner-layer 803. See e.g., FIG. 9B and FIG. 9A.

Thus, FIG. 9A and FIG. 9B, taken together may show how a given tire, tire 300, the bottom of footwear, article 1000, tire 1100, tire 1200, tire 1300, floormat 1400, and/or liner 1500 may have at least two different predetermined color(s)—with respect to their raised portions versus their recessed portions.

FIG. 10A shows a cross-section through a portion of a textured article 1000. In some embodiments, the portion of textured article 1000 shown in FIG. 10A may be a boundary region of textured article 1000 showing where textured article 1000 ends (terminates) and where the environmental region (non-textured article 1000 region) begins that may be exterior, separate, and distinct to textured article 1000. FIG. 10A shows exterior-environment 1013 outside of and exterior to the shown portion of textured article 1000. In some embodiments, exterior-environment 1013 may be external environment that is not part of textured article 1000. In some embodiments, textured article 1000 may be selected from: a tire, textured tire 300, textured tire 300b, textured-tire 300d (which may be made from a blank-tire 300c), a tire 1100, a tire 1200, a tire 1300, sole-of-footwear 701, a shoe, footwear, a bottom of a shoe, a bottom of footwear, a sole of a shoe, a floormat, a floormat 1400, a vehicle-liner 1500, a pickup truck bed liner, a truck bed liner, a coaster, a portion thereof, combinations thereof, and/or the like. In some embodiments, textured article 1000 may be an outputted end product arising from operation of removal machine 351 (or additive machine 351) and/or removal-element (tool-head) 352 upon an untextured precursor version of textured article 1000 to form the given textured article 1000. For example, and without limiting the scope of the present invention, when textured article 1000 may be a textured tire 300b and/or textured-tire 300d then the FIG. 10A article 1000 embodiment may be at least substantially similar to FIG. 3F and/or FIG. 3G. For example, and without limiting the scope of the present invention, when textured article 1000 may be a textured tire 300b and/or textured-tire 300d, then FIG. 10A may be showing an upper (or lower) portion of a given textured tire 300b and/or textured-tire 300d.

Continuing discussing FIG. 10A, in some embodiments, machine 351 and/or tool-head 352 acting upon an untextured blank may generate regions/portions of textured article 1000. In some embodiments formed regions/portions of textured article 1000 may comprise at least one raised-portion 1001 and/or at least one recessed-portion 1003. In some embodiments textured article 1000 may comprise exterior-surface 1011. In some embodiments, exterior-surface 1011 may be an exterior surface of textured article 1000. In some embodiments, an outside (facing) exterior perimeter surface of textured article 1000 may be exterior-surface 1011. In some embodiments, exterior-surface 1011 may be intended to come into direct physical contact with some aspect of the exterior-environment 1013. For example, and without limiting the scope of the present invention, when textured article 1000 may be a bottom of footwear, then exterior-surface 1011 may be intended and configured to come into periodic direct physical contact with the ground (e.g., when a person is walking). For example, and without limiting the scope of the present invention, when textured article 1000 may be a floormat, then exterior-surface 1011 may be intended and configured to come into periodic direct physical contact with a person's footwear (and/or foot) resting on top of that exterior-surface 1011 of the given floormat. For example, and without limiting the scope of the present invention, when textured article 1000 may be a truck or vehicle bed liner, then exterior-surface 1011 may be intended and configured to come into periodic direct physical contact with object(s) placed on top of that exterior-surface 1011 of the given truck or vehicle bed liner.

Continuing discussing FIG. 10A, in some embodiments, raised-portion 1001 may be a surface portion of textured article 1000 that is most exterior. In some embodiments, raised-portion 1001 may end (terminate) at portion(s) (region(s)) of exterior-surface 1011. For example, and without limiting the scope of the present invention, when textured article 1000 may be the exterior element of a tire, wherein exterior surfaces (exterior-surface 1011) of textured article 1000 are intended to come into regular periodic contact with a given road surface 190, then raised-portion (tread) 1001 may be a surface portion (exterior-surface 1011) that is intended to come into direct physical contact with the given road surface 190 under normal driving conditions. For example, and without limiting the scope of the present invention, when textured article 1000 may be a bottom of footwear, then raised-portion 1001 may be intended and configured to come into periodic direct physical contact with the ground (e.g., when a person is walking). For example, and without limiting the scope of the present invention, when textured article 1000 may be a floormat, then raised-portions 1001 may be intended and configured to come into periodic direct physical contact with a person's footwear (and/or foot) resting on top of those raised-portions 1001 of the given floormat. For example, and without limiting the scope of the present invention, when textured article 1000 may be a truck or vehicle bed liner, then raised-portions 1001 may be intended and configured to come into periodic direct physical contact with object(s) placed on top of those raised-portions 1001 of the given truck or vehicle bed liner.

Continuing discussing FIG. 10A, in some embodiments, recessed-portion 1003 may be a portion of textured article 1000 that is recessed (sunken and/or inset) away from a given (proximal and/or adjacent) raised-portion 1001 by at least some fixed distance of depth (such as depth-of-groove 1007). With respect to a cross-section through textured article 1000, in some embodiments, each given recessed-portion 1003 may be flanked by two opposing, separate, distinct, and adjacent raised-portions 1001. With respect to a cross-section through textured article 1000, in some embodiments, each given raised-portion 1001 may be flanked by at least one adjacent recessed-portion 1003. With respect to a cross-section through textured article 1000, in some embodiments, at least one raised-portion 1001 may be flanked by two opposing, separate, distinct, and adjacent recessed-portions 1003. In some embodiments, machine 351 may be programed to generate a completed textured article 1000 with a plurality of raised-portions 1001 and a plurality of recessed-portions 1003, that result in a predetermined and/or programmable pattern (texture). In some embodiments, depths, widths, heights, and/or the like of raised-portion(s) 1001 and/or of recessed-portion(s) 1003 may be determined by a program (e.g., computer program) that is configured to instruct machine 351. In some embodiments, depths, widths, heights, and/or the like of raised-portion(s) 1001 and/or of recessed-portion(s) 1003 may be uniform, constant, and/or non-variable with respect to each other. In some embodiments, at least some of the depths, the widths, the heights, and/or the like of raised-portion(s) 1001 and/or of recessed-portion(s) 1003 may be different, non-uniform, and/or variable with respect to each other (e.g., according to a specific computer program's instructions for operation of machine 351).

Continuing discussing FIG. 10A, in some embodiments, at least most (a majority) of material(s) of textured article 1000 (e.g., by mass and/or weight) may be region-of-first-color 1002. In some embodiments, region-of-first-color 1002 may be of at least one color. In some embodiments, region-of-first-color 1002 may be of at least one predetermined color. In some embodiments, region-of-first-color 1002 may be black. In some embodiments, region-of-first-color 1002 may be at least mostly (substantially) black. In some embodiments, all of textured article 1000 material(s) may be region-of-first-color 1002, except for region(s) of: region-of-second-color 1004, wear-depth-gauge 1005 (when present), a portion thereof, combinations thereof, and/or the like. In some embodiments, region-of-second-color 1004 and/or wear-depth-gauge 1005 (when present) may be of different color(s) as compared to color(s) of region-of-first-color 1002. In some embodiments, region-of-second-color 1004 and/or wear-depth-gauge 1005 (when present) may be of different color(s) or as same color(s) as compared to color(s) of region-of-first-color 1002.

Continuing discussing FIG. 10A, in some embodiments, textured article 1000 may comprise at least one region-of-second-color 1004. In some embodiments, textured article 1000 may comprise a plurality of regions-of-second-color 1004. In some embodiments, region-of-second-color 1004 may be located at a depth of a depth-of-groove 1007 from a reference point on a nearest exterior-surface 1011 portion of textured article 1000. In some embodiments, at least one recessed-portion 1003 (of a given textured article 1000) may distally terminate at a given region-of-second-color 1004, wherein the distal end of the given recessed-portion 1003 is disposed opposite from a nearest exterior-surface 1011 portion of textured article 1000. In some embodiments, each recessed-portion 1003 (of a textured article 1000) may distally terminate at a given region-of-second-color 1004, wherein the distal end of the given recessed-portion 1003 is disposed opposite from a nearest exterior-surface 1011 portion of textured article 1000. In some embodiments, region-of-second-color 1004 begins at depth-of-groove 1007 and where a given recessed-portion 1003 terminates away from a nearest exterior-surface 1011 portion of textured article 1000. In some embodiments, region-of-second-color 1004 may be located directly under a given recessed-portion 1003 and visually accessible from above (outside) that recessed-portion 1003. In some embodiments, region-of-second-color 1004 may not be located in nor directly under a given raised-portion 1001. In some embodiments, a given region-of-second-color 1004 may be a singular band that is (fixedly) embedded within a given untextured blank (that may be turned into textured article 1000). In some embodiments, a given region-of-second-color 1004 may only become visually accessible, once its associated (linked and/or paired) recessed-portion 1003 is formed. Operation of machine 351 and/or removal-element 352 upon a given untextured blank to yield textured article 1000, may visually uncover region(s)-of-second-color 1004 (e.g., within the distal bottoms at least some of the recessed-portion(s) 1003).

Continuing discussing FIG. 10A, in some embodiments, region-of-second-color 1004 may be of at least one color. In some embodiments, region-of-second-color 1004 may be of at least one predetermined color. In some embodiments, color(s) of region-of-second-color 1004 may be different from color(s) of region-of-first-color 1002. In some embodiments, color(s) of region-of-second-color 1004 may be different from color(s) of wear-depth-gauge 1005. In some embodiments, color(s) of region-of-second-color 1004 may be different from color(s) of region-of-first-color 1002 and/or different from color(s) of wear-depth-gauge 1005. In some embodiments, color(s) of region-of-second-color 1004 may be selected so as to be high-contrast with respect to color(s) of region-of-first-color 1002 and/or of wear-depth-gauge 1005.

Utilizing such a high-contrast colors scheme on footwear (e.g., when textured article 1000 may be at least a bottom portion of footwear) may increase the footwear's visibility with respect to external observers, such as, but not limited to, others and as such may contribute to pedestrian safety. For example, and without limiting the scope of the present invention, raised-portions 1001 (and region-of-first-color 1002) may be black, while region(s)-of-second-color 1004 (at the bottoms of the recessed-portions 1003) may be some bright color (such as, but not limited to, red, yellow, green, blue, white, or the like). Utilizing such a high-contrast colors scheme on floormats (e.g., when textured article 1000 may be a floormat) may help to indicate when the floormat is dirty, by the presence of accumulating dirt onto the bottoms of the recessed-portions 1003 which may be colored in a high contrast manner with respect to the raised-portions 1001. For example, and without limiting the scope of the present invention, raised-portions 1001 (and region-of-first-color 1002) may be black, while region(s)-of-second-color 1004 (at the bottoms of the recessed-portions 1003) may be some bright color (such as, but not limited to, red, yellow, green, blue, white, or the like). Utilizing such a high-contrast colors scheme on vehicle bed liners (e.g., when textured article 1000 may be a vehicle bed liner) may help to indicate when the vehicle bed liner is dirty, by the presence of accumulating dirt onto the bottoms of the recessed-portions 1003 which may be colored in a high contrast manner with respect to the raised-portions 1001. For example, and without limiting the scope of the present invention, raised-portions 1001 (and region-of-first-color 1002) may be black, while region(s)-of-second-color 1004 (at the bottoms of the recessed-portions 1003) may be some bright color (such as, but not limited to, red, yellow, green, blue, white, or the like).

(In some embodiments, color(s) of region-of-second-color 1004 may be different or the same as color(s) of: region-of-first-color 1002 and/or of wear-depth-gauge 1005.)

FIG. 10B shows a cross-section through a portion of a textured article 1000. FIG. 10B may be substantially similar to FIG. 10A, except FIG. 10B may include wear-depth-gauges 1005. In some embodiments, textured article 1000 (and/or the untextured blank that gives rise to textured article 1000) may comprise at least one region of wear-depth-gauge 1005. In some embodiments, wear-depth-gauge 1005 may be a wear down gauge, such that once the given raised-portion 1001 becomes sufficiently worn down, that its formerly encapsulated wear-depth-gauge 1005 becomes visually accessible, then an external observe will know by visual cue that the given textured article 1000 is ready for replacement. In some embodiments, textured article 1000 (and/or the untextured blank that gives rise to textured article 1000) may comprise a plurality of regions of wear-depth-gauge 1005. In some embodiments, wear-depth-gauge 1005 may be located at a depth of a depth-of-gauge 1009 from a reference point on a nearest exterior-surface 1011 portion of textured article 1000. In some embodiments, depth-of-groove 1007 and depth-of-gauge 1009 may both be fixed and finite depths extending into material(s) of textured article 1000, but of different depths. In some embodiments, depth-of-groove 1007 and depth-of-gauge 1009 may both be fixed and finite depths extending into textured article 1000 from a nearest exterior-surface 1011 portion, but of different depths. In some embodiments, depth-of-gauge 1009 may be shorter (shallower) than depth-of-groove 1007. In some embodiments, depth-of-groove 1007 may be associated with an initial (starting) depth of region-of-second-color 1004 (and/or a depth of recessed-portion 1003); whereas, depth-of-gauge 1009 may be associated with an initial (starting) depth of wear-depth-gauge 1005. In some embodiments, at least one raised-portion 1001 (of a given textured article 1000) may comprise within it a given wear-depth-gauge 1005 (at least when that given raised-portion 1001 is substantially unworn). In some embodiments, at least one raised-portion 1001 (of a given textured article 1000) may house and/or encapsulate within it a given wear-depth-gauge 1005 (at least when that given raised-portion 1001 is substantially unworn). In some embodiments, each raised-portion 1001 (of a given textured article 1000) may comprise within it a given wear-depth-gauge 1005. In some embodiments, each raised-portion 1001 (of a given textured article 1000) may house and/or encapsulate within each such raised-portion 1001 at least one wear-depth-gauge 1005 (at least when the given raised-portion 1001 is substantially unworn). In some embodiments, wear-depth-gauge 1005 begins at depth-of-gauge 1009. In some embodiments, wear-depth-gauge 1005 may be located directly under a given exterior-surface 1011 of a given raised-portion 1001; however, that wear-depth-gauge 1005 only become visually accessible from above (outside) once its associated (linked/paired) raised-portion 1001 has worn down to the depth-of-gauge 1009. In some embodiments, wear-depth-gauge 1005 may not be located in nor under a given recessed-portion 1003. In some embodiments, a given wear-depth-gauge 1005 may be a singular band that is (fixedly) embedded within a given textured article 1000 (when its associated linked/paired raised-portion 1001 is not substantially worn down/away). In some embodiments, a given wear-depth-gauge 1005 may be a singular band that is (fixedly) embedded within a given textured article 1000, beginning at depth-of-gauge 1009 and directly under exterior-surface 1011 of at least one raised-portion 1001.

Continuing discussing FIG. 10B, in some embodiments, wear-depth-gauge 1005 may be of at least one color. In some embodiments, wear-depth-gauge 1005 may be of at least one predetermined color. In some embodiments, color(s) of wear-depth-gauge 1005 may be different from color(s) of region-of-first-color 1002 and/or different from color(s) of region-of-second-color 1004. In some embodiments, color(s) of wear-depth-gauge 1005 may be selected so as to be high-contrast with respect to color(s) of region-of-first-color 1002 and/or with respect to color(s) of region(s)-of-second-color 1004. Utilizing such a high-contrast colors scheme on textured articles 1000 may increase a probability of discovering that a textured article 1000's raised-portion(s) 1001 have worn down to a point where textured article 1000 replacement may be desired. For example, and without limiting the scope of the present invention, raised-portions 1001 (and region-of-first-color 1002) may be black, while wear-depth-gauge 1005 may be some bright color (such as, but not limited to, red, yellow, green, blue, white, or the like). Some embodiments, of textured article 1000 may be with or without wear-depth-gauge(s) 1005.

(In some embodiments, color(s) of wear-depth-gauge 1005 may be different or the same as color(s) of: region-of-first-color 1002 and/or of region-of-second-color 1004.)

FIG. 10C shows a cross-sectional view through an upper portion of article 1000 with raised-portions 1001 and recessed-portions 1003. FIG. 10C may be similar to the FIG. 10B embodiment of article 1000; however, in FIG. 10C article 1000 may have embedded sheet(s) 1004 and/or 1005 of particular color(s) instead of using band(s) 1004 and/or 1005. In some embodiments, in the FIG. 10C embodiment of article 1000, region-of-color 1004 may be configured as a sheet (or as a layer) located at recessed-depth 1007 from exterior-surface 1011 (when raised-portions 1001 are at least substantially [mostly] unworn); and when raised-portions 1001 and recessed-portions 1003 are formed within that article 1000, then tops of region-of-color 1004, at bottoms of at least some of the recessed-portions 1003, may become visible to an observer that is external to article 1000; and region-of-color 1004 may appear as bands since portions of region-of-color 1004 may be covered entirely over by at least some of the raised-portions 1001. In some embodiments, in the FIG. 10C embodiment of article 1000, wear-depth-gauge 1005 may be configured as a sheet (or as a layer) located at depth 1009 from exterior-surface 1011 (when raised-portions 1001 are at least substantially [mostly] unworn); and when raised-portions 1001 and recessed-portions 1003 are formed within that article 1000, then wear-depth-gauge 1005 may appear as distinct bands within (embedded in) at least some of the raised-portions 1001 (because portions of wear-depth-gauge 1005 that had initially existed where recessed-portions 1003 get formed, get removed as the recessed-portions 1003 get formed, leaving wear-depth-gauge 1005 in a finalized band configuration).

FIG. 11 depicts a front view, a rear view, a top view, or a bottom view of a (vehicle) tire 1100, wherein its raised-portions (treads) 1101 are of a first-color and at least some of bottoms of its recessed-portions 1103 are of a second-color. In some embodiments, tire 1100 may be a passenger vehicle tire, a SUV tire, a car tire, a truck tire, a pickup truck tire, combinations thereof, and/or the like. In some embodiments, tire 1100 may be have been made, manufactured, and/or constructed by placing (elastic) band(s) 200 over recessed-portions 1103 that entirely circumscribe a circumference of tire 1100 and/or by placing uncured or flowable band material 200a into bottoms at least some of recessed-portions 1103, whether or not those recessed-portions 1103 circumscribe the circumference of tire 1100 (see e.g., FIG. 2A through FIG. 2G). In some embodiments, tire 1100 may be have been made, manufactured, and/or constructed by converting untextured blank tire 300a into textured tire 300b and/or by converting blank-tire 300c into textured-tire 300d (e.g., using machine 351 and/or tool-head 352); wherein textured tire 300b and/or textured-tire 300d may be tire 1100 (see e.g., FIG. 3A through FIG. 3P). In some embodiments, tire 1100 may be at least substantially similar to the same as textured tire 300b and/or textured-tire 300d. In some embodiments, raised-portions (treads) 1101 may be may be at least substantially similar to the same as raised-portions (treads) 301. In some embodiments, recessed-portions 1103 may be may be at least substantially similar to the same as recessed-portions 303. In some embodiments, tire 1100 may be have been made, manufactured, and/or constructed by converting a tire 100 into a textured and colored tire 300 using bath 400; wherein textured and colored tire 300 may be 1100 (see e.g., FIG. 4). In some embodiments, tire 1100 may be at least substantially similar to the same as textured and colored tire 300. In some embodiments, tire 1100 may be have been made, manufactured, and/or constructed by wrapping sheet (planar) material 500 around tire 100 to form a tire 300 and/or tire 1100, using heat source (heat means) 501, such that sheet (planar) material 500 welds onto tire 100 (see e.g., FIG. 5). In some embodiments, tire 1100 may be have been made, manufactured, and/or constructed by the processes of FIG. 8A and FIG. 8B. In some embodiments, tire 1100 may be have been made, manufactured, and/or constructed by the processes of FIG. 9A and FIG. 9B. In some embodiments, raised-portions (treads) 1101 may be at least substantially similar to the same as raised-portions 1001. In some embodiments, raised-portions (treads) 1101 may be have at least some of the same properties, functions, purposes, and/or relationships as raised-portions 1001. In some embodiments, recessed-portions 1103 may be at least substantially similar to the same as recessed-portions 1003. In some embodiments, recessed-portions 1103 may be have at least some of the same properties, functions, purposes, and/or relationships as recessed-portions 1003.

FIG. 12A depicts a perspective view of a (vehicle) tire 1200, wherein its raised-portions (treads) 1201 are of a first-color and at least some of bottoms of its recessed-portions 1203 are of a second-color. FIG. 12B depicts a front view, a rear view, a top view, or a bottom view of (vehicle) tire 1200. Tire 1200 may differ from tire 1100 in that in tire 1100 had four (4) separate and distinct recessed-portions 1103 of continuous channels that ran perfectly circular around the circumference of tire 1100; whereas, tire 1200 has no such continuous channels of recessed-portions 1203 that ran perfectly circular around a circumference of tire 1200. In some embodiments, tire 1200 may have custom tread pattern. In some embodiments, tire 1200 may be a truck tire, a pickup truck tire, a passenger vehicle tire, a SUV tire, a car tire, combinations thereof, and/or the like. In some embodiments, tire 1200 may be have been made, manufactured, and/or constructed by converting untextured blank tire 300a into textured tire 300b (e.g., using machine 351 and/or tool-head 352) or converting blank-tire 300c into textured-tire 300d; wherein textured tire 300b and/or textured-tire 300d may be tire 1200 (see e.g., FIG. 3A through FIG. 3P). In some embodiments, tire 1200 may be at least substantially similar to the same as textured tire 300b and/or textured-tire 300d. In some embodiments, raised-portions (treads) 1201 may be may be at least substantially similar to the same as raised-portions (treads) 301. In some embodiments, recessed-portions 1203 may be may be at least substantially similar to the same as recessed-portions 303. In some embodiments, tire 1200 may be have been made, manufactured, and/or constructed by converting a tire 100 into a textured and colored tire 300 using bath 400; wherein textured and colored tire 300 may be 1200 (see e.g., FIG. 4). In some embodiments, tire 1200 may be at least substantially similar to the same as textured and colored tire 300. In some embodiments, tire 1200 may be have been made, manufactured, and/or constructed by wrapping sheet (planar) material 500 around tire 100 to form a tire 300 and/or tire 1200, using heat source (heat means) 501, such that sheet (planar) material 500 welds onto tire 100 (see e.g., FIG. 5). In some embodiments, tire 1200 may be have been made, manufactured, and/or constructed by the processes of FIG. 8A and FIG. 8B. In some embodiments, tire 1200 may be have been made, manufactured, and/or constructed by the processes of FIG. 9A and FIG. 9B. In some embodiments, raised-portions (treads) 1201 may be at least substantially similar to the same as raised-portions 1001. In some embodiments, raised-portions (treads) 1201 may be have at least some of the same properties, functions, purposes, and/or relationships as raised-portions 1001. In some embodiments, recessed-portions 1203 may be at least substantially similar to the same as recessed-portions 1003. In some embodiments, recessed-portions 1203 may be have at least some of the same properties, functions, purposes, and/or relationships as recessed-portions 1003.

FIG. 13 depicts a front view, a rear view, a top view, or a bottom view of (motorcycle) tire 1300, wherein its raised-portions (treads) 1301 are of a first-color and at least some of bottoms of its recessed-portions 1303 are of a second-color. Tire 1300 may differ from tire 1100 in that in tire 1100 had four (4) separate and distinct recessed-portions 1103 of continuous channels that ran perfectly circular around the circumference of tire 1100; whereas, tire 1300 has no such continuous channels of recessed-portions 1303 that ran perfectly circular around a circumference of tire 1300. And in this respect tire 1300 may be more similar to tire 1200 than to tire 1100. Additionally, in some embodiments, tire 1300 may be a motorcycle tire. In some embodiments, tire 1300 may have custom tread pattern. In some embodiments, tire 1300 may be have been made, manufactured, and/or constructed by converting untextured blank tire 300a into textured tire 300b and/or converting blank-tire 300c into textured-tire 300d (e.g., using machine 351 and/or tool-head 352); wherein textured tire 300b and/or textured-tire 300d may be tire 1300 (see e.g., FIG. 3A through FIG. 3P). In some embodiments, tire 1300 may be at least substantially similar to the same as textured tire 300b and/or textured-tire 300d. In some embodiments, raised-portions (treads) 1301 may be may be at least substantially similar to the same as raised-portions (treads) 301. In some embodiments, recessed-portions 1303 may be may be at least substantially similar to the same as recessed-portions 303. In some embodiments, tire 1300 may be have been made, manufactured, and/or constructed by converting a tire 100 into a textured and colored tire 300 using bath 400; wherein textured and colored tire 300 may be 1300 (see e.g., FIG. 4). In some embodiments, tire 1300 may be at least substantially similar to the same as textured and colored tire 300. In some embodiments, tire 1300 may be have been made, manufactured, and/or constructed by wrapping sheet (planar) material 500 around tire 100 to form a tire 300 and/or tire 1300, using heat source (heat means) 501, such that sheet (planar) material 500 welds onto tire 100 (see e.g., FIG. 5). In some embodiments, tire 1300 may be have been made, manufactured, and/or constructed by the processes of FIG. 8A and FIG. 8B. In some embodiments, tire 1300 may be have been made, manufactured, and/or constructed by the processes of FIG. 9A and FIG. 9B. In some embodiments, raised-portions (treads) 1301 may be at least substantially similar to the same as raised-portions 1001. In some embodiments, raised-portions (treads) 1301 may be have at least some of the same properties, functions, purposes, and/or relationships as raised-portions 1001. In some embodiments, recessed-portions 1303 may be at least substantially similar to the same as recessed-portions 1003. In some embodiments, recessed-portions 1303 may be have at least some of the same properties, functions, purposes, and/or relationships as recessed-portions 1003.

In some embodiments, a given tire 300, tire 300b, textured-tire 300d, tire 1100, tire 1200, and/or tire 1300 may be for use on a given (motor) vehicle. In some embodiments, a given tire 300, tire 300b, textured-tire 300d, tire 1100, tire 1200, and/or tire 1300 may be a (motor) vehicle tire. In some embodiments, a given tire 300, tire 300b, textured-tire 300d, tire 1100, tire 1200, and/or tire 1300 may be configured for rolling locomotion use on a given vehicle. In some embodiments, a given tire 300, tire 300b, textured-tire 300d, tire 1100, tire 1200, and/or tire 1300 may be configured as a vehicle tire. In some embodiments, a given tire 300, tire 300b, textured-tire 300d, tire 1100, tire 1200, and/or tire 1300 may comprise a plurality of raised-portions 301, 1101, 1201, and/or 1301 and may also comprise a plurality of recessed-portions 303, 1103, 1203, and/or 1303. In some embodiments, the plurality of raised-portions 301, 1101, 1201, and/or 1301 may form the exterior most tread elements of that tire 300b, 300d, 1100, 1200, and/or 1300, such as, but not limited to, tread block(s) and/or tread rib(s). In some embodiments, a raised-portion 301, 1101, 1201, and/or 1301, selected from the plurality of raised-portions 301, 1101, 1201, and/or 1301, may be: a tread block, a tread rib, a portion thereof, combinations thereof, and/or the like. In some embodiments, (at least some of or at least most of) exterior-most surfaces of the plurality of raised-portions 301, 1101, 1201, and/or 1301 may be intended to come into periodic direct physical contact with a road surface 190 when that given tire 300, tire 300b, textured-tire 300d, tire 1100, tire 1200, and/or tire 1300 rolls as intended upon that road surface 190. In some embodiments, each recessed-portion 303, 1103, 1203, and/or 1303, selected from the plurality of recessed-portions 303, 1103, 1203, and/or 1303, may be directly adjacent to at least one raised-portion 301, 1101, 1201, and/or 1301, selected from the plurality of raised-portions 301, 1101, 1201, and/or 1301. In some embodiments, each recessed-portion 303, 1103, 1203, and/or 1303, selected from the plurality of recessed-portions 303, 1103, 1203, and/or 1303, may be recessed with respect to the exterior-most surfaces of the plurality of raised-portions 301, 1101, 1201, and/or 1301. In some embodiments, at least one recessed-portion 303, 1103, 1203, and/or 1303, selected from the plurality of recessed-portions 303, 1103, 1203, and/or 1303, may be at least one of: a groove, a sipe, a dimple, a portion thereof, combinations thereof, and/or the like. In some embodiments, each raised-portion 301, 1101, 1201, and/or 1301 selected from the plurality of raised-portions 301, 1101, 1201, and/or 1301 may be raised with respect to bottoms of the plurality of recessed-portions 303, 1103, 1203, and/or 1303. In some embodiments, (at least) upper regions of the plurality of raised-portions 301, 1101, 1201, and/or 1301 may be a first-color 302 (raised-portion color 302). In some embodiments, at least some (or at least most) of the bottoms of the plurality of recessed-portions 303, 1103, 1203, and/or 1303 may be a second-color 304 (color-of-bottom-of-recessed-portion 304). In some embodiments, the first-color 302 (raised-portion color 302) may be at least one predetermined color. In some embodiments, the second-color 304 (color-of-bottom-of-recessed-portion 304) may be at least one predetermined color. In some embodiments, the first-color 302 (raised-portion color 302) and the second-color 304 (color-of-bottom-of-recessed-portion 304) may be different colors from each other. See e.g., FIG. 3A to FIG. 3P, FIG. 11, FIG. 12, and FIG. 13.

In some embodiments, a given tire 300b, blank-tire 300c, textured-tire 300d, 1100, 1200, and/or 1300 may comprise at least one visual-tread-depth-gauge 305. In some embodiments, the visual-tread-depth-gauge 305 may be (fixedly) embedded within one or more raised-portions 301, 1101, 1201, and/or 1301, selected from the plurality of raised-portions 301, 1101, 1201, and/or 1301, at a first-depth 309 (depth-of-gauge 309) from the exterior-most surfaces of the plurality of raised-portions 301, 1101, 1201, and/or 1301. In some embodiments, the visual-tread-depth-gauge 305 may be a third-color (of the given tire and/or as compared to color 302 and color 304). In some embodiments, the first-depth 309 (depth-of-gauge 309) may be with respect to when the plurality of raised-portions 301, 1101, 1201, and/or 1301 are at least substantially (mostly) unworn (e.g., when the given tire 300b, 300d, 1100, 1200, and/or 1300 is new and/or unused). In some embodiments, when the plurality of raised-portions 301, 1101, 1201, and/or 1301 may be at least substantially (mostly) unworn, then the visual-tread-depth-gauge 305 may not be visible from an exterior of that given tire 300b, 300d, 1100, 1200, and/or 1300 (because that visual-tread-depth-gauge 305 may be [entirely] [fixedly] embedded withing at least one raised-portion 301, 1101, 1201, and/or 1301, selected from the plurality of raised-portions 301, 1101, 1201, and/or 1301). In some embodiments, the third-color (of the visual-tread-depth-gauge 305) may be different from: the first-color 302 (raised-portion color 302); the second-color 304 (color-of-bottom-of-recessed-portion 304); or both the first-color 302 (raised-portion color 302) and also different from the second-color 304 (color-of-bottom-of-recessed-portion 304). In some embodiments, the visual-tread-depth-gauge 305 may become visible when a height of the plurality of raised-portions 301, 1101, 1201, and/or 1301 wears down to the first-depth 309 (depth-of-gauge 309). In some embodiments, the at least some of the bottoms of the plurality of recessed-portions 303, 1103, 1203, and/or 1303 that are the second-color 304 (color-of-bottom-of-recessed-portion 304), may be located at a second-depth 307 (depth-of-groove 307) from the exterior-most surfaces of the plurality of raised-portions 301, 1101, 1201, and/or 1301. In some embodiments, the second-depth 307 (depth-of-groove 307) may be greater to or equal to the first-depth 309 (depth-of-gauge 309). In some embodiments, measurement and/or determination of the first-depth 309 (depth-of-gauge 309) may be with respect to when the plurality of raised-portions 301, 1101, 1201, and/or 1301 are at least substantially (mostly) unworn (such as, but not limited to, when the given tire 300b, 300d, 1100, 1200, and/or 1300 may be new and/or unused). In some embodiments, measurement and/or determination of the second-depth 307 (depth-of-groove 307) may be with respect to when the plurality of raised-portions 301, 1101, 1201, and/or 1301 are at least substantially (mostly) unworn. See e.g., FIG. 3G, FIG. 3H, FIG. 3I, FIG. 3J, FIG. 3K, FIG. 3L, FIG. 3M, and/or FIG. 3N for visual-tread-depth-gauge 305.

In some embodiments, color differences between the plurality of raised-portions 301, 1101, 1201, and/or 1301 and the plurality of recessed-portions 303, 1103, 1203, and/or 1303 of a given tire 300b, textured-tire 300d, tire 1100, tire 1200, and/or tire 1300 enhances and/or increases visibility of that given tire 300b, 300d, 1100, 1200, and/or 1300 because of the difference(s) in color(s). This enhanced and/or increased visibility of tire 300b, textured-tire 300d, tire 1100, tire 1200, and/or tire 1300, is further increased the more high contrast the color(s) difference(s) between color(s) of the plurality of raised-portions 301, 1101, 1201, and/or 1301 and the color(s) of the plurality of recessed-portions 303, 1103, 1203, and/or 1303. And that enhanced and/or increased visibility is a safety feature of tires 300b, textured-tires 300d, tires 1100, tires 1200, and/or tires 1300. In some embodiments, the first-color 302 (raised-portion color 302) and the second-color 304 (color-of-bottom-of-recessed-portion 304) are different colors from each other increases vehicle safety of a vehicle fitted with at least one such tire 300b, textured-tire 300d, tire 1100, tire 1200, and/or tire 1300, by that tire 300b, textured-tire 300d, tire 1100, tire 1200, and/or tire 1300 being easier to see by an external observer (such as, but not limited to, a person), as compared to a different-tire 100 where its raised-tread-elements and its grooves (including its grooves bottoms) of that different-tire 100 are all a same color.

In some embodiments, vehicles of a given fleet may use color-coded tires 300b, textured-tires 300d, tires 1100, tires 1200, and/or tires 1300. The fleet may be privately owned, government owned, or combinations thereof. In some embodiments, the at least one predetermined color of a given recessed-portions 303, 1103, 1203, and/or 1303 (and/or of raised-portions 301, 1101, 1201, and/or 1301) may be assigned (e.g., in a database or the like records keeping system) to at least one function of a vehicle-fleet-management-system. In some embodiments, the first-color 302 (raised-portion color 302) or the second-color 304 (color-of-bottom-of-recessed-portion 304) may be at least one predetermined color. In some embodiments, that at least one predetermined color of the given color-coded tire(s) 300b, textured-tire(s) 300d, tire(s) 1100, tire(s) 1200, and/or tire(s) 1300 may be assigned to at least one function of the vehicle-fleet-management-system. In some embodiments, that at least one function may be associated with a vehicle (of the fleet) that uses such color-coded tires 300b, textured-tires 300d, tires 1100, tires 1200, and/or tires 1300. In some embodiments, the at least one function may be correspond to at least one of: a job-site location (e.g., where that vehicle is to be driven to), a location (e.g., a location assigned to that vehicle), a driver (e.g., a driver assigned to that vehicle), a worker (e.g., a worker assigned to that vehicle), a user (e.g., a user assigned to that vehicle), a task (e.g., for a specific construction and/or maintenance task, a security task, a patrol task, etc.), a use (e.g., as transportation of a golf-cart for certain holes), a route (e.g., specific roads intended to be used), a portion thereof, combinations thereof, and/or the like. And thus, by merely observing the color-coded tires 300b, textured-tires 300d, tires 1100, tires 1200, and/or tires 1300 of a given vehicle, one (and/or a computing system) can know the at least one function for that vehicle in the given fleet.

In some embodiments, the second-color 304 (color-of-bottom-of-recessed-portion 304) may be formed by spraying, painting, and/or extruding a liquid (or flowable) form of the second-color 304 (color-of-bottom-of-recessed-portion 304) onto the at least some of the bottoms, of the plurality of recessed-portions 303, 1103, 1203, and/or 1303, that dries in place as the solidified and/or finalized second-color 304 (color-of-bottom-of-recessed-portion 304).

In some embodiments, tire-band 200, sleeve 300, sleeve 300a, textured sleeve 300b, tire-blank 300c, textured-tire 300d, article 1000, tire 1100, tire 1200, tire 1300, a portion thereof, combinations thereof, and/or the like, may be made by/from at least one of: casting, molding, injection molding, CNC machining, 3D printing, machining operations, heating operations, welding operations, annealing operations, vacuum operations, extrusion, a portion thereof, combinations thereof, and/or the like.

In some embodiments, tire-band 200, sleeve 300, sleeve 300a, textured sleeve 300b, tire-blank 300c, textured-tire 300d, article 1000, tire 1100, tire 1200, tire 1300, a portion thereof, combinations thereof, and/or the like, are not configured for nor intended for retreading applications. In some embodiments, band 200 (tire-band 200) when fitted to a given tire 100, is not for retreading applications nor tread applications. In some embodiments, band 200 (tire-band 200) when fitted to a given tire 100, is not configured for retreading applications nor tread applications. In some embodiments, band 200 (tire-band 200) when fitted to a given tire 100, does not cover over raised-portion(s) and/or tread 101 elements of that given tire 100. In some embodiments, band 200 (tire-band 200) when fitted to a given tire 100, is not configured to cover over raised-portion(s) and/or tread 101 elements of that given tire 100. In some embodiments, band 200 (tire-band 200) when fitted to a given tire 100, may fit and/or reside entirely within a given groove 103 of that given tire 100.

In some embodiments, tire-band 200, sleeve 300, sleeve 300a, textured sleeve 300b, tire-blank 300c, textured-tire 300d, article 1000, tire 1100, tire 1200, tire 1300, a portion thereof, combinations thereof, and/or the like, may be configured for and/or intended for retreading applications and/or for providing traction with (against) road surfaces 190.

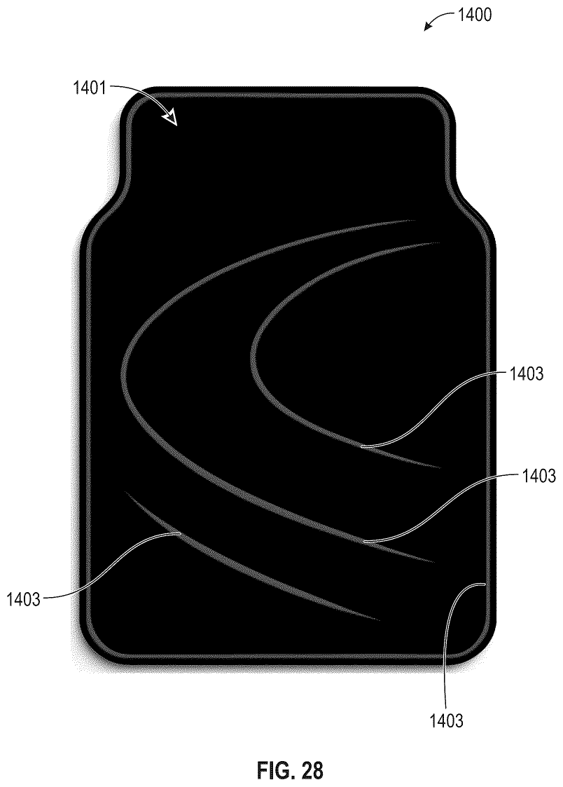

FIG. 14 depicts a top perspective view of a set of vehicle floormats 1400, wherein its raised-portions 1401 are of a first-color and at least some of bottoms of its recessed-portions 1403 are of a second-color. In some embodiments, floormat(s) 1400 may have a custom pattern with respect to its raised-portions 1401 and its recessed-portions 1403. In some embodiments, floormat 1400 may be made from one or more: plastics, foams, polymers, elastomers, rubber(s), silicone(s), a portion thereof, combinations thereof, and/or the like. In some embodiments, floormat(s) 1400 may be have been made, manufactured, and/or constructed in a similar manner as by converting blank-tire 300c into textured-tire 300d (e.g., using machine 351 and/or tool-head 352 onto a blank untextured floormat to generate a textured floormat 1400). In some embodiments, floormat(s) 1400 may be have been made, manufactured, and/or constructed in a similar manner as by converting a tire 100 into a textured and colored tire 300 using bath 400 (e.g., by dipping a precursor floormat [with some preexisting texture] into a bath 400). In some embodiments, floormat(s) 1400 may be have been made, manufactured, and/or constructed by the processes of FIG. 8A and FIG. 8B. In some embodiments, floormat(s) 1400 may be have been made, manufactured, and/or constructed by the processes of FIG. 9A and FIG. 9B. In some embodiments, raised-portions 1401 may be at least substantially similar to the same as raised-portions 1001. In some embodiments, raised-portions 1401 may be have at least some of the same properties, functions, purposes, and/or relationships as raised-portions 1001. In some embodiments, recessed-portions 1403 may be at least substantially similar to the same as recessed-portions 1003. In some embodiments, recessed-portions 1403 may be have at least some of the same properties, functions, purposes, and/or relationships as recessed-portions 1003. See e.g., FIG. 28 for a color photograph of floormat 1400 with different colored recessed-portions versus color of the raised-portions.

In some embodiments, floormat 1400 may comprise a plurality of raised-portions 1401/1001 and a plurality of recessed-portions 1403/1003. In some embodiments, exterior-most surfaces 1011 of the plurality of raised-portions 1401/1001 may be configured to come into removable direct physical contact with footwear or a foot when the footwear or the foot may be removably placed on top of the floormat 1400. In some embodiments, each recessed-portion 1403/1003, selected from the plurality of recessed-portions 1403/1003, may be directly adjacent to at least one raised-portion 1401/1001, selected from the plurality of raised-portions 1401/1001. In some embodiments, at least some areas of a given recessed-portion 1403/1003 may also come into removable direct physical contact with footwear or a foot (e.g., depending upon how widely spaced apart adjacent raised-portions 1401/1001 may be to each other). In some embodiments, each recessed-portion 1403/1003, selected from the plurality of recessed-portions 1403/1003, may be recessed with respect to the exterior-most surfaces 1011 of the plurality of raised-portions 1401/1001. In some embodiments, each raised-portion 1401/1001, selected from the plurality of raised-portions 1401/1001, may be raised with respect to bottoms of the plurality of recessed-portions 1403/1003. In some embodiments, at least some upper regions of the plurality of raised-portions 1401/1001 may be a first-color 1002 (color-of-raised-portion 1002). In some embodiments, at least some of the bottoms of the plurality of recessed-portions 1403/1003 may be a second-color 1004 (color-of-recessed-bottom 1004). In some embodiments, the first-color 1002 (color-of-raised-portion 1002) and the second-color 1004 (color-of-recessed-bottom 1004) may be different colors from each other. In some embodiments, floormat 1400 may be configured for use in a vehicle. In some embodiments, floormat 1400 may be configured to at least partially cover over and rest on top of at least some floor portions of the given vehicle. In some embodiments, floormat 1400 may be a vehicle-floormat. See e.g., FIG. 10A, FIG. 10B, FIG. 10C, and FIG. 14.

In some embodiments, floormat 1400 may comprises a visual-wear-depth-gauge 1005. In some embodiments, the visual-wear-depth-gauge may be (fixedly) (at least partially to totally entirely) embedded within one or more raised-portions 1401/1001, selected from the plurality of raised-portions 1401/1001, at a first-depth 1009 (depth-of-gauge 1009) from the exterior-most surfaces 1011 of the plurality of raised-portions 1401/1001. In some embodiments, the visual-wear-depth-gauge 1005 may be a third-color (as compared to color 1002 and/or color 1004). In some embodiments, the first-depth 1009 (depth-of-gauge 1009) may be with respect to when the plurality of raised-portions 1401/1001 may be at least substantially (mostly) unworn. In some embodiments, when the plurality of raised-portions 1401/1001 may be at least substantially (mostly) unworn, then the visual-wear-depth-gauge 1005 may not be visible from an exterior of the floormat 1400. In some embodiments, the third-color (of the visual-wear-depth-gauge 1005) may be different from: the second-color 1004 (color-of-recessed-bottom 1004); the first-color 1002 (color-of-raised-portion 1002); or both the first-color 1002 (color-of-raised-portion 1002) and the second-color 1004 (color-of-recessed-bottom 1004). In some embodiments, the visual-wear-depth-gauge 1005 becomes visible when a height of the plurality of raised-portions 1401/1001 wears down to the first-depth 1009 (depth-of-gauge 1009). See e.g., FIG. 10B and FIG. 10C.

In some embodiments, with respect to floormat 1400, the at least some of the bottoms of the plurality of recessed-portions 1403/1003 that may be the second-color 1004 (color-of-recessed-bottom 1004), may be located at a second-depth 1007 (recessed-depth 1007) from the exterior-most surfaces 1011 of the plurality of raised-portions 1401/1001. In some embodiments, the second-depth 1007 (recessed-depth 1007) may be greater to or equal to the first-depth 1009 (depth-of-gauge 1009). In some embodiments, the second-depth 1007 (recessed-depth 1007) may be greater to the first-depth 1009 (depth-of-gauge 1009). In some embodiments, the second-depth 1007 (recessed-depth 1007) may be greater to the first-depth 1009 (depth-of-gauge 1009) when the plurality of raised-portions 1403/1001 are at least substantially (mostly) unworn. In some embodiments, the second-depth 1007 (recessed-depth 1007) may be with respect to when the plurality of raised-portions 1401/1001 may be at least substantially (mostly) unworn. See e.g., FIG. 10B and FIG. 10C.

In some embodiments, with respect to floormat 1400, the first-color 1002 (color-of-raised-portion 1002) and the second-color 1004 (color-of-recessed-bottom 1004) are different colors from each other functions as an indicator of cleanliness or dirtiness of the floormat 1400, as compared to a different-floormat where its raised-elements and its recessed-elements of the different-floormat are all at least substantially (mostly) a same color. When the raised-elements and the recessed-elements of the different-floormat are all at least substantially (mostly) a same color, such as, but not limited to, a dark color (e.g., black), it is generally difficult to tell when that different-floormat is dirty. Whereas, when the first-color 1002 (color-of-raised-portion 1002) and the second-color 1004 (color-of-recessed-bottom 1004) are different colors from each other, then dirt on that floormat 1400 may become more visible and thus easer for one to tell when that particular floormat 1400 may be dirty or clean.

In some embodiments, with respect to floormat 1400, the second-color 1004 (color-of-recessed-bottom 1004) may be formed by spraying a liquid form of the second-color 1004 (color-of-recessed-bottom 1004) onto the at least some of the bottoms, of the plurality of recessed-portions 1403/1003, that dries and/or cures in place as the finished (cured) second-color 1004 (color-of-recessed-bottom 1004). In some embodiments, the second-color 1004 (color-of-recessed-bottom 1004) may be formed by painting a liquid form of the second-color 1004 (color-of-recessed-bottom 1004) onto the at least some of the bottoms, of the plurality of recessed-portions 1403/1003, that dries and/or cures in place as the finished (cured) second-color 1004 (color-of-recessed-bottom 1004). In some embodiments, the second-color 1004 (color-of-recessed-bottom 1004) may be formed by extruding a liquid form of the second-color 1004 (color-of-recessed-bottom 1004) onto the at least some of the bottoms, of the plurality of recessed-portions 1403/1003, that dries and/or cures in place as the finished (cured) second-color 1004 (color-of-recessed-bottom 1004).

In some embodiments, the recessed-portions 1403/1003 of floormat 1400 and/or of article 1000 may be configured and/or may function to receive, trap, and/or hold dirt and/or debris. In some embodiments, the raised-portions 1401/1001 of floormat 1400 and/or of article 1000 may be configured and/or may function to be at least mostly (substantially) free of dirt and/or debris (e.g., as the dirt and/or debris may easily slip and/or fall off into adjacent, proximate, and/or nearby recessed-portions 1403/1003). In some embodiments, located at least partially around a perimeter of floormat 1400 and/or of article 1000 may be at least one recessed-portion (channel/grove) 1403/1003 (see e.g., FIG. 28). In some embodiments, floormat 1400 and/or article 1000 may be without carpet pile, carpet, textile, fabric, and/or yarn. In some embodiments, a vehicle-liner 1500 may be a type and/or an example of a floormat 1400.

In some embodiments, article 1000, floormat 1400, a portion thereof, combinations thereof, and/or the like, may be made at least mostly (substantially) from at least one of the following materials of construction: a plastic, a thermoplastic, a polymer, vinyl, polypropylene, nitrile (NBR), SBR (styrene butadiene rubber), EPDM (ethylene propylene diene monomer), neoprene (rubber), silicone (rubber), vulcanized rubber, polyurethane, polyurethane bonded rubber, recycled rubber, foam rubber, extruded rubber, natural rubber, synthetic rubber, an elastomer, leather, faux leather, a fungus, a fungal growth, a foam thereof, a sheet thereof, a roll thereof, a laminate thereof, any other material suitable for a floormat, a chemical composition per material manufacturer/supplier that is intended for use as a floormat, a portion thereof, combinations thereof, and/or the like.

In some embodiments, article 1000, floormat 1400, a portion thereof, combinations thereof, and/or the like, may be made by/from at least one of: casting, molding, injection molding, CNC machining, 3D printing, machining operations, heating operations, welding operations, annealing operations, vacuum operations, extrusion, a portion thereof, combinations thereof, and/or the like.

FIG. 15 depicts a top perspective view of a portion of a vehicle-liner 1500, wherein its raised-portions 1501 are of a first-color and at least some of bottoms of its recessed-portions 1503 are of a second-color. In some embodiments, vehicle-liner 1500 may have a custom and/or a predetermined pattern with respect to its raised-portions 1501 and its recessed-portions 1503. In some embodiments, vehicle-liner 1500 may be a truck bed liner, a pickup truck bedliner, a trunk liner, a frunk liner, a portion thereof, combinations thereof, and/or the like. In some embodiments, vehicle-liner 1500 may be made from one or more: plastics, foams, polymers, elastomers, rubber(s), silicone(s), a portion thereof, combinations thereof, and/or the like. In some embodiments, vehicle-liner 1500 may be have been made, manufactured, and/or constructed in a similar manner as by converting blank-tire 300c into textured-tire 300d (e.g., using machine 351 and/or tool-head 352 onto a blank untextured bedliner to generate a textured vehicle-liner 1500). In some embodiments, vehicle-liner 1500 may be have been made, manufactured, and/or constructed in a similar manner as by converting a tire 100 into a textured and colored tire 300 using bath 400 (e.g., by dipping a precursor bedliner [with some preexisting texture] into a bath 400). In some embodiments, vehicle-liner 1500 may be have been made, manufactured, and/or constructed by the processes of FIG. 8A and FIG. 8B. In some embodiments, vehicle-liner 1500 may be have been made, manufactured, and/or constructed by the processes of FIG. 9A and FIG. 9B. In some embodiments, raised-portions 1501 may be at least substantially similar to the same as raised-portions 1001. In some embodiments, raised-portions 1501 may be have at least some of the same properties, functions, purposes, and/or relationships as raised-portions 1001. In some embodiments, recessed-portions 1503 may be at least substantially similar to the same as recessed-portions 1003. In some embodiments, recessed-portions 1503 may be have at least some of the same properties, functions, purposes, and/or relationships as recessed-portions 1003.

In some embodiments, the vehicle-liner 1500 may be configured to at least partially line (e.g., cover over a bottom surface) a section of a vehicle, wherein the section of the vehicle may be selected from: a trunk, a boot, a frunk, a cargo area, a rear compartment, a region below a hatchback, a bed of the vehicle, a pickup truck bed, a truck bed, a portion thereof, combinations thereof, and/or the like. In some embodiments, the vehicle-liner 1500 may be a liner of a bed of a truck. In some embodiments, the vehicle-liner 1500 may be a liner of a bed of a pickup truck. See e.g., FIG. 10A, FIG. 10B, FIG. 10C, and FIG. 15.

In some embodiments, vehicle-liner 1500 may comprise a plurality of raised-portions 1501/1001 and a plurality of recessed-portions 1503/1003. In some embodiments, exterior-most surfaces 1011 of the plurality of raised-portions 1501/1001 may be configured to come into removable direct physical contact with cargo 1550 placed on top of the vehicle-liner 1500. In some embodiments, each recessed-portion 1503/1003, selected from the plurality of recessed-portions 1503/1003, may be directly adjacent to at least one raised-portion 1501 / 1001, selected from the plurality of raised-portions 1501/1001. In some embodiments, each recessed-portion 1503/1003, selected from the plurality of recessed-portions 1503/1003, may be recessed with respect to the exterior-most surfaces 1011 of the plurality of raised-portions 1501/1001. In some embodiments, each raised-portion 1501/1001, selected from the plurality of raised-portions 1501/1001, may be raised with respect to bottoms of the plurality of recessed-portions 1503/1003. In some embodiments, at least some of the upper regions of the plurality of raised-portions 1501/1001 may be a first-color 1002 (e.g., an upper most color). In some embodiments, at least some of the bottoms of the plurality of recessed-portions 1503/1003 may be a second-color 1004 (e.g., a recessed-color 1004). In some embodiments, the first-color 1002 and the second-color 1004 may be different colors from each other. See e.g., FIG. 10A, FIG. 10B, FIG. 10C, and FIG. 15.

In some embodiments, the vehicle-liner 1500 may comprise a visual-wear-depth-gauge 1005. In some embodiments, the visual-wear-depth-gauge 1005 may be (fixedly) (entirely) embedded within one or more raised-portions 1501/1001, selected from the plurality of raised-portions 1501/1001, at a first-depth 1009 (gauge depth 1009) from the exterior-most surfaces 1011 of the plurality of raised-portions 1501/1001. In some embodiments, the visual-wear-depth-gauge 1005 may be a third-color 1005 (e.g., as compared against a first-color 1002 of at least some of the upper regions of the plurality of raised-portions 1501/1001 may and as compared to a second-color 1004 of at least some of the bottoms of the plurality of recessed-portions 1503/1003). In some embodiments, the first-depth 1009 (gauge depth 1009) may be with respect to when the plurality of raised-portions 1501/1001 may be at least substantially (mostly) unworn. In some embodiments, when the plurality of raised-portions 1501/1001 may be at least substantially unworn, then the visual-wear-depth-gauge 1005 may not be visible from an exterior of the vehicle-liner 1500. In some embodiments, the third-color may be different from: the second-color 1004; the first-color 1002; or both the first-color 1002 and the second-color 1004. In some embodiments, the visual-wear-depth-gauge 1005 becomes visible when a height of the plurality of raised-portions 1501/1001 wears down to the first-depth 1009 (gauge depth 1009). See e.g., FIG. 10B and FIG. 10C.

In some embodiments, the at least some of the bottoms of the plurality of recessed-portions 1503/1003 may be located at a second-depth 1007 (recessed-depth 1007) from the exterior-most surfaces 1011 of the plurality of raised-portions 1501/1001. In some embodiments, the second-depth 1007 (recessed-depth 1007) may be with respect to when the plurality of raised-portions 1501/1001 may be at least substantially (mostly) unworn. In some embodiments, the second-depth 1007 (recessed-depth 1007) may be from exterior-most surfaces 1011 (of the plurality of raised-portions 1501/1001) to at least some of the bottoms of the plurality of recessed-portions 1503/1003. In some embodiments, the second-depth 1007 (recessed-depth 1007) may be greater to the first-depth 1009 (gauge depth 1009). In some embodiments, the second-depth 1007 (recessed-depth 1007) may be greater to or equal to the first-depth 1009 (gauge depth 1009). See e.g., FIG. 10A, FIG. 10B and FIG. 10C.

In some embodiments, with respect to vehicle-liner 1500, the first-color 1002 and the second-color 1004 may be different colors from each other; wherein such different coloring functions as an indicator of cleanliness or dirtiness of the vehicle-liner 1500, as compared to a different-vehicle-liner where its raised-elements and its recessed-elements (and/or the bottoms of its recessed-elements) of the different-vehicle-liner are all at least substantially (mostly) a same color. When at least some of the upper raised-portions 1001 are a different color from at least some of bottoms of recessed-portions 1003, that difference in coloring makes it easier for debris and dirt laying on top of that vehicle-liner 1500 to become visible; thus, this coloring difference serves as indicator of cleanliness or dirtiness of the vehicle-liner 1500. And this indicator of cleanliness or dirtiness may be further enhanced the more different those colors are, i.e., the more high contrast those different colors may be from each other.

In some embodiments, with respect to vehicle-liner 1500, the second-color 1004 may be formed by spraying a liquid form of the second-color 1004 onto the at least some of the bottoms, of the plurality of recessed-portions 1503/1003, that dries and/or cures in place as the finished, finalized, and cured second-color 1004. In some embodiments, the second-color 1004 may be formed by painting a liquid form of the second-color 1004 onto the at least some of the bottoms, of the plurality of recessed-portions 1503/1003, that dries and/or cures in place as the finished, finalized, and cured second-color 1004. In some embodiments, the second-color 1004 may be formed by extruding a liquid (or flowable) form of the second-color 1004 onto the at least some of the bottoms, of the plurality of recessed-portions 1503/1003, that dries and/or cures in place as the finished, finalized, and cured second-color 1004. In some embodiments, extrusions of flowable forms discussed and noted herein may be carried out by gun 251 and/or the like.

In some embodiments, article 1000, vehicle-liner 1500, a portion thereof, combinations thereof, and/or the like, may be made by/from at least one of: casting, molding, injection molding, CNC machining, 3D printing, machining operations, heating operations, welding operations, annealing operations, vacuum operations, extrusion, a portion thereof, combinations thereof, and/or the like.

FIG. 16 depicts a machine 351 or a portion thereof. In some embodiments, machine 351 may comprise one or more: rails, gantries, stepper motors, actuators, pistons, sensors, tool-heads 352, print-heads 354, a portion thereof, combinations thereof, and/or the like.

FIG. 17 depicts machine 351 or a portion thereof. In some embodiments, machine 351 may comprise a robotic arm. In some embodiments, attached to a distal (terminal) portion of that robotic arm may be tool-head 352 and/or print-head 354. In some embodiments, that robotic arm may be configured for up to six (6) degrees of motion (or freedom of motion). FIG. 17 also shows support-for-article 1701, which may be configured to support, fix, hold, and/or retain article 1000 while machine 351 works upon that article 1000. In some embodiments, clamps, vacuum, and/or the like may be used to temporarily fix article 1000 to support-for-article 1701. In some embodiments, support-for-article 1701 may have means to move and/or articulate article 1000. In some embodiments, support-for-article 1701 may be controlled and/or operated, at least in part, by machine 351. In some embodiments, machine 351 may comprise support-for-article 1701.

In some embodiments, machine 351 may be selected from one or more preexisting CNC machines, lathes, mills, and/or 3D printers. In some embodiments, tool-head 352 and/or print-head 354 may be selected from one or more preexisting tool-heads and/or print-heads that are used on preexisting CNC machines, lathes, mills, and/or 3D printers. CNC machines, lathes, mills, 3D printers, tools thereof, accessories thereof, portions thereof, combinations thereof, and/or the like are preexisting machines that exist and are used in numerous manufacturing capacities, from hobby levels, to commercial and/or industrial machines. CNC machines, lathes, mills, 3D printers, tools thereof, accessories thereof, portions thereof, combinations thereof, and/or the like are well understood in the relevant industries. The teachings of such preexisting CNC machines, lathes, mills, 3D printers, tools thereof, accessories thereof, portions thereof, combinations thereof, and/or the like are incorporated by reference herein as is fully set forth herein. See e.g., FIG. 16 and/or FIG. 17.

In some embodiments, a given textured-tire 300b and/or 300d may begin as a slick 300a and/or as a blank-tire 300c, without any treads. In some embodiments, slick 300a and/or blank-tire 300c may be mounted to a support 1701, a mandril, a wheel 150, and/or the like. In some embodiments, the support 1701, the mandril, the wheel 150, and/or the like may be provided with a rotational (spinning) means. In some embodiments, as the support 1701, the mandril, wheel 150, and/or the like-with its (removably) attached slick 300a and/or blank-tire 300c-rotates, machine 351 may generate treads thereon (e.g., may generated raised-portions 301 and recessed-portions 303, at least some of which may be present on sidewall(s) 371 in some embodiments). In some embodiments, machine 351 may use tool-head 352 for generating such treads and/or raised-portions 301 and recessed-portions 303 in a given slick 300a and/or blank-tire 300c to generate textured-tire 300b and/or 300d. In some embodiments, tool-head 352 may be heated, vibrated, reciprocating, rotating, spinning, combinations thereof, and/or the like. In some embodiments, tool-head 352 may move around given slick 300a and/or blank-tire 300c when acting upon the given slick 300a and/or blank-tire 300c, and whether or not the given slick 300a and/or blank-tire 300c may be rotating.

In some embodiments, treads (e.g., raised-portions 301 and recessed-portions 303) may be formed first in the given slick 300a and/or blank-tire 300c, and/or outermost layer 805, before slick 300a, blank-tire 300c, and/or outermost layer 805 are attached (fused, bonded) onto: an untreaded tire, a tire carcass, and/or the like to form (generate) a finished (finalized) textured-tire 300b and/or 300d.

In some embodiments, during machine 351 operations upon slick 300a and/or blank-tire 300c, at least one of the following may be stationary: machine 351, tool-head 352, 3D printer head 354, the support 1701, the mandril, wheel 150, slick 300a, blank-tire 300c, textured-tire 300b, textured-tire 300d, a portion thereof, combinations thereof, and/or the like. In some embodiments, during machine 351 operations upon slick 300a and/or blank-tire 300c, at least one of the following may be in motion: machine 351, tool-head 352, 3D printer head 354, the support 1701, the mandril, wheel 150, slick 300a, blank-tire 300c, textured-tire 300b, textured-tire 300d, a portion thereof, combinations thereof, and/or the like. In some embodiments, during machine 351 operations upon slick 300a and/or blank-tire 300c, any of the following may be moving and/or in motion: machine 351, tool-head 352, 3D printer head 354, the support 1701, the mandril, wheel 150, slick 300a, blank-tire 300c, textured-tire 300b, textured-tire 300d, a portion thereof, combinations thereof, and/or the like. In some embodiments, movements and/or articulations of 3D printer head 354 may be at least the same as for tool-head 352. In some embodiments, tool-head 352 and/or 3D printer head 354 may be capable of the same movements, motions, articulations, degrees of freedom, combinations thereof, and/or the like.

In some embodiments, a given slick 300a and/or a given blank-tire 300c may be coded (and/or tagged) such that a code (tag) is associated with particular color(s) of the underlayment 304, as the colored underlayment 304 may not be exteriorly visible when in the slick 300a and/or a given blank-tire 300c configuration (state) (e.g., its color(s) may become visible after machine 351 operations thereon). In some embodiments, such code(s) and/or tag(s) may be selected from one or more of: a barcode, a QR code, a 2D code (two dimensional code), a 3D code (two dimensional code), a RFID tag, a NFC tag, a visual code, an optically readable code, a written code, an alphanumeric code, a numeric code, a machine code, combinations thereof, and/or the like. In some embodiments, code(s) and/or tag(s) along with their color assignment(s) (association(s)) may be maintained within a database. In some embodiments, the code(s) and/or tag(s) may be machine and/or software generated. In some embodiments, the code(s) and/or tag(s) may be machine readable (scannable).

In some embodiments, an article 1000 may be selected from at least one of: a tire 300b, 300d, 1100, 1200, and/or 1300; a sole of footwear 701; a floormat 1400; a vehicle-liner 1500, or a coaster. See FIG. 10A, FIG. 10B, and/or FIG. 10C for article 1000. See FIG. 3B for tire 300b. See FIG. 3E to FIG. 3P for textured-tire 300d. See FIG. 11 for tire 1100, FIG. 12 for tire 1200, and FIG. 13 for tire 1300. See FIG. 7A and FIG. 7B for sole of footwear 701 (sole-of-footwear 701). See FIG. 14 for floormat 1400. See FIG. 15 for vehicle-liner 1500. In some embodiments, floormat 1400 may be configured for use in a vehicle (i.e., as a vehicle-floormat). In some embodiments, vehicle-liner 1500 may be configured to at least partially line at least one of: a trunk, a boot, a frunk, a cargo area, a rear compartment, a region below a hatchback, a bed of a vehicle, a bed of a truck, or a bed of a pickup truck.

In some embodiments, an article 1000 may comprise at least two layers, namely, an outermost-layer 805 and a revealable-layer 803. In some embodiments, the outermost-layer 805 may be disposed on top of the revealable-layer 803 in a manner where a majority of a largest surface of a bottom of the outermost-layer 805 is facing a majority of a largest surface of a top of the revealable-layer 803. In some embodiments, the majority of the largest surface of the bottom of the outermost-layer 805 may be (directly) attached to the majority of the largest surface of the top of the revealable-layer 803. In some embodiments, such attachment may be accomplished by welding, adhesive, glue, epoxy, and/or the like between outermost-layer 805 and revealable-layer 803; and/or manufacturing the outermost-layer 805 and revealable-layer 803 together, such as, but not limited to, via injection molding. In some embodiments, the majority of the largest surface of the bottom of the outermost-layer 805 and the majority of the largest surface of the top of the revealable-layer 803 may be at least substantially parallel with each other (e.g., before machine 351 acts upon outermost-layer 805). In some embodiments, at least some portions of the outermost-layer 805 may be removed by machine 351 to a first-depth 1007/307 (depth-of-recess 1007/307) that visually reveals regions of the revealable-layer 803 as recessed-portions 1003/303 of the article 1000, to an observer that is external to the article 1000. In some embodiments, the first-depth 1007/307 may be from the exterior-surface 1011 of the outermost-layer 805 to a depth in the article 1000 where the revealable-layer 803 begins; when the outermost-layer 805 may be at least substantially unworn (such as, but not limited to, when article 1000 may be new and/or unused). In some embodiments, at least some upper-regions of the outermost-layer 805 may be of a first-color 1002/302 (outermost-color 1002/302). In some embodiments, at least some upper-regions of the outermost-layer 805 may be of at least one first-color 1002/302 (outermost-color 1002/302). In some embodiments, at least some of revealable-layer 803 may be of a second-color 1004/304 (revealed-color 1004/304). In some embodiments, at least some of revealable-layer 803 may be of at least one second-color 1004/304 (revealed-color 1004/304). In some embodiments, the first-color 1002/302 (outermost-color 1002 / 302) may be different from the second-color 1004/304 (revealed-color 1004/304). See e.g., FIG. 10A, FIG. 10B, FIG. 10C, FIG. 8A, FIG. 8B, FIG. 3E, FIG. 3F, FIG. 3G, FIG. 3H, FIG. 3I, FIG. 3J, and FIG. 3K.

In some embodiments, an exterior-surface 1011 of the outermost-layer 805 may be configured to come into removable physical contact with at least one object; and that at least one object is not part of article 1000. In some embodiments, the at least one object may be selected from: a portion of a road surface 190, a portion of a ground surface 190, a portion of floor 190, a bottom of a shoe (such as, but not limited to, sole-of-footwear 701), a foot of a person, or a portion of cargo 1500.

In some embodiments, machine 351 may be at least one computer numerical control (CNC) machine. In some embodiments, machine 351 may be at least one CNC type of device, apparatus, and/or system. In some embodiments, machine 351 may be at least one CNC router machine. In some embodiments, machine 351 may operate and/or control at least one removal-tool 352 (tool-head 352). In some embodiments, machine 351 may comprise at least one removal-tool 352 (tool-head 352). In some embodiments, removal-tool 352 (tool-head 352) may be configured to remove material (e.g., material of outermost-layer 805) from the article 1000 (e.g., to form recessed-portion(s) 1003 and/or to form predetermined patterns in article 1000). See e.g., FIG. 3E, FIG. 3F, FIG. 3G, FIG. 3J, FIG. 3M, FIG. 3N, and FIG. 3P; FIG. 8A and FIG. 8B; see also FIG. 16 and FIG. 17 for example CNC machine(s) 351.

In some embodiments, a bottom of the revealable-layer 803 may be part of other structure of article 1000 (e.g., such that bottom of the revealable-layer 803 may be part of other structure of article 1000 may be integral with each other); or the revealable-layer 803 may be attached to the other structure of article 1000. For example and without limiting the scope of the present invention, when article 1000 may be a tire 300b, 300d, 1100, 1200, and/or 1300; then this other structure of article 1000 may be other portions of such a tire, such as, but not limited to, sidewalls, a tire carcass, steel belts, and/or the like. For example and without limiting the scope of the present invention, when article 1000 may be sole of footwear 701; then this other structure of article 1000 may be other portions of such that footwear that has that sole of footwear 701. For example and without limiting the scope of the present invention, when article 1000 may be floormat 1400; then this other structure of article 1000 may be other portions of such that floormat 1400. For example and without limiting the scope of the present invention, when article 1000 may be vehicle-liner 1500; then this other structure of article 1000 may be other portions of such that vehicle-liner 1500.

In some embodiments, article 1000 may comprise at least one visual-depth-gauge 1005. In some embodiments, the at least one visual-depth-gauge 1005 may be (fixedly) embedded within the outermost-layer 805 at a second-depth 1009/309 from the exterior-surface 1011 of the outermost-layer 805, when the outermost-layer 805 may be at least substantially unworn. In some embodiments, the second-depth 1009/309 may be less than the first-depth 1007/307. In some embodiments, when the outermost-layer 805 wears down to the second-depth 1009/309, then the at least one visual-depth-gauge 1005 may become visible to an observer that is external to article 1000. In some embodiments, the at least one visual-depth-gauge 1005 may be of a third-color. In some embodiments, the at least one visual-depth-gauge 1005 may be of at least one third-color. In some embodiments, the third-color (of the at least one visual-depth-gauge 1005) may be different from: the first-color 1002 / 302 (outermost-color 1002/302), the second-color 1004/304 (revealed-color 1004/304), or both the first-color 1002/302 (outermost-color 1002/302) and the second-color 1004/304 (revealed-color 1004/304). In some embodiments, the at least one third-color (of the at least one visual-depth-gauge 1005) may be different from: the at least one first-color 1002/302 (outermost-color 1002/302), the at least one second-color 1004/304 (revealed-color 1004/304), or both the at least one first-color 1002/302 (outermost-color 1002/302) and the at least one second-color 1004/304 (revealed-color 1004/304). See e.g., FIG. 10B and FIG. 10C.

In some embodiments, article 1000 may comprise a predetermined pattern of the recessed-portions 1003 and of areas of the outermost-layer 805 that are not removed by machine 351. In some embodiments, this predetermined pattern may be visible to an observer that is external to article 1000. In some embodiments, article 1000 may comprise a predetermined pattern that is formed from the recessed-portions 1003 and from the areas of the outermost-layer 805 that are not removed by machine 351. In some embodiments the predetermined pattern (of article 1000) may at least substantially (mostly) match a preexisting pattern (with respect to look and feel, dimensions, and/or materials of construction).

In some embodiments, when article 1000 may be a tire 300b, 300d, 1100, 1200, and/or 1300, then the predetermined pattern of article 1000 may be its overall tread pattern; and the preexisting pattern may be a tread pattern of a preexisting tire (such as, but not limited to, tire 100 or a different tire 300, 300b, 300d, 1100, 1200, and/or 1300). In some embodiments, matching of the predetermined pattern of that article 1000 (when is tire 300b, 300d, 1100, 1200, and/or 1300) to the preexisting pattern, may include matching a current tread height of that preexisting tire (which may be in some state of being worn). In some embodiments, machine 351 may remove material of the outermost-layer 805 so that a height of outermost-layer 805 remaining after the material removal matches a height of treads in the preexisting tire. Thus, a given tire 300b, 300d, 1100, 1200, and/or 1300 may be custom manufactured to match a tread pattern and a tread height of preexisting tires (e.g., used tires), and as such this may be useful when one needs to (or wants to) replace less than all of the tires of a given vehicle.

In some embodiments, with respect to a 3D printed article 1000 (or an article 1000 with at least some portion being 3D printed), article 1000 may comprise at least two layers, namely, an outermost-added-layer 807 and a base-layer 803. In some embodiments, an exterior-surface of the base-layer 803 may be at least substantially smooth and at least substantially untextured (before any portions of outermost-added-layer 807 are added on top of that exterior-surface of base-layer 803). In some embodiments, the outermost-added-layer 807 may be added by machine 351 in sections on top of the exterior-surface of regions of the base-layer 803 forming raised-portions 1001 of the outermost-added-layer 807. In some embodiments, bottoms of the sections of the outermost-added-layer 807 may be (directly) attached to tops of the regions of the base-layer 803. In some embodiments, such attachment may be accomplished by welding, layer adhesion (e.g., from 3D printing [or additive manufacturing] operations [e.g., fused layer adhesion]), adhesive, glue, epoxy, and/or the like between outermost-added-layer 807 and base-layer 803. One or more of layers of article 1000 may be injection molded, extruded, and/or 3D printed. In some embodiments, these raised-portions 1001 may be raised with respect to the exterior-surface (top surface) of the base-layer 803. In some embodiments, portions of the base-layer 803 that are not covered over by the sections of the outermost-added-layer 807 may form recessed-portions 1003 with respect to an exterior-surface 1011 of the outermost-added-layer 807. In some embodiments, at least some of upper-regions of the outermost-added-layer 807 may be of a first-color 1002/302 (outermost-color 1002/302). In some embodiments, at least some of upper-regions of the outermost-added-layer 807 may be of at least one first-color 1002/302 (outermost-color 1002/302). In some embodiments, at least some of the base-layer 803 may be of a second-color 1004/304 (revealed-color 1004/304). In some embodiments, at least some of the base-layer 803 may be of at least one second-color 1004/304 (revealed-color 1004/304). In some embodiments, the at least one first-color 1002/302 (outermost-color 1002/302) may be different from the at least one second-color 1004/304 (revealed-color 1004/304). In some embodiments, the exterior-surface 1011 of the outermost-added-layer 807 may be configured to come into removable physical contact with at least one object, wherein the at least one object is not part of the article 1000. See e.g., FIG. 3E, FIG. 3L, FIG. 9A, FIG. 9B, FIG. 10A, FIG. 10B, and FIG. 10C.

In some embodiments, machine 351 may be at least one three-dimensional (3D) printer. In some embodiments, machine 351 may be at least one 3D printer type of device, apparatus, or system. In some embodiments, machine 351 may be selected from: a fused deposition modeling (FDM) 3D printer, a stereolithography (SLA) 3D printer, a selective laser sintering (SLS) 3D printer, an additive manufacturing machine, a portion thereof, combinations thereof, and/or the like. In some embodiments, a device, an apparatus, or a system embodiment of the present invention may comprise machine 351. In some embodiments, machine 351 may be configured to manufacture article 1000 or a portion thereof. In some embodiments, machine 351 may comprise at least one printer-head 354. In some embodiments, machine 351 may operate and/or controls at least one printer-head 354 and/or a portion thereof. In some embodiments, printer-head 354 may be at least one print head of a given 3D printer and/or configured to be used as a print head on/with a given 3D printer. In some embodiments, the at least one printer-head 354 may be configured to add material (of outermost-added-layer 807) to the article 1000 and/or onto base-layer 803. In some embodiments, as outermost-added-layer 807 may be added (to article 1000) by 3D printer machine 351, outermost-added-layer 807 may actually comprise a plurality of sub-layers, that in totality form outermost-added-layer 807. Only the bottom most sub-layer of outermost-added-layer 807 may be in direct communication with (a top surface of) base-layer 803; and other sub-layers of outermost-added-layer 807 may be laid down on top of a previously laid down sub-layer of outermost-added-layer 807 (except where sub-layers of outermost-added-layer 807 might be interrupted by 3D printer machine 351 laying down a visual-depth-gauge 1005). See e.g., FIG. 3E, FIG. 3L, FIG. 9A, FIG. 9B, FIG. 10A, FIG. 10B, and FIG. 10C; and see FIG. 16 and FIG. 17 for example 3D printer(s) 351.

In some embodiments, with respect to a 3D printed article 1000 (or an article 1000 with at least some portion being 3D printed), article 1000 may comprise at least one visual-depth-gauge 1005. In some embodiments, the at least one visual-depth-gauge 1005 may be (fixedly) embedded within the outermost-added-layer 807. In some embodiments, the at least one visual-depth-gauge 1005 may be covered over by at least some upper-regions of the outermost-added-layer 807, when the outermost-added-layer 807 may be in a at least substantially (mostly) unworn state. In some embodiments, the at least one visual-depth-gauge 1005 may be formed (laid down) by machine 351 acting upon base-layer 803 and/or upon a lower region of outermost-added-layer 807. In some embodiments, lower region of outermost-added-layer 807 may be above base-layer 803. In some embodiments, when the upper-regions of the outermost-added-layer 807 wears down, then the at least one visual-depth-gauge 1005 may become visible to an observer that is external to article 1000. In some embodiments, the at least one visual-depth-gauge 1005 may be of a third-color. In some embodiments, the at least one visual-depth-gauge 1005 may be of at least one third-color. In some embodiments, the at least one visual-depth-gauge 1005 may be a third-color. In some embodiments, the at least one visual-depth-gauge 1005 may be at least one third-color. In some embodiments, the third-color (of visual-depth-gauge 1005) may be different from: the first-color 1002/302 (outermost-color 1002/302), the second-color 1004/304 (revealed-color 1004/304), or both the first-color 1002/302 (outermost-color 1002/302) and the second-color 1004/304 (revealed-color 1004/304). In some embodiments, the at least one third-color (of visual-depth-gauge 1005) may be different from: the at least one first-color 1002/302 (outermost-color 1002/302), the at least one second-color 1004/304 (revealed-color 1004/304), or both the at least one first-color 1002/302 (outermost-color 1002/302) and the at least one second-color 1004/304 (revealed-color 1004/304). See e.g., FIG. 10B and FIG. 10C.

In some embodiments, with respect to a 3D printed article 1000 (or an article 1000 with at least some portion being 3D printed), article 1000 may comprise a predetermined pattern of the raised-portions 1001 and of the recessed-portions 1003. In some embodiments, this predetermined pattern may be visible to an observer that is external to article 1000. In some embodiments, article 1000 may comprise a predetermined pattern that is formed from the raised-portions 1001 and from the recessed-portions 1003. In some embodiments the predetermined pattern (of article 1000) may at least substantially (mostly) match a preexisting pattern (with respect to look and feel, dimensions, and/or materials of construction).

In some embodiments, with respect to a 3D printed article 1000 (or an article 1000 with at least some portion being 3D printed), when article 1000 may be a tire 300 b, 300 d, 1100, 1200, and/or 1300, then the predetermined pattern of article 1000 may be its overall tread pattern; and the preexisting pattern may be a tread pattern of a preexisting tire (such as, but not limited to, tire 100 or a different tire 300, 300b, 300d, 1100, 1200, and/or 1300). In some embodiments, matching of the predetermined pattern of that article 1000 (when is tire 300b, 300d, 1100, 1200, and/or 1300) to the preexisting pattern, may include matching a current tread height of that preexisting tire (which may be in some state of being worn). In some embodiments, machine 351 may add material of the outermost-added-layer 807 (added to base-layer 803 and/or to previously added layer(s) of outermost-added-layer 807) so that a height of outermost-added-layer 807 after the material has been added, matches a height of treads in the preexisting tire. Thus, a given tire 300b, 300d, 1100, 1200, and/or 1300 may be custom manufactured to match a tread pattern and/or a tread height of preexisting tires (e.g., used tires), and as such this may be useful when one needs to (or wants to) replace less than all of the tires of a given vehicle.

In some embodiments, with respect to a 3D printed article 1000 (or an article 1000 with at least some portion being 3D printed), a bottom of the base-layer 803 may be part of other structure of article 1000 (e.g., such that bottom of the base-layer 803 may be part of other structure of article 1000 may be integral with each other); or the base-layer 803 may be attached to the other structure of article 1000. See e.g., FIG. 9A, FIG. 9B, FIG. 10A, FIG. 10B, and FIG. 10C.

Typical tire 100 operating conditions may be important to consider for various tire and tire accessory embodiments of the present inventions to function as desired and/or as intended. For example, during typical tire 100 operating conditions, spinning of given tire 100 generates centrifugal forces (which can often be very significant); and tire 100 interactions with the given road surface 190 generate heat in the tire 100 from friction with the road surface 190 and from flexing of the given tire 100 as it spins against the given road surface 190; and there may also be heating contributions to the given tire 100 from high temperature road surfaces 190 and/or from environmental/ambient air temperature, all of which may increase a temperature of the given tire 100. In some embodiments, various tire and tire accessory embodiments of the present inventions may be configured to operate and/or function as desired and/or as intended under such typical tire 100 operating conditions.

Centrifugal force is an apparent outward force on a mass when it is rotated (spun);

thus, spinning tires 100 experience centrifugal forces. And over time, centrifugal forces, both experienced in the past and from current spinning, are a main contributor to tire failure, as the outer most tire elements (e.g., the tread) generally have an outward force that may cause separation from inner elements, such as, belts, plies, liners, and/or the tire's carcass. Note, it is not unusual for such tire failures when occurring on highways at relatively high speeds to result in death and/or serious bodily injury, as well as, significant property damage. Centrifugal forces of a spinning tire 100 may be very significant, both from a perspective of fatigue in the given tire from past tire spinning usage and from any moment in time when the tire is actually currently spinning. Various different formulas may be used to calculate centrifugal force.

For example, a magnitude of the centrifugal force F on an object of mass m at the perpendicular distance r from the axis of a rotating frame of reference with angular velocity ω is (see Eq. 1):

$$F = ( m ) ( {ω}^{2} ) ( r ) \qquad ( Eq . 1 )$$

Or sometimes centrifugal force F may be calculated by formula Eq. 2:

$$F = ( {mv}^{2} ) / ( r ) \qquad ( Eq . 2 )$$

where v may be the linear velocity as opposed the angular velocity, ω.

Or sometimes centrifugal force F may be calculated by formula Eq. 3:

$$F = ( {Wv}^{2} ) / ( gR ) \qquad ( Eq . 3 )$$

where W is the weight of the rotating object (as opposed to its mass) (e.g., in pounds); v equals the velocity of that body at the rim, in feet per second; g is the local (Earth's) gravitational constant (a constant, e.g., 32.16 ft./sec./sec.); R equals the radius, or the distance of the rotating body from the axis, in feet; and F is the force in pounds.

Next consider some typical values for the variables in such centrifugal force calculations, formulations, and/or equations.

Passenger cars in the U.S. typically have tires in the 15 inches to 18 inches “diameters” range. Whereas, sport and luxury vehicles in the U.S. typically have tires in the 19 inches to 22 inches “diameters” range. Typical tire “diameters” range from 14 inches to 22 inches for most passenger vehicles and light trucks in the U.S. However, these tire “diameter” sizes, that are marked on a given tire's exterior sidewall as, “R15” for example, for a 15 inches diameter, actually refer to the outside diameter of the wheel's rim that the given tire is designed to fit onto and not the actual outside diameter of that given tire. For example, a tire 100 with its sidewall marked “R19” may actually have an outside tire diameter of 28 inches to 29 inches (and may fit onto a wheel/rim of 19 inches in outside diameter).

A standard passenger car tire typically weighs between 20 to 25 pounds (9.1 kilograms [kg] to 11.3 kg). However, this can vary depending on the tire size, material, and design. Passenger car wheels typically weigh between 25 and 30 pounds (11.3 kg to 13.6 kg). However, this can vary depending on the wheel size, material, and design.

Note, as mere point of reference, a typical passenger vehicle tire revolves roughly 750 times as it travels a mile. At 60 mph (miles per hour), that is then 750 revolutions per minute (750 rpm).

With respect to Eq. 3 for calculating a spinning tire's centrifugal force, if an outside diameter of a vehicle's tire is 24 inches (thus, R equals 1 foot [ft]), and the vehicle is going 100 mph (146.7 ft. /sec.), then a mass of one pound at the rim of that wheel will have a centrifugal force of 669.2 pounds. Thus, any tire element (e.g., its tread or a portion thereof) that cannot take an outward tension load of 669.2 pounds will tend to come loose and eventually fly off of that spinning tire. Note, at a speed of 250 mph, the centrifugal force of this spinning 24 inch vehicle tire increases to 4,182 pounds for a mass of one pound at the rim of the wheel. See e.g., https://www.hotrod.com/features/tiring-problem-february-1985-982-1264-8-1. In Eq. 3, the centrifugal force (F) is inversely proportional to R; i.e., if one doubles R, the centrifugal force (F) is halved (assuming other variables were constant). Also in Eq. 3, the centrifugal force (F) on the tire increases geometrically, namely, at the square of vehicle's speed; thus, small changes in vehicle speed have large effect upon the centrifugal force (F).

FIG. 19 shows a table of calculated centrifugal forces (F) (according to Eq. 1) of tires of different diameters (from 12 inches to 36 inches) and at different vehicle speeds from 10 mph to 250 mph. To use this table of FIG. 19, pick a speed of interest and a tire diameter of interest and then multiply the number in the given cell of the table (which is in newtons per kg) by a mass of the wheel (and/or tire) to get the centrifugal force in newtons for those conditions. See also FIG. 18 for the formulas and an example of using this FIG. 19 table. For example, a 24 inch diameter tire, spinning at a vehicle speed of 100 mph and with a wheel mass of 10 kg results in a centrifugal force of 65,560 Newtons (N) (14,738 pounds) (see e.g., FIG. 18 and/or FIG. 19).

For example, a 24 inch diameter tire, spinning at a more modest vehicle speed of 60 mph and with a wheel mass of 10 kg results in a centrifugal force of 23,604 Newtons (N) (5,306 pounds) (see e.g., FIG. 18).

Thus, spinning vehicle tires 100 experience very significant centrifugal forces at commonly driven speeds. In some embodiments, various tire and tire accessory embodiments of the present inventions may be configured to operate and/or function as desired and/or as intended, and without separating from the given tire under such typical tire centrifugal forces.

In direct sunlight and on warm or hot days, asphalt road surfaces 190 are routinely in the 120 degrees Fahrenheit to 150 degrees Fahrenheit range, or get even hotter. Non-moving tires in static direct contact with such asphalt road surfaces 190 can approach such temperatures, especially at points of direct physical contact with that asphalt road surface 190.

Additionally, when a vehicle is driving, its tires also heat up from high frequency flexing of the tires. The frequency comes from the tire's rotation; recall, at 60 mph a typical tire has an rpm of about 750. And the flexing happens because the loads upon that tire (i.e., where the tire presses against the road's surface and from the actual mass of the vehicle) are balanced against the tire's at least partially elastic rubber material and against the tire's air pressure. Note, even with respect to a non-rotating vehicle tires (e.g., a parked car), a given tire appears generally round (circular), except for the portion of that given tire that is in direct physical contact with the ground, which gets flatted out a bit (because of the above noted loads). And often that flattened out portion is flanked by short regions of slightly bulging tire sidewalls because the tire is being pressed into the pavement by the weight of the vehicle on which it's mounted. As the tire rolls, that flattened section of tire pops back into its natural round shape (because of the tire's air pressure and the rubber's elasticity), and the next section of tire is pressed flat, until the entire tire revolves and every part of it has been flexed flat and back again. In this manner, a moving vehicle with tires will have its tires flexing at a high frequency and that continual flexing causes heat to build up in the tire's materials. This tire flexing from normal driving conditions generally causes the spinning tire's temperature to increase by about 50 degrees Fahrenheit above and beyond whatever the ambient air temperature may be, after thirty (30) minutes of highway driving. For example, on a hot summer day with ambient air temperature of 120 degrees Fahrenheit, a vehicle's tires may have temperatures in the 150 degrees Fahrenheit after thirty (30) minutes of highway driving. Also note, if a tire's air pressure is too low, that particular tire will get even hotter because reduced pressure results in more flexing of that tire.

In some embodiments, various tire and tire accessory embodiments of the present inventions may be configured to operate and/or function as desired and/or as intended, and without separating from the given tire when the given tire may have a temperature of 200 degrees Fahrenheit to negative 100 degrees Fahrenheit or range(s) within that range. In some embodiments, various tire and tire accessory embodiments of the present inventions may be configured to operate and/or function as desired and/or as intended, and without separating from the given tire when the given tire may have a temperature of 200 degrees Fahrenheit to zero degrees Fahrenheit or range(s) within that range. In some embodiments, various tire and tire accessory embodiments of the present inventions may be configured to operate and/or function as desired and/or as intended, and without separating from the given tire when the given tire may have a temperature of 200 degrees Fahrenheit to thirty-five (35) degrees Fahrenheit or range(s) within that range. In some embodiments, various tire and tire accessory embodiments of the present inventions may be configured to operate and/or function as desired and/or as intended at temperatures of 200 degrees Fahrenheit to negative 100 degrees Fahrenheit or range(s) within that range. In some embodiments, various tire and tire accessory embodiments of the present inventions may be configured to operate and/or function as desired and/or as intended at temperatures of 200 degrees Fahrenheit to zero degrees Fahrenheit or range(s) within that range. In some embodiments, various tire and tire accessory embodiments of the present inventions may be configured to operate and/or function as desired and/or as intended at temperatures of 200 degrees Fahrenheit to thirty-five (35) degrees Fahrenheit or range(s) within that range.

FIG. 20 is a color photograph, from a perspective view, showing a modified tire 100a that is fitted with four separate and distinct tire-bands 200, with one such tire-band 200 per groove 103 of that tire 100. Each groove 103 of that tire 100 has a (one) tire-band 200 fitted therein. Tire-band(s) 200 may be selected such at least one color of a given tire-band 200 may be different from tread 101 elements color(s) of tire 100 (which may be black). For example, in FIG. 20 the tire-bands 200 are red; whereas, the tread 101 elements and the grooves 103 of tire 100 are black, which results in high contrast. Other different color(s) may of course be selected. FIG. 20 is a color version of FIG. 2E.

FIG. 21 is a color photograph, from a front view (rear view, top view, or bottom view), showing a modified tire 100a that is fitted with four separate and distinct tire-bands 200, with one such tire-band 200 per groove 103 of that tire 100. Each groove 103 of that tire 100 has a (one) tire-band 200 fitted therein. Tire-band(s) 200 may be selected such at least one color of a given tire-band 200 may be different from tread 101 elements color(s) of tire 100 (which may be black). For example, in FIG. 20 the tire-bands 200 are red; whereas, the tread 101 elements and the grooves 103 of tire 100 are black, which results in high contrast. Other different color(s) may of course be selected. FIG. 21 is a color version of FIG. 2D.

FIG. 22 is a color photograph, from a perspective view, showing a textured tire 300b and/or textured-tire 300d where its recessed-portions 303 are of recessed-color 304 that may be different from raised-color 302 of its raised-portions 301. In FIG. 22, recessed-color 304 may be a first-color (e.g., orange) and raised-color 302 may be a second-color (e.g., black). Other colors may be selected for the recessed-color(s) 304 and/or for the raised-color(s) 302 of a given textured tire 300b and/or textured-tire 300d.

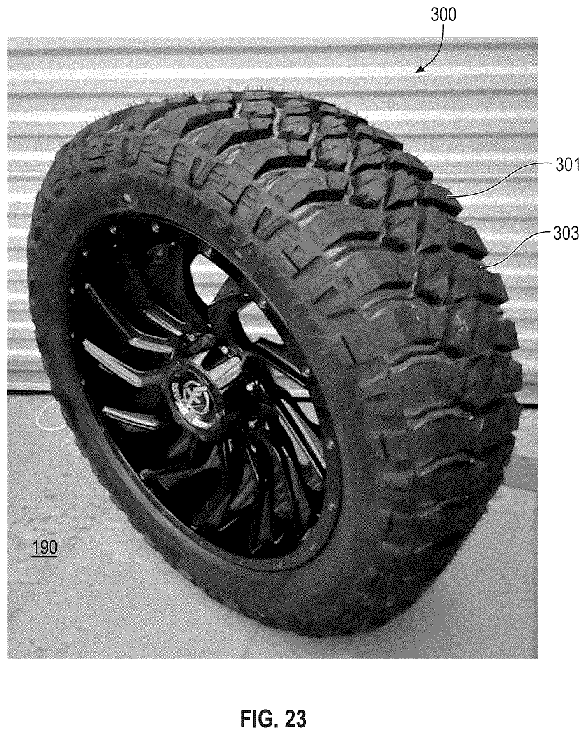

FIG. 23 is a color photograph, from a perspective view, showing a textured tire 300b and/or textured-tire 300d where its recessed-portions 303 are of recessed-color 304 that may be different from raised-color 302 of its raised-portions 301. In FIG. 23, recessed-color 304 may be a first-color (e.g., red) and raised-color 302 may be a second-color (e.g., black). Other colors may be selected for the recessed-color(s) 304 and/or for the raised-color(s) 302 of a given textured tire 300b and/or textured-tire 300d.

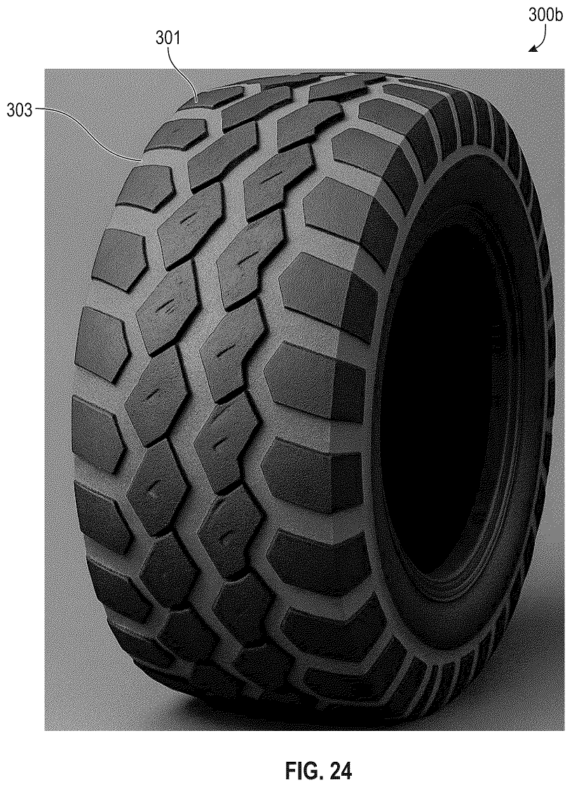

FIG. 24 is a color photograph, from a perspective view, showing a textured tire 300b and/or textured-tire 300d where its recessed-portions 303 are of recessed-color 304 that may be different from raised-color 302 of its raised-portions 301. In FIG. 24, recessed-color 304 may be a first-color (e.g., red) and raised-color 302 may be a second-color (e.g., black). Other colors may be selected for the recessed-color(s) 304 and/or for the raised-color(s) 302 of a given textured tire 300b and/or textured-tire 300d. Textured tire 300b and/or textured-tire 300d shown in FIG. 24 may be an offroad tire and/or a pickup truck tire. FIG. 24 may show of the sidewall 107 of that particular textured tire 300b and/or textured-tire 300d (e.g., consistent with FIG. 3M and/or FIG. 3N).

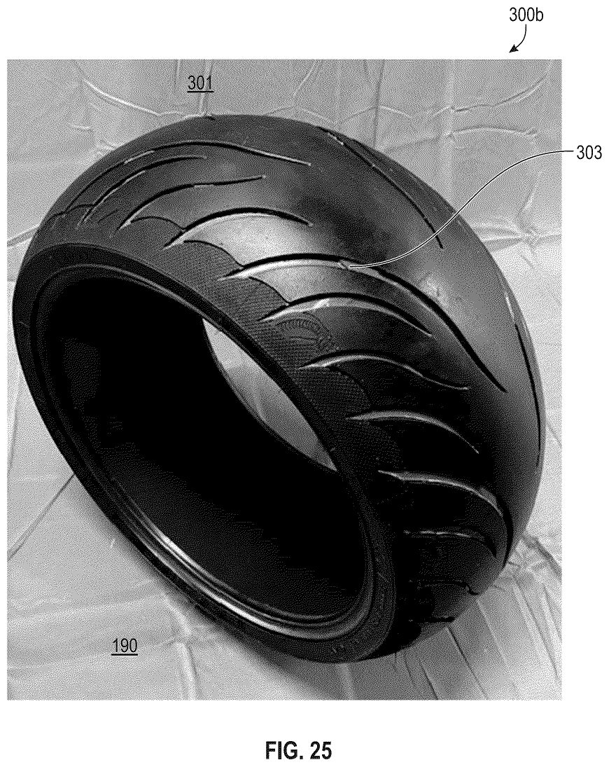

FIG. 25 is a color photograph, from a perspective view, showing a textured tire 300b and/or textured-tire 300d where its recessed-portions 303 are of recessed-color 304 that may be different from raised-color 302 of its raised-portions 301. In FIG. 25, recessed-color 304 may be a first-color (e.g., blue) and raised-color 302 may be a second-color (e.g., black). Other colors may be selected for the recessed-color(s) 304 and/or for the raised-color(s) 302 of a given textured tire 300b and/or textured-tire 300d. Textured tire 300b and/or textured-tire 300d shown in FIG. 25 may be a motorcycle tire and/or a custom motorcycle tire.

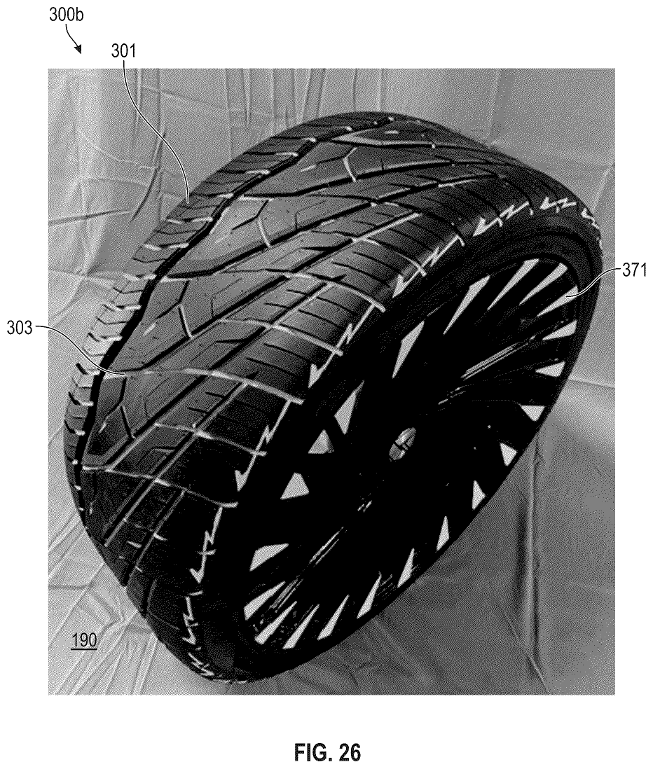

FIG. 26 is a color photograph, from a perspective view, showing a textured tire 300b and/or textured-tire 300d where its recessed-portions 303 are of recessed-color 304 that may be different from raised-color 302 of its raised-portions 301. In FIG. 26, recessed-color 304 may be a first-color (e.g., yellow) and raised-color 302 may be a second-color (e.g., black). Other colors may be selected for the recessed-color(s) 304 and/or for the raised-color(s) 302 of a given textured tire 300b and/or textured-tire 300d. FIG. 26 may show how recessed-color 304 may also be found on at least some regions (portions and/or sections) of the sidewall 107 of that particular textured tire 300b and/or textured-tire 300d (e.g., consistent with FIG. 3M and/or FIG. 3N).

FIG. 27 is a color photograph, from a bottom view, showing a textured sole-of-footwear 701 (or showing a bottom of footwear that may comprise sole-of-footwear 701) where its recessed-portions 705 are of recessed-color 1004 that may be different from raised-color 1002 of its raised-portions 703. In FIG. 27, recessed-color 1004 may be a first-color (e.g., red) and raised-color 1002 may be a second-color (e.g., black). Other colors may be selected for the recessed-color(s) 1004 and/or for the raised-color(s) 1002 of a given textured sole-of-footwear 701. FIG. 27 may be a color version of FIG. 7A and/or of FIG. 7B.

FIG. 28 is a color photograph, from a top view, showing a textured floormat 1400 where its recessed-portions 1403 are of recessed-color 1004 that may be different from raised-color 1002 of its raised-portions 1401. In FIG. 28, recessed-color 1004 may be a first-color (e.g., red) and raised-color 1002 may be a second-color (e.g., black). Other colors may be selected for the recessed-color(s) 1004 and/or for the raised-color(s) 1002 of a given textured floormat 1400. FIG. 28 may be a color version of a portion of FIG. 14.

In some embodiments, “at least substantially (mostly) unworn” and/or the like may mean that the given item is more than 50% unworn. If the given item is new and/or unused, it would generally be perfectly unworn and thus at least substantially (mostly) unworn. In some embodiments, “at least substantially (mostly) unworn” and/or the like may mean that the given item is less than 50% worn down or worn out.

In some embodiments, any of the colored elements of the various embodiments of the present invention, the recessed-portion(s), and/or the bottoms of the recessed-portions may comprise at least one reflector, reflective tape, reflective element(s), reflective pigment(s), a portion thereof, combinations thereof, and/or the like. In some embodiments, any of the colored elements of the various embodiments of the present invention, the recessed-portion(s), and/or the bottoms of the recessed-portions may be reflective and/or may glow in the dark. Glow in the dark coloring (and/or recessed-portion(s)) may utilize photoluminescent material(s), photoluminescent pigment(s), photoluminescent paint(s), photoluminescent colorant(s), tritium illumination, radioluminescence, a portion thereof, combinations thereof, and/or the like.

In some embodiments, wear-depth-gauge(s) 305 and/or 1005 may be integrated and/or integral to/with their raised-portion(s) that they may be initially (fixedly) embedded within such raised-portion(s).

In some embodiments, machine 351, removal-tool 352, and/or print-head 354 may work upon the sidewall(s) 107 and/or 371 of tire(s) 100, 300, 300a, 300b, 300c, 300d, 1100, 1200, and/or 1300.

In some embodiments, machine 351, removal-tool 352, and/or print-head 354 may be used to form and/or create: a logo, a design, artwork, a 2D design, a letter, a number, a punctuation mark, a word, a name, a trademark, a 2D character, a portion thereof, combinations thereof, and/or the like-upon: tire(s) 100, 300, 300a, 300b, 300c, 300d, 1100, 1200, and/or 1300; sole-of-footwear 701; article 650; article 1000; floormat 1400; vehicle-liner 1500; a portion thereof, combinations thereof, and/or the like.

In some embodiments, tire(s) 300, 300a, 300b, 300c, 300d, 1100, 1200, and/or 1300 may comprise a predetermined colored underlayment, such as, but not limited to, layer 803, recessed-portion 1003, region(s) 1004, a sidewall 371 (of the given tire 300, 300a, 300b, 300c, 300d, 1100, 1200, and/or 1300), a portion thereof, combinations thereof, and/or the like. In some embodiments, this colored underlayment may extend onto and/or into the sidewall 371 of the given tire 300, 300a, 300b, 300c, 300d, 1100, 1200, and/or 1300, such that this colored underlayment on the sidewall 371 (of the sidewall 371) may be externally visible by an observer that is external of that tire 300, 300a, 300b, 300c, 300d, 1100, 1200, and/or 1300.

In some embodiments, sole-of-footwear 701, floormat 1400, or vehicle-liner 1500 may comprise a predetermined colored underlayment, such as, but not limited to, layer 803, recessed-portion 1003, region(s) 1004, a portion thereof, combinations thereof, and/or the like.

It was and is not unusual for one or more pre-existing tires 100 of a given vehicle to become inoperable; e.g., because of damage and/or wear and tear to one or more of those pre-existing tires 100. Further, it would generally be desired to then replace the one or more pre-existing tires 100 that are now inoperable. Further still, if only one or two (or three) pre-existing tires 100 were rendered inoperable, it would generally be desirable from a cost perspective to only replace the inoperable tire(s) 100, but to leave the still operable tire(s) 100 on the given vehicle (e.g., assuming the given vehicle is configured for use with at least four tires). But in that situation, a problem could arise if new tire(s) 100 were not available to use for such replacement, e.g., because that particular make and model of tire(s) 100 may have become discontinued and/or may not be in stock, which in turn could result in the undesirable situation of the vehicle's owner having to replace all tire(s) 100, even those that are still operable. Or if new tire(s) 100 were available for such replacement, one would still have a problem because the new tire(s) 100 would be new-in an unworn state-whereas, the old but still operable tire(s) on the given vehicle would be in a worn state, such that installing the new tire(s) along with the old but still operable tire(s) 100 may result in a situation where that given vehicle rides poorly due to misbalancing of the treads, with some being new and unworn and others being worn. Tire(s) embodiments of the present invention resolves both of those particular problems.

Because one or more tires-according to one or more embodiments described herein (such as, but not limited to, textured-tire 300d)—may be manufactured with a custom and/or predetermined tread pattern, if one or more pre-existing tires 100 of a given vehicle become inoperable, the now inoperable tire(s) 100 may be replaced with a new tire (e.g., textured-tire 300d) that matches the tread pattern and dimensions of the inoperable tire(s) 100, along with matching the state of tread wear of worn but operable tire(s) 100, which avoids issues of obtaining new tire(s) 100, as new tire(s) 100 could be discontinued, not in stock, and/or have unworn treads.

In some embodiments, the material(s) of construction of band 200, flowable band-material 200a, material-to-be-melted 271, sleeve 300, untextured sleeve 300a, textured sleeve 300b, blank-tire 300c, textured-tire 300d, raised-portion (tread) 301, region-of-first-color 302 (upper most color 302), recessed-portion 303, region-of-second-color 304 (recessed-color 304), tread-wear-depth-gauge 305, exterior-surface 311, belt(s) 361, body plies 363, bead 365, bead filler 367, inner-liner 369, sidewall(s) 371, tread-precursor-material 381, outer exterior surface 383, outer exterior surface of formed treads 393, fluid-sleeve-material 401, sheet 500, first-layer 803, second-layer 805, tread 807, raised-portion (tread) 1001, region-of-first-color 1002 (upper most color 1002), recessed-portion 1003, region-of-second-color 1004 (recessed-color 1004), wear-depth-gauge 1005, raised-portion (tread) 1101, recessed-portion 1103, raised-portion (tread) 1201, recessed-portion 1203, raised-portion (tread) 1301, and/or recessed-portion 1303—i.e., elements of a tire or a tire-band 200 according to least embodiment herein-may be the same or substantially (mostly) the same as the material(s) of construction as used in typical tire(s) 100, and/or with respect to a typical tire's 100 tread 101 and/or grooves 103; except that at least some of the tire elements of the embodiments described herein may have different color(s) as compared to elements of typical tire(s) 100.

In some embodiments, the material(s) of construction of band 200, flowable band-material 200a, material-to-be-melted 271, sleeve 300, untextured sleeve 300a, textured sleeve 300b, blank-tire 300c, textured-tire 300d, raised-portion (tread) 301, region-of-first-color 302 (upper most color 302), recessed-portion 303, region-of-second-color 304 (recessed-color 304), tread-wear-depth-gauge 305, exterior-surface 311, belt(s) 361, body plies 363, bead 365, bead filler 367, inner-liner 369, sidewall(s) 371, tread-precursor-material 381, outer exterior surface 383, outer exterior surface of formed treads 393, fluid-sleeve-material 401, sheet 500, first-layer 803, second-layer 805, tread 807, raised-portion (tread) 1001, region-of-first-color 1002 (upper most color 1002), recessed-portion 1003, region-of-second-color 1004 (recessed-color 1004), wear-depth-gauge 1005, raised-portion (tread) 1101, recessed-portion 1103, raised-portion (tread) 1201, recessed-portion 1203, raised-portion (tread) 1301, and/or recessed-portion 1303—i.e., elements of a tire or a tire-band 200 according to least embodiment herein-may be configured for attachment to the material(s) of construction of tread 101, of grooves 103, and/or of substrate 801 of a given tire 100.

However, in some embodiments, band 200, flowable band-material 200a, material-to-be-melted 271, sleeve 300, untextured sleeve 300a, textured sleeve 300b, blank-tire 300c, textured-tire 300d, raised-portion (tread) 301, region-of-first-color 302 (upper most color 302), recessed-portion 303, region-of-second-color 304 (recessed-color 304), tread-wear-depth-gauge 305, exterior-surface 311, sidewall(s) 371 (or a portion thereof), tread-precursor-material 381, outer exterior surface 383, outer exterior surface of formed treads 393, fluid-sleeve-material 401, sheet 500, first-layer 803, second-layer 805, tread 807, raised-portion (tread) 1001, region-of-first-color 1002 (upper most color 1002), recessed-portion 1003, region-of-second-color 1004 (recessed-color 1004), wear-depth-gauge 1005, raised-portion (tread) 1101, recessed-portion 1103, raised-portion (tread) 1201, recessed-portion 1203, raised-portion (tread) 1301, and/or recessed-portion 1303 may have (show) one or more predetermined color(s), which may differ from color(s) of tread 101, of grooves 103, and/or of substrate 801 of a given tire 100.

In some embodiments, the one or more (predetermined) color(s) of: tread 101, groove(s) 103, band 200, flowable band-material 200a, material-to-be-melted 271, sleeve 300, untextured sleeve 300a, textured sleeve 300b, blank-tire 300c, textured-tire 300d, raised-portion (tread) 301, region-of-first-color 302 (upper most color 302), recessed-portion 303, region-of-second-color 304 (recessed-color 304), tread-wear-depth-gauge 305, exterior-surface 311, sidewall(s) 371 (or a portion thereof), tread-precursor-material 381, outer exterior surface 383, outer exterior surface of formed treads 393, fluid-sleeve-material 401, sheet 500, raised portion 703, recessed region 705, bottom of recessed region 705, first-layer 803, second-layer 805, tread 807, raised-portion (tread) 1001, region-of-first-color 1002 (upper most color 1002), recessed-portion 1003, region-of-second-color 1004 (recessed-color 1004), wear-depth-gauge 1005, raised-portion (tread) 1101, recessed-portion 1103, raised-portion (tread) 1201, recessed-portion 1203, raised-portion (tread) 1301, and/or recessed-portion 1303, raised-portion 1401, recessed-portion 1403, raised-portion 1501, and/or recessed-portion 1503 may differ from each other.

Note with respect to the materials of construction, it is not desired nor intended to thereby unnecessarily limit the present invention by reason of such disclosure.

Embodiments of the inventions shown and disclosed herein may be applied to and/or used on a tire of a wheel 150, such as, but not limited to a rubber tire; and/or applied to and/or used on a sole of footwear (and/or the bottom of footwear) and/or on mats, such as, but not limited to floormats.

The manufacturing processes and/or methods shown and described herein for making an article where its raised portions (or portions thereof) (e.g., ridges) and bottoms of its recessed portions (or portions thereof) (e.g., grooves bottoms) have different colors from each other, may be applied to and/or used on any physical (tangible) article that has raised portions (or portions thereof) (e.g., ridges) and that has recessed portions (or portions thereof) (e.g., grooves), such as, but not limited to, tires, bottoms of footwear (soles of footwear), mats, floormats, vehicle floormats, vehicle-liners, truck bed liners, pickup truck liners, coasters, and the like. For example, and without limiting the scope of the present invention, the teachings of FIG. 2G, FIG. 2H, FIG. 21, FIG. 3A to FIG. 3P, FIG. 4, FIG. 6A, FIG. 8A, FIG. 8B, FIG, 9A, FIG. 9B, FIG. 10A, FIG. 10B, and/or FIG. 10C, may be applied to and/or used on any physical (tangible) article that has raised portions (or portions thereof) (e.g., ridges) and that has recessed portions (or portions thereof) (e.g., grooves), such as, but not limited to, tires, bottoms of footwear (soles of footwear), mats, floormats, vehicle floormats, vehicle-liners, truck bed liners, pickup truck liners, coasters, and the like. With respect to at least some layered embodiments shown and discussed herein, one or more of such layer(s) may be formed by extrusion, injection molding, 3D printing, CNC machining, a portion thereof, combinations thereof, and/or the like.

In some embodiments, references herein to using a given tire, a tire-band 200, a tire fitted with at least one tire-band 200, and/or a vehicle fitted with such tire(s), and then driving that vehicle or using that given tire and/or that given tire-band 200 as intended or normally, may mean driving that subject vehicle according to local and/or relevant vehicle code laws and/or regulations and/or driving that subject vehicle according to its manufacturer's instructions.

Note, no human nor a portion thereof is part of any embodiment of the present invention(s). Further, no human nor a portion thereof is claimed as any embodiment of the present invention(s). However, some embodiments, may act upon a human or a portion thereof. For example and without limiting the scope of the present invention, sole-of-footwear 701 may be part of a given article of footwear (e.g., a shoe) that may be removably worn by a given human.

Bands for grooves of tires have been described; as well as, articles with raised-portions and with recessed-portions, such as, but not limited to, tires, soles of footwear, floormats, vehicle liners, and coasters, wherein at least some of the raised-portions and/or the recessed-portions bottoms may be colored differently from each other have been described. The foregoing description of the various embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A floormat comprising:
sheets, wherein all of the sheets are of a same material;
a plurality of raised-portions, wherein exterior-most surfaces of the plurality of raised-portions are configured to come into removable direct physical contact with footwear or a foot when the footwear or the foot are removably placed on a top of the floormat; and
a plurality of recessed-portions, wherein each recessed-portion, selected from the plurality of recessed-portions, is directly adjacent to at least one raised-portion, selected from the plurality of raised-portions;
wherein each recessed-portion, selected from the plurality of recessed-portions, is recessed with respect to the exterior-most surfaces of the plurality of raised-portions;
wherein each raised-portion, selected from the plurality of raised-portions, is raised with respect to bottoms of the plurality of recessed-portions;
wherein upper regions of the plurality of raised-portions are a first-color;
wherein at least some of the bottoms of the plurality of recessed-portions are a second-color, wherein the at least some of the bottoms of the plurality of recessed-portions are exteriorly visible from the top of the floormat;
wherein the plurality of raised-portions and the plurality of recessed-portions are constructed from at least two of the sheets.

2. The floormat according to claim 1, wherein the floormat is configured for use in or on a vehicle by the floormat having dimensions that are sized to fit in or on the vehicle.

3. The floormat according to claim 1, wherein the first-color and the second-color are different colors from each other.

4. The floormat according to claim 1, wherein the floormat further comprises a visual-wear-depth-gauge, wherein the visual-wear-depth-gauge is embedded within one or more raised-portions, selected from the plurality of raised-portions, at a first-depth from the exterior-most surfaces of the plurality of raised-portions; wherein the visual-wear-depth-gauge is a third-color.

5. The floormat according to claim 4, wherein the first-depth is with respect to when the plurality of raised-portions are at least substantially unworn.

6. The floormat according to claim 4, wherein when the plurality of raised-portions are at least substantially unworn the visual-wear-depth-gauge is not visible from an exterior of the floormat.

7. The floormat according to claim 4, wherein the third-color is different from the second-color.

8. The floormat according to claim 4, wherein the visual-wear-depth-gauge becomes visible when a height of the plurality of raised-portions wears down to the first-depth.

9. The floormat according to claim 4, wherein the at least some of the bottoms of the plurality of recessed-portions that are the second-color, are located at a second-depth from the exterior-most surfaces of the plurality of raised-portions.

10. The floormat according to claim 9, wherein the second-depth is greater to or equal to the first-depth.

11. The floormat according to claim 9, wherein the second-depth is with respect to when the plurality of raised-portions are at least substantially unworn.

12. The floormat according to claim 1, wherein the first-color and the second-color are different colors from each other, wherein the different colors function as an indicator of cleanliness or dirtiness of the floormat, as compared to a different-floormat where raised-elements and recessed-elements of the different-floormat are all a same color.

13. The floormat according to claim 1, wherein the second-color is formed by spraying a liquid form of the second-color onto the at least some of the bottoms, of the plurality of recessed-portions, that dries in place as the second-color.

14. The floormat according to claim 1, wherein the second-color is formed by painting a liquid form of the second-color onto the at least some of the bottoms, of the plurality of recessed-portions, that dries in place as the second-color.

15. The floormat according to claim 1, wherein the second-color is formed by extruding a liquid form of the second-color onto the at least some of the bottoms, of the plurality of recessed-portions, that dries in place as the second-color.

16. The floormat according to claim 1, wherein the floormat is a vehicle-floormat that is configured for use within a vehicle, wherein the vehicle-floormat is sized to fit within a portion of the vehicle.

17. The floormat according to claim 1, wherein the floormat is a vehicle-liner that is configured for use on a vehicle, wherein the vehicle-liner is sized to fit within a portion of the vehicle.
